(19) United States
(12) Patent Application Publication
(10) Pub. No.: US 2025/0205681 A1
(43) Pub. Date: Jun. 26, 2025

(54) POLYMER REINFORCEMENT ON DOUBLE AMINE COATED SORBENT

(71) Applicant: X Development LLC, Mountain View, CA (US)

(72) Inventors: Jeremy Aaron Willman, Redwood City, CA (US); Chaokun Gong, Sunnyvale, CA (US); Amanda Marie Rampertab, Santa Clara, CA (US); Jacques Gagne, Los Gatos, CA (US)

(21) Appl. No.: 19/000,606

(22) Filed: Dec. 23, 2024

Related U.S. Application Data
(60) Provisional application No. 63/614,807, filed on Dec. 26, 2023.

(51) Int. Cl. B01J 20/30; B01J 20/10; B01J 20/26; B01J 20/28; B01J 20/32

(52) U.S. Cl. CPC B01J 20/30; B01J 20/103; B01J 20/262; B01J 20/28088; B01J 20/3214

(57) ABSTRACT

Disclosed herein are methods, and compositions produced using the methods, including introducing porous substrate particles and a first reagent comprising a polymer to a solvent to provide a plurality of coated particles; and introducing a second reagent comprising a polymeric amine and a third reagent comprising a silane moiety and an amine moiety to the coated particles, thereby providing a plurality of functionalized, coated particles.

### CROSS REFERENCE TO RELATED PATENT APPLICATION

This application claims priority to U.S. Provisional Patent Application No. 63/614,807, entitled “POLYMER REINFORCEMENT ON DOUBLE AMINE COATED SILICA SORBENT,” filed Dec. 26, 2023, which is hereby incorporated by reference.

### FIELD OF THE DISCLOSURE

The disclosure relates to a functionalized material and more specifically, to a functionalized material for reversibly capturing carbon dioxide.

### BACKGROUND

Atmospheric carbon concentrations have risen in correlation with industrialized activity for decades. Carbon dioxide is a primary contributor to the total carbon concentration. Three-dimensional porous substrate structures have been utilized to remove carbon dioxide from gaseous environments.

### SUMMARY

Given in the above background, there is a need in the art for methods, systems, and compositions, for removing carbon dioxide form gaseous environments (e.g., air). In some aspects, the present disclosure advantageously relates to methods of making a functionalized material for the capture of carbon dioxide having a protective polymer (e.g., PVA, Pebax) coating at a commercial scale (e.g., batches of 25 kg or more), systems for making the same, and compounds produced therefrom. In some embodiments, porous substrate particles are functionalized with a polymeric amine, such as polyethylenimine (PEI), and a compound containing silane and amine moieties, such as an ethoxysilane, for the purposes of reversibly capturing carbon dioxide at low concentrations (e.g., <400 ppm, atmospheric concentrations) out of a gas. In some embodiments, the porous substrate features large pore sizes (e.g., from 5 nanometers (nm) to 20 nm, from 20 nm to 50 nm, or from 50 nm to 150 nm) and high surface-to-volume ratios. In some embodiments, particles of the functionalized material (e.g., the porous substrate optionally modified with one or more polymers, silane moieties, and/or amine moieties) feature a particle size of from 0.5 millimeters (mm) to 4 mm.

Advantageously, in some embodiments, the mechanical properties of the functionalized particles are improved by coating the substrate particles with a polymer coating, as disclosed herein. In some embodiments, the porous substrate is coated with the polymer before and/or after the functionalization process. Without being limited to any one theory of operation, in some embodiments, the functionalized, coated substrate has increased resistance to abrasion, increased crush strength, and produces fewer fines when agitated in bulk. In some embodiments, the polymer coating is a single type of polymer, or a mixture of more than one polymer. One example of a polymer for coating the substrate particles is polyvinyl alcohol (PVA). In some embodiments, the polymer is dip-coated onto the substrate particles, or spray-coated, before, after, or at the same time as the aminosilanes and/or polymeric amine coatings.

Without being limited to any one theory of operation, in some embodiments, the combination of a polymeric amine and an aminosilane increases amine bonding to the substrate for increased carbon capture (e.g., >1 mol/kg). The first polymeric amine layer forms a network with the aminosilane compound during binding to the porous substrate. In some embodiments, the functionalized material is produced using solution-based reaction methods (e.g., dip-coating) in which the aminosilane compound and the polymeric amine compound are solvated in a solution (e.g., a water-based solution). In some embodiments, the porous substrate is dispensed into the mixture, stirred, and removed. In some embodiments, this functionalizes the substrate with both the silane-containing compound and the polymeric amine concurrently.

Advantageously, the process facilitates scaled-up sorbent manufacturing and recycling of some process ingredients which reduces long-term production costs. The method reduces energy and time for drying the volumes of polymer-coated sorbent. In one example, dip-coating methods are gentler than stirred production methods and reduces damage to the dip-coated particles.

In some embodiments desorption using the materials described herein is performed at laboratory temperatures (e.g., >70° C.) thereby enabling the functionalized material to be re-introduced to carbon dioxide for recapture. In some embodiments, high adsorption/desorption cycle counts are achieved (e.g., >100 cycles). In some embodiments, the adsorbent achieves CO₂ uptake up to 0.1 to 2.5 (e.g., 1.2-1.8 mol CO₂/kg) in ambient air conditions of 420 ppm CO₂. Advantageously, performing the functionalization in one batch reduces the steps involved in functionalization and increases cost-effectiveness of production.

One aspect disclosed herein is a method including introducing at least a portion of a plurality of porous substrate particles and a first reagent that includes a polymer to a solvent to provide a plurality of coated silica particles; and introducing a second reagent that includes a polymeric amine and a third reagent that includes a silane moiety and an amine moiety to at least a portion of the plurality of coated silica particles, thereby providing a plurality of functionalized, coated particles.

In some embodiments, examples include one or more of the following features. In some embodiments, introducing the second reagent and the third reagent includes mixing the second reagent and the third reagent in a different solvent to form a mixture and spraying the mixture on the coated silica particles. In some embodiments, the first reagent includes PVA. In some embodiments, the porous substrate particles are introduced to the solvent at a ratio in a range from 1.5 to 4:1 wt/wt of solvent to the porous substrate particles. In some embodiments, the first reagent is introduced to the solvent at a ratio in a range of up to 20% wt/wt of the first reagent to the porous substrate particles. In some embodiments, the third reagent includes an alkoxysilane, a methoxysilane, a silanetriol, an alkoxysilanol, a chlorosilane, a hydrosilane, or an ethoxysilane. In some embodiments, the third reagent includes (3-aminopropyl) trimethoxysilane, (3-aminopropyl)triethoxysilane, [3-(2-aminoethylamino) propyl]trimethoxysilane, n-(2-aminoethyl)-3-aminopropyl silanetriol, nl-(3-trimethoxysilylpropyl) diethylenetriamine, 3-aminopropylsilanetriol, n-(2aminoethyl)-3-aminopropylsilanetriol, tris(ethylmethylamino) chlorosilane, or tris(dimethylamino) chlorosilane, or amino silane oligomers. In some embodiments, the second reagent is a polymeric amine. In some embodiments, the second reagent is a linear or a branched polymeric amine. In some embodiments, the second reagent is selected from the group including, but not limited to, polyethylenimine (pei), polypropylenimine, tetraethylenepentamine (tepa), triethylenetetramine (teta), diethanolamine, and/or a large molecule weight amine mixture. In some embodiments, the method further includes, before introducing the second reagent and the third reagent: drying the coated silica particles in a vacuum oven at 80 c until a hydration threshold of less than 5% wt/wt of water to coated silica substrate is reached. In some embodiments, the method further includes introducing a fourth reagent, optionally including an antioxidant at a weight ratio of 5% to porous substrate particles. In some embodiments, the antioxidant is an organic sulfur-containing compound selected from a list including, but not limited to, 2,2-thiodiethanol, 2-hydroxyethyl disulfide, and/or 3,3′-dithiodipropionic acid. In some embodiments, the third reagent is introduced to the different solvent at a ratio of between 20% and 80% wt/wt of the third reagent to the porous substrate particles.

Another aspect disclosed herein is a composition including porous substrate particles modified according to any method aspect herein.

Another aspect disclosed herein is a method including using the functionalized silica particles of any aspect herein to remove atmospheric CO₂ from air by direct air capture.

Another aspect disclosed herein is a method including introducing a second reagent and a third reagent to a portion of a plurality of porous substrate particles to provide a plurality of functionalized silica particles; and introducing a first reagent to at least a portion of the plurality of functionalized silica particles, thereby providing a plurality of functionalized, coated particles.

Another aspect disclosed herein is a method including introducing a first reagent including a polymer into a volume of a first solvent to create a coating mixture; agitating the coating mixture for a first duration; introducing at least a portion of a plurality of porous substrate particles into the coating mixture to create a coating suspension; agitating the coating suspension for a second duration to create a plurality of coated silica particles; recovering at least a portion of the plurality of coated silica particles by filtration or evaporation; drying at least a portion of the plurality of coated silica particles until a hydration threshold is reached; introducing a second reagent including polyethylenimine and a third reagent including a silane moiety and an amine moiety into a volume of a second solvent to create a functionalization mixture; introducing at least a portion of the plurality of coated silica particles to the functionalization mixture to create a functionalization suspension; agitating the functionalization suspension to create a plurality of functionalized, coated particles; and recovering at least a portion of the plurality of functionalized, coated silica particles by filtration or evaporation.

In some embodiments, examples include one or more of the following features. In some embodiments, the silica particles are introduced to the functionalization mixture to create the functionalization suspension and the functionalization suspension is agitated to provide functionalized silica particles before the functionalized silica particles are introduced into the coating mixture to provide the functionalized, coated particles. In some embodiments, drying the functionalized silica particles includes heating the functionalized silica particles at 120° C. for 20 minutes. In some embodiments, drying the functionalized silica particles includes flowing an inert gas over the functionalized silica particles until the hydration threshold can be reached. In some embodiments, the hydration threshold is less than 5% wt/wt of water to functionalized silica particles. In some embodiments, the composition has a crush strength of at least 1.5 MPa. In some embodiments, the composition further includes a hydrophobic compound. In some embodiments, the hydrophobic compound is a hydrophobic silane compound, and/or a hydrophobic polymer. In some embodiments, the hydrophobic silane compound includes a silane molecule and one, two, or three alkyl chains. In some embodiments, the hydrophobic polymer includes polydimethylsiloxane (PDMS), silicone oil, polyethylene, polytetrafluoroethylene, and/or polyurethanes.

In some embodiments, examples include one or more of the following features. In some embodiments, the composition has a crush strength of at least 1.5 MPa. In some embodiments, the composition includes a hydrophobic compound. In some embodiments, the hydrophobic compound is a hydrophobic silane compound, and/or a hydrophobic polymer. In some embodiments, the hydrophobic silane compound includes a silane molecule and one, two, or three alkyl chains. In some embodiments, the hydrophobic polymer includes polydimethylsiloxane (PDMS), silicone oil, polyethylene, polytetrafluoroethylene, or polyurethanes.

Particular implementations of the subject matter described in this specification can be implemented so as to realize one or more of the following technical advantages.

One method of making the coated substrate sorbent is using a water-based, single-pot reaction at ambient pressures and temperatures in short time scales reducing the cost of production, reducing reliance on industrial solvents, and reducing the environmental impact of the product.

In some embodiments, the coated sorbent adsorbs CO₂ at concentrations similar to uncoated sorbents, enabling efficient capture at levels present in atmospheric conditions using stronger, longer-lasting products.

In some embodiments, CO₂ is desorbed from the coated sorbent at laboratory temperatures, which reduces the energy required to remove captured CO₂, increases the applicability of the regenerated substrate to more industries and environments, and increases the speed at which the CO₂ is desorbed.

In some embodiments, the coated sorbent achieves high adsorption/desorption counts which advantageously reduces operational costs in carbon capture systems.

In some embodiments, the coated sorbent is produced using industrially available components, advantageously reducing the cost of and increasing the scalability of production.

In some embodiments, coating sorbents with a polymer compound increases the capture stability and mechanical strength of the individual particles, increasing the useful lifespan of the sorbent and reducing the production of fines when the sorbent fragments under mechanical forces.

The details of one or more embodiments are set forth in the accompanying drawings and the description below. Other features and advantages will be apparent from the description and drawings, and from the claims.

### DESCRIPTION OF DRAWINGS

FIG. 1 is a schematic illustration of a functionalized, coated particle, in accordance with some embodiments of the present disclosure.

FIGS. 2A, 2B, 2C, 2D, 2E, 2F, 2G, 2H, 2I, 2J, and 2K are chemical illustrations of exemplary compounds including silane groups, amine groups, and polymeric amine groups, in accordance with some embodiments of the present disclosure.

FIGS. 3A and 3B collectively illustrate flow chart diagrams showing a process for producing functionalized, coated particles, in accordance with some embodiments of the present disclosure.

FIG. 4 is a schematic illustration of an example Nutsche filter mixing/filtration/drying system for producing functionalized particles from particles, in accordance with some embodiments of the present disclosure.

FIG. 5 is a schematic illustration of an example paddle dryer for producing functionalized particles from particles, in accordance with some embodiments of the present disclosure.

FIG. 6 is a schematic illustration of an example ribbon dryer for producing functionalized particles from particles, in accordance with some embodiments of the present disclosure.

FIG. 7 is a schematic illustration of an example implementation of a carbon dioxide extraction system, in accordance with some embodiments of the present disclosure.

FIG. 8 is a schematic illustration of an example implementation of an integrated power and carbon dioxide extraction system, in accordance with some embodiments of the present disclosure.

FIG. 9 is a schematic illustration of a compression strength test fixture for testing particle samples, in accordance with some embodiments of the present disclosure.

FIG. 10 is a bar chart of experimental compression strength results for tested particle samples, in accordance with an embodiment of the present disclosure.

FIGS. 11A and 11B are schematic illustrations of an attrition and abrasion test fixture for testing particle samples, in accordance with some embodiments of the present disclosure.

FIG. 12 is a line chart depicting CO₂ uptake over a plurality of cycles by a non-limiting functionalized material including a silica substrate, in accordance with some embodiments of the present disclosure. Provided are the testing cycle number (x-axis) and uptake at each cycle (y-axis).

FIGS. 13A and 13B collectively illustrate example schematics for testing sample CO₂ absorption, in accordance with some embodiments of the present disclosure. FIG. 13A is a schematic illustration of an exploded view and an assembled view of a sample holder for testing sample CO₂ adsorption, in accordance with some embodiments of the present disclosure. FIG. 13B is a schematic diagram of an experimental setup for testing sample absorption of CO₂, in accordance with some embodiments of the present disclosure.

FIGS. 14A and 14B illustrate example aminosilanes in accordance with some embodiments of the present disclosure.

In the figures, like references indicate like elements.

### DETAILED DESCRIPTION

In some embodiments, amorphous silica is used as a porous sorbent substrate for functionalization to achieve carbon capture. Without being limited to any one theory of operation, in some embodiments, sorbent substrates with amine functionalization, e.g., one or more amine-containing groups covalently bonded on surfaces, achieve reversible capture of carbon dioxide from gaseous mixtures (e.g., the atmosphere).

As used herein, the term “moiety” is used to describe characteristic parts of organic molecules. For example, an amine moiety is a molecule, compound, or portion of a compound containing an amine group (e.g., —NR^{N1}R^{N2}, as described herein), whereas a silane moiety is a molecule, compound, or portion of a compound containing a silane group (e.g., —SiR^{S1}R^{S2}R^{S3}, as described herein). In one non-limiting instance, an amine moiety includes an aminoalkyl group (e.g., -Ak-NR^{N1}R^{N2}, as described herein), as may be present in an aminosilane compound or a polymeric amine compound. The term moiety is used to describe both larger molecules containing the group, or may be used to describe the group itself.

As used herein, “interact” is used to describe covalent or non-covalent interactions between chemicals, such as by way of physical adsorption or ionic interactions.

By “acyl” or “alkanoyl,” as used interchangeably herein, is meant an aliphatic or alkyl group, as defined herein, attached to the parent molecular group through a carbonyl group. In particular embodiments, the alkanoyl is —C(O)-Ak, in which Ak is an aliphatic or alkyl group, as defined herein. In some embodiments, an unsubstituted alkanoyl is a C₂₋₇ alkanoyl group. Exemplary alkanoyl groups include acetyl.

By “acyloxy” or “alkanoyloxy,” as used interchangeably herein, is meant an acyl or alkanoyl group, as defined herein, attached to the parent molecular group through an oxy group. In particular embodiments, the alkanoyloxy is —O—C(O)-Ak, in which Ak is an aliphatic or alkyl group, as defined herein. In some embodiments, an unsubstituted alkanoyloxy is a C₂₋₇ alkanoyloxy group. Exemplary alkanoyloxy groups include acetoxy.

By “acyl halide” is meant —C(O)X, where X is a halogen, such as Br, F, I, or Cl.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl, e.g., as described herein), alkenes (or alkenyl), alkynes (or alkynyl), including cyclic versions thereof, and further including straight- and branched-chain arrangements, and all stereo and position isomers as well. In some embodiments, such a hydrocarbon is unsubstituted or substituted with one or more groups, such as groups described herein for an alkyl group.

By “aliphatic-aryl” is meant an aryl group that is or can be coupled to a compound disclosed herein, where the aryl group is or becomes coupled through an aliphatic group, as defined herein. In some embodiments, the aliphatic-aryl group is -L-R, in which L is an aliphatic group, as defined herein, and R is an aryl group, as defined herein.

By “aliphatic-heteroaryl” is meant a heteroaryl group that is or can be coupled to a compound disclosed herein, where the heteroaryl group is or becomes coupled through an aliphatic group, as defined herein. In some embodiments, the aliphatic-heteroaryl group is -L-R, in which L is an aliphatic group, as defined herein, and R is a heteroaryl group, as defined herein.

By “alkenyl” is meant an optionally substituted C₂₋₂₄ alkyl group having one or more double bonds. The alkenyl group can be cyclic (e.g., C₃₋₂₄ cycloalkenyl) or acyclic. The alkenyl group can also be substituted or unsubstituted. For example, the alkenyl group can be substituted with one or more substitution groups, as described herein for alkyl. Non-limiting unsubstituted alkenyl groups include allyl and vinyl. In some embodiments, the unsubstituted alkenyl group is a C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkenyl group. Non-limiting examples of alkenyl groups include vinyl or ethenyl (—CH═CH₂), 1-propenyl (—CH═CHCH₃), allyl or 2-propenyl (—CH₂—CH═CH₂), 1-butenyl (—CH═CHCH₂CH₃), 2-butenyl (—CH₂CH═CHCH₃), 3-butenyl (—CH₂CH₂CH═CH₂), 2-butenylidene (═CH—CH═CHCH₃), and the like.

By “alkenylene” is meant a multivalent (e.g., bivalent) form of an alkenyl group, which is an optionally substituted C₂₋₂₄ alkyl group having one or more double bonds. The alkenylene group can be cyclic (e.g., C₃₋₂₄ cycloalkenyl) or acyclic. The alkenylene group can be substituted or unsubstituted. For example, the alkenylene group can be substituted with one or more substitution groups, as described herein for alkyl. Non-limiting examples of alkenylene include-CH═CH— or —CH═CHCH₂—.

By “alkoxy” is meant-OR, where R is an optionally substituted aliphatic or alkyl group, as described herein. Non-limiting examples of alkoxy groups include methoxy, ethoxy, n-propoxy, isopropoxy, n-butoxy, t-butoxy, sec-butoxy, n-pentoxy, trihaloalkoxy, such as trifluoromethoxy, etc. The alkoxy group can be substituted or unsubstituted. For example, the alkoxy group can be substituted with one or more substitution groups, as described herein for alkyl. Non-limiting examples of unsubstituted alkoxy include C₁₋₃, C₁₋₆, C₁₋₁₂, C₁₋₁₆, C₁₋₁₈, C₁₋₂₀, or C₁₋₂₄ alkoxy groups.

By “alkoxyalkyl” is meant an alkyl group, as defined herein, which is substituted with an alkoxy group, as defined herein. Non-limiting examples of unsubstituted alkoxyalkyl groups include between 2 to 12 carbons (C₂₋₁₂ alkoxyalkyl), as well as those having an alkyl group with 1 to 6 carbons and an alkoxy group with 1 to 6 carbons (i.g., C₁₋₆ alkoxy-C₁₋₆ alkyl). In some embodiments, the alkoxyalkyl group is -L-O—R, in which L is an alkylene group, as defined herein, and R is an alkyl group, as defined herein.

By “alkyl” and the prefix “alk” is meant a branched or unbranched saturated hydrocarbon group of 1 to 24 carbon atoms, such as methyl (Me), ethyl (Et), n-propyl (nPr), isopropyl (i-Pr), cyclopropyl, n-butyl (n-Bu), isobutyl (i-Bu), s-butyl (s-Bu), t-butyl (tBu), cyclobutyl, n-pentyl, isopentyl, s-pentyl, neopentyl, hexyl, heptyl, octyl, nonyl, decyl, dodecyl, tetradecyl, hexadecyl, eicosyl, tetracosyl, and the like. In some embodiments, the alkyl group is cyclic (e.g., C₃₋₂₄ cycloalkyl) or acyclic. In some embodiments, the alkyl group is branched or unbranched. In some embodiments, the alkyl group is also substituted or unsubstituted. For example, in some embodiments, the alkyl group is substituted with one or more alkenyl, alkoxy, alkynyl, amino, aryl, carboxyaldehyde (e.g., —C(O)H), carboxyl (e.g., —CO₂H), cyano (e.g., —CN), halo, nitro (e.g., —NO₂), oxo (e.g., ═O), and the like. In some embodiments, the alkyl group is substituted with one, two, three or, in the case of alkyl groups of two carbons or more, four substituents independently selected from the group consisting of: (1) C₁₋₆ alkoxy (e.g., —O—R, in which R is C₁₋₆ alkyl); (2) C₁₋₆ alkylsulfinyl (e.g., —S(O)—R, in which R is C₁₋₆ alkyl); (3) C₁₋₆ alkylsulfonyl (e.g., —SO₂—R, in which R is C₁₋₆ alkyl); (4) amine (e.g., —C(O)NR¹R² or —NHCOR¹, where each of R¹ and R² is, independently, selected from hydrogen, aliphatic, heteroaliphatic, haloaliphatic, haloheteroaliphatic, aromatic, as defined herein, or any combination thereof, or R¹ and R², taken together with the nitrogen atom to which each are attached, can form a heterocyclyl group, as defined herein); (5) aryl (e.g., C₄₋₁₈ aryl); (6) arylalkoxy (e.g., —O-L-R, in which L is C₁₋₆ alkylene and R is C₄₋₁₈ aryl); (7) aryloyl (e.g., —C(O)—R, in which R is C₄₋₁₈ aryl); (8) azido (e.g., —N₃); (9) cyano (e.g., —CN); (10) aldehyde (e.g., —C(O)H); (11) C₃₋₈ cycloalkyl; (12) halo; (13) heterocyclyl (e.g., as defined herein, such as a 5-, 6- or 7-membered ring containing one, two, three, or four non-carbon heteroatoms); (14) heterocyclyloxy (e.g., —O—R, in which R is heterocyclyl, as defined herein); (15) heterocyclyloyl (e.g., —C(O)—R, in which R is heterocyclyl, as defined herein); (16) hydroxy (e.g., —OH); (17) N-protected amino; (18) nitro (e.g., —NO₂); (19) oxo (e.g., ═O); (20) C₁₋₆ thioalkoxy (e.g., —S—R, in which R is alkyl); (21) thiol (e.g., —SH); (22) —CO₂R¹, where R¹ is selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); (23) —C(O)NR¹R², where each of R¹ and R² is, independently, selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); (24) —SO₂R¹, where R¹ is selected from the group consisting of (a) C₁₋₆ alkyl, (b) C₄₋₁₈ aryl, and (c) C₁₋₆ alkyl-C₄₋₁₈ aryl (e.g., -L-R, in which Lis C₁₋₆ alkylene and R is C₄₋₁₈ aryl); (25) —SO₂NR¹R₂, where each of R¹ and R² is, independently, selected from the group consisting of (a) hydrogen, (b) C₁₋₆ alkyl, (c) C₄₋₁₈ aryl, and (d) C₁₋₆ alkyl-C₄₋₁₈ aryl (e.g., -L-R, in which L is C₁₋₆ alkylene and R is C₄₋₁₈ aryl); and (26) —NR¹R², where each of R¹ and R² is, independently, selected from the group consisting of (a) hydrogen, (b) an N-protecting group, (c) C₁₋₆ alkyl, (d) C₂₋₆ alkenyl, (e) C₂₋₆ alkynyl, (f) C₄₋₁₈ aryl, (g) C₁₋₆ alkyl-C₄₋₁₈ aryl (e.g., -L-R, in which L is C₁₋₆ alkylene and R is C₄₋₁₈ aryl), (h) C₃₋₈ cycloalkyl, and (i) C₁₋₆ alkyl-C₃₋₈ cycloalkyl (e.g., -L-R, in which Lis C₁₋₆ alkylene and R is C₃₋₈ cycloalkyl), where in one embodiment no two groups are bound to the nitrogen atom through a carbonyl group or a sulfonyl group.

In some embodiments, the alkyl group is a primary, secondary, or tertiary alkyl group substituted with one or more substituents (e.g., one or more halo or alkoxy). In some embodiments, the unsubstituted alkyl group is a C₁₋₃, C₁₋₄, C₁₋₆, C₁₋₈, C₁₋₁₀, C₁₋₁₂, C₁₋₁₆, C₁₋₁₈, C₁₋₂₀, C₁₋₂₄, C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkyl group. Unless stated otherwise specifically in the specification, an alkyl group is optionally substituted by one or more of substituents that are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a})N(R^{a})₂, —N(R^{a})S(O)ₜR^{a} (where tis 1 or 2), —S(O)ₜR^{a} (where t is 1 or 2), —S(O)ₜOR^{a} (where t is 1 or 2), —S(O)ₜN(R^{a})₂ (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

By “alkylene” is meant a multivalent (e.g., bivalent) form of an aliphatic or alkyl group, as described herein. Exemplary alkylene groups include methylene, ethylene, propylene, butylene, etc. In some embodiments, the alkylene group is a C₁₋₃, C₁₋₄, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. In some embodiments, the alkylene group is branched or unbranched. The alkylene group is also substituted or unsubstituted. For example, in some embodiments, the alkylene group is substituted with one or more substitution groups, as described herein for alkyl.

The term “alkoxy” refers to the group-O-alkyl, including from 1 to 24 carbon atoms of a straight, branched, cyclic configuration and combinations thereof attached to the parent structure through an oxygen. Exemplary alkoxy groups include methoxy, ethoxy, propoxy, isopropoxy, cyclopropyloxy, butoxy, cyclohexyloxy, and trihaloalkoxy, such as trifluoromethoxy, etc. In some embodiments, the alkoxy group is substituted or unsubstituted. For example, in some embodiments, the alkoxy group is substituted with one or more substitution groups, as described herein for alkyl. Exemplary unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

The term “substituted alkoxy” refers to alkoxy wherein the alkyl constituent is substituted (e.g., —O-(substituted alkyl)). Unless stated otherwise specifically in the specification, the alkyl moiety of an alkoxy group is optionally substituted by one or more substituents the independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, —N(R^{a})C(NR^{a}) N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “alkylsilyl,” as used herein, refers to —SiR¹R²R³ group, wherein R¹ is an optionally substituted alkyl, and wherein each of R² and R³ is independently selected from H and an optionally substituted alkyl. Alkylsilyls include mono, bis, and tris alkylsilyls. Examples of alkylsilyls include trimethylsilyl, dimethylsilyl, methylsilyl, triethylsilyl, diethylsilyl, ethylsilyl, and the like.

By “alkylsulfinyl” is meant an alkyl group, as defined herein, attached to the parent molecular group through an —S(O)— group. In some embodiments, the unsubstituted alkylsulfinyl group is a C₁₋₆ or C₁₋₁₂ alkylsulfinyl group. In other embodiments, the alkylsulfinyl group is —S(O)—R, in which R is an alkyl group, as defined herein.

By “alkylsulfinylalkyl” is meant an alkyl group, as defined herein, substituted by an alkylsulfinyl group. In some embodiments, the unsubstituted alkylsulfinylalkyl group is a C₂₋₁₂ or C₂₋₂₄ alkylsulfinylalkyl group (e.g., C₁₋₆ alkylsulfinyl-C₁₋₆ alkyl or C₁₋₁₂ alkylsulfinyl-C₁₋₁₂ alkyl). In other embodiments, the alkylsulfinylalkyl group is -L-S(O)—R, in which L is alkylene, as defined herein, and R is an alkyl group, as defined herein.

By “alkylsulfonyl” is meant an alkyl group, as defined herein, attached to the parent molecular group through an —SO₂— group. In some embodiments, the unsubstituted alkylsulfonyl group is a C₁₋₆ or C₁₋₁₂ alkylsulfonyl group. In other embodiments, the alkylsulfonyl group is —SO₂—R, where R is an optionally substituted alkyl (e.g., as described herein, including optionally substituted C₁₋₁₂ alkyl, haloalkyl, or perfluoroalkyl).

By “alkylsulfonylalkyl” is meant an alkyl group, as defined herein, substituted by an alkylsulfonyl group. In some embodiments, the unsubstituted alkylsulfonylalkyl group is a C₂₋₁₂ or C₂₋₂₄ alkylsulfonylalkyl group (e.g., C₁₋₆ alkylsulfonyl-C₁₋₆ alkyl or C₁₋₁₂ alkylsulfonyl-C₁₋₁₂ alkyl). In other embodiments, the alkylsulfonylalkyl group is -L-SO₂—R, in which L is alkylene, as defined herein, and R is an alkyl group, as defined herein.

By “alkynyl” is meant an optionally substituted C₂₋₂₄ alkyl group having one or more triple bonds. The alkynyl group can be cyclic or acyclic and is exemplified by ethynyl, 1-propynyl, and the like. The alkynyl group can also be substituted or unsubstituted. For example, the alkynyl group can be substituted with one or more substitution groups, as described herein for alkyl. Non-limiting unsubstituted alkynyl groups include C₂₋₈ alkynyl, C₂₋₆ alkynyl, C₂₋₅ alkynyl, C₂₋₄ alkynyl, or C₂₋₃ alkynyl. Non-limiting examples of alkynyl groups include ethynyl (—C≡CH), 1-propynyl (—C≡CCH₃), 2-propynyl or propargyl (—CH₂C≡CH), 1-butynyl (—C≡CCH₂CH₃), 2-butynyl (—CH₂C≡CCH₃), 3-butynyl (—CH₂CH₂C≡CH), and the like. In some embodiments, the unsubstituted alkynyl group is a C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkynyl group.

By “alkynylene” is meant a multivalent (e.g., bivalent) form of an alkynyl group, which is an optionally substituted C₂₋₂₄ alkyl group having one or more triple bonds. The alkynylene group can be cyclic or acyclic. The alkynylene group can be substituted or unsubstituted. For example, the alkynylene group can be substituted with one or more substitution groups, as described herein for alkyl. Non-limiting examples of alkynylene groups include —C≡C— or —C≡CCH₂—.

By “amido” is meant —C(O)NR¹R² or —NHCOR¹, where each of R¹ and R² is, independently, selected from hydrogen, aliphatic, heteroaliphatic, haloaliphatic, haloheteroaliphatic, aromatic, as defined herein, or any combination thereof, or where R¹ and R², taken together with the nitrogen atom to which each are attached, can form a heterocyclyl group, as defined herein.

By “amino” or “amino” is meant a —N(R^{a})₂ radical group, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl, unless stated otherwise specifically in the specification. When a —N(R^{a})₂ group has two R^{a} substituents other than hydrogen, they can be combined with the nitrogen atom to form a 4-, 5-, 6- or 7-membered ring. For example, —N(R^{a})₂ is intended to include, but is not limited to, 1-pyrrolidinyl and 4-morpholinyl. Unless stated otherwise specifically in the specification, an amino group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, C(O)N(R^{a})₂, —N(R^{a})C(O)OR^{a}, —N(R^{a})C(O)R^{a}, —N(R^{a})C(O)N(R^{a})₂, ¬N(R^{a})C(NR^{a}) N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), or —PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “substituted amino” also refers to N-oxides of the groups —NHR^{a}, and NR^{a}R^{a} each as described above. N-oxides can be prepared by treatment of the corresponding amino group with, for example, hydrogen peroxide or m-chloroperoxybenzoic acid.

By “aminoalkyl” is meant an aliphatic or alkyl group, as described herein, substituted with one, two, three, or more amine groups. In some embodiments, the aminoalkyl includes internal amine groups or terminal amine groups. In some embodiments, the aminoalkyl group is further substituted. For example, in some embodiments, the aminoalkyl group is substituted with one or more substitution groups, as described herein for alkyl. Exemplary unsubstituted aminoalkyl groups include C₁₋₃, C₁₋₆, C₁₋₁₂, C₁₋₁₆, C₁₋₁₈, C₁₋₂₀, or C₁₋₂₄ aminoalkyl groups. In some embodiments, the aminoalkyl group is -L-NR¹R₂, in which L is an aliphatic or alkylene group, as defined herein, and each of R¹ and R² is, independently, selected from hydrogen, aliphatic, heteroaliphatic, haloaliphatic, haloheteroaliphatic, aromatic, as defined herein, or any combination thereof; or R¹ and R², taken together with the nitrogen atom to which each are attached, can form a heterocyclyl group, as defined herein. In other embodiments, the aminoalkyl group is -L-C(NR¹R₂) (R₃)—R⁴, in which L is a covalent bond, an aliphatic group, or an alkylene group, as defined herein; each of R¹ and R² is, independently, selected from hydrogen, aliphatic, heteroaliphatic, haloaliphatic, haloheteroaliphatic, aromatic, as defined herein, or any combination thereof; or R¹ and R², taken together with the nitrogen atom to which each are attached, can form a heterocyclyl group, as defined herein; and each of R³ and R⁴ is, independently, H or alkyl, as defined herein.

By “aminoaryl” is meant an aromatic or aryl group, as defined herein, substituted by an amino group, as defined herein.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system.

By “aryl” is meant an aromatic carbocyclic group comprising at least five carbon atoms to 15 carbon atoms (C₅₋₁₅), such as five to ten carbon atoms (C₅₋₁₀), having a single ring or multiple condensed rings, which condensed rings can or may not be aromatic provided that the point of attachment to a remaining position of the compounds disclosed herein is through an atom of the aromatic carbocyclic group. In some embodiments, aryl groups are substituted with one or more groups other than hydrogen, such as alkyl, as well as any substitution groups described herein for alkyl. Exemplary aryl groups include, but are not limited to, benzyl, naphthalene, phenyl, biphenyl, phenoxybenzene, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group. Aryl groups can have any suitable number of carbon ring atoms and any suitable number of rings. Aryl groups can include any suitable number of carbon ring atoms, such as C₆, C₇, C₈, C₉, C₁₀, C₁₁, C₁₂, C₁₃, C₁₄, C₁₅ or C₁₆, as well as C₆₋₁₂, C₆₋₁₀, or C₆₋₁₄. Bivalent radicals formed from substituted benzene derivatives and having the free valences at ring atoms are named as substituted phenylene radicals. Bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. Whenever it appears herein, a numerical range such as “6 to 10” (e.g., C₆-C₁₀ aromatic or C₆-C₁₀ aryl) refers to each integer in the given range; e.g., “6 to 10 ring atoms” means that the aryl group may consist of 6 ring atoms, 7 ring atoms, etc., up to and including 10 ring atoms. Aryl groups can be monocyclic, fused (i.e., rings which share adjacent pairs of ring atoms) to form bicyclic (e.g., benzocyclohexyl) or tricyclic groups or polycyclic groups, or linked by a bond to form a biaryl group. Representative aryl groups include phenyl, naphthyl and biphenyl. Other aryl groups include benzyl, having a methylene linking group. Unless stated otherwise specifically in the specification, an aryl moiety is optionally substituted by one or more substituents which are independently alkyl, heteroalkyl, acylsulfonamido, alkenyl, alkynyl, cycloalkyl, heterocycloalkyl, hydroxamate, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —S(O)ₜR^{a}— (where t is 1 or 2), —OC(O)—R^{a}, —N(R^{a})₂, C(O)R^{a}, C(O)OR^{a}, —OC(O)N(R^{a})₂, C(O)N(R^{a})₂, —N(R^{a})C(O)OR^{a}, —N(R^{a})C(O)R^{a}, N(R^{a})C(O)N(R^{a})₂, N(R^{a})C(NR^{a})N(R^{a})₂, N(R^{a})S(O)ₜR^{a} (where t is 1 or 2), —S(O)ₜR^{a} (where t is 1 or 2), —S(O)ₜOR^{a} (where t is 1 or 2), S(O)ₜN(R^{a})₂ (where t is 1 or 2), or PO(OR^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

By “arylene” is meant a multivalent (e.g., bivalent) form of an aromatic or aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. In some embodiments, the arylene group is branched or unbranched. In some embodiments, the arylene group is further substituted or unsubstituted. For example, In some embodiments, the arylene group is substituted with one or more substitution groups, as described herein for alkyl or aryl.

By “aryloxy” is meant-OR, where R is an optionally substituted aromatic or aryl group, as described herein. In some embodiments, an unsubstituted aryloxy group is a C₄₋₁₈ or C₆₋₁₈ aryloxy group.

By “carbonyl” is meant a —C(O)— group.

By “arylalkoxy” is meant an alkyl-aryl group, as defined herein, attached to the parent molecular group through an oxygen atom. In some embodiments, the arylalkoxy group is —O-L-R, in which L is an alkylene group, as defined herein, and R is an aryl group, as defined herein.

By “aryloxycarbonyl” is meant an aryloxy group, as defined herein, that is attached to the parent molecular group through a carbonyl group. In some embodiments, an unsubstituted aryloxycarbonyl group is a C₅₋₁₉ aryloxycarbonyl group. In other embodiments, the aryloxycarbonyl group is —C(O)O—R, in which R is an aryl group, as defined herein.

By “aryloyl” is meant an aryl group that is attached to the parent molecular group through a carbonyl group. In some embodiments, an unsubstituted aryloyl group is a C₇₋₁₁ aryloyl or C₅₋₁₉ aryloyl group. In other embodiments, the aryloyl group is —C(O)—R, in which R is an aryl group, as defined herein.

By “(aryl) (alkyl) ene” is meant a bivalent form including an arylene group, as described herein, attached to an alkylene or a heteroalkylene group, as described herein. In some embodiments, the (aryl) (alkyl) ene group is -L-Ar- or -L-Ar-L- or —Ar-L-, in which Ar is an aromatic or arylene group and each L is, independently, an optionally substituted aliphatic, alkylene group, heteroaliphatic, or heteroalkylene group.

By “borono” is meant a —B(OH)₂ group.

By “carbonyl” is meant a —C(O)— group, which can also be represented as >C═O, or a —CO— group.

By “carboxyl” or “carboxylic acid” is meant a —CO₂H group or a compound including such a group, including deprotonated and protonated forms thereof.

By “carboxyalkyl” is meant an alkyl group, as defined herein, substituted by one or more carboxyl groups, as defined herein.

By “carboxyaryl” is meant an aryl group, as defined herein, substituted by one or more carboxyl groups, as defined herein.

By “cyclic anhydride” is meant a 3-, 4-, 5-, 6- or 7-membered ring (e.g., a 5-, 6- or 7-membered ring), unless otherwise specified, having a —C(O)—O—C(O)— group within the ring. The term “cyclic anhydride” also includes bicyclic, tricyclic, and tetracyclic groups in which any of the above rings is fused to one, two, or three rings independently selected from the group consisting of an aryl ring, a cyclohexane ring, a cyclohexene ring, a cyclopentane ring, a cyclopentene ring, and another monocyclic heterocyclic ring. Exemplary cyclic anhydride groups include a radical formed from succinic anhydride, glutaric anhydride, maleic anhydride, phthalic anhydride, isochroman-1,3-dione, oxepanedione, tetrahydrophthalic anhydride, hexahydrophthalic anhydride, pyromellitic dianhydride, naphthalic anhydride, 1,2-cyclohexanedicarboxylic anhydride, etc., by removing one or more hydrogen. Other exemplary cyclic anhydride groups include dioxotetrahydrofuranyl, dioxodihydroisobenzofuranyl, etc. The cyclic anhydride group can also be substituted or unsubstituted. For example, the cyclic anhydride group can be substituted with one or more groups including those described herein for heterocyclyl.

By “cycloaliphatic” is meant an aliphatic group, as defined herein, that is cyclic.

By “cycloalkoxy” is meant a cycloalkyl group, as defined herein, attached to the parent molecular group through an oxygen atom. In some embodiments, the cycloalkoxy group is —O—R, in which R is a cycloalkyl group, as defined herein.

By “cycloalkylalkoxy” is meant an alkyl-cycloalkyl group, as defined herein, attached to the parent molecular group through an oxygen atom. In some embodiments, the cycloalkylalkoxy group is —O-L-R, in which L is an alkylene group, as defined herein, and R is a cycloalkyl group, as defined herein.

By “cycloalkyl” is meant a monovalent saturated or unsaturated non-aromatic cyclic hydrocarbon group of from three to eight carbons, unless otherwise specified, and is exemplified by cyclopropyl, cyclobutyl, cyclopentyl, cyclohexyl, cycloheptyl, bicyclo[2.2.1.heptyl], and the like. The cycloalkyl group can also be substituted or unsubstituted. For example, the cycloalkyl group can be substituted with one or more groups including those described herein for alkyl.

By “cycloheteroaliphatic” is meant a heteroaliphatic group, as defined herein, that is cyclic.

By “disulfide” is meant —SSR, where R is selected from hydrogen, aliphatic, heteroaliphatic, haloaliphatic, haloheteroaliphatic, aromatic, as defined herein, or any combination thereof.

By “formyl” is meant a —C(O)H group.

By “halo” is meant F, Cl, Br, or I.

By “haloaliphatic” is meant an aliphatic group, as defined herein, substituted with one or more halo.

By “haloalkyl” is meant an alkyl group, as defined herein, substituted with one or more halo.

By “haloalkenyl” is meant an alkenyl group, as defined herein, substituted with one or more halo.

By “haloalkynyl” is meant an alkynyl group, as defined herein, substituted with one or more halo.

By “haloalkylene” is meant an alkylene group, as defined herein, substituted with one or more halo.

By “halocarbonyl” is meant a —C(O)X group, in which X is halo, as defined herein.

By “haloheteroaliphatic” is meant a heteroaliphatic, as defined herein, in which one or more hydrogen atoms, such as one to 10 hydrogen atoms, independently is replaced with a halogen atom, such as fluoro, bromo, chloro, or iodo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to boron, halo, nitrogen, oxygen, phosphorus, selenium, silicon, sulfur, and, if applicable, oxidized forms thereof within the group.

By “heteroalkyl” is meant an aliphatic or alkyl group, as defined herein, containing one, two, three, or four non-carbon heteroatoms (e.g., independently selected from the group consisting of boron, halo, nitrogen (e.g., as present in imino), oxygen, phosphorus, selenium, silicon, sulfur, and, if applicable, oxidized forms thereof).

By “heteroalkylene” is meant a multivalent (e.g., bivalent) form of a heteroaliphatic or heteroalkyl group, as described herein. The heteroalkylene group can be substituted or unsubstituted. For example, in some embodiments, the heteroalkylene group is substituted with one or more substitution groups, as described herein for alkyl.

By “heteroalkenylene” is meant a multivalent (e.g., bivalent) form of a heteroalkenyl group, which is an optionally substituted heteroalkyl group having one or more double bonds. The heteroalkenylene group can be cyclic or acyclic. The heteroalkenylene group can be substituted or unsubstituted. For example, the heteroalkenylene group can be substituted with one or more substitution groups, as described herein for alkyl.

By “heteroalkynylene” is meant a multivalent (e.g., bivalent) form of a heteroalkynyl group, which is an optionally substituted heteroalkyl group having one or more triple bonds. The heteroalkynylene group can be cyclic or acyclic. The heteroalkynylene group can be substituted or unsubstituted. For example, the heteroalkynylene group can be substituted with one or more substitution groups, as described herein for alkyl.

By “heteroaromatic” is meant an aromatic group, as defined herein, including at least one heteroatom to 20 heteroatoms, such as one to 15 heteroatoms, or one to 5 heteroatoms, which can be selected from, but not limited to boron, nitrogen, oxygen, phosphorus, selenium, silicon, sulfur, and oxidized forms thereof within the group.

By “heteroaryl” is meant an aryl group including at least one heteroatom to six heteroatoms, such as one to four heteroatoms, which can be selected from, but not limited to, boron, nitrogen, oxygen, phosphorus, selenium, silicon, sulfur, and oxidized forms thereof within the ring. In some embodiments, such heteroaryl groups have a single ring or multiple condensed rings, where the condensed rings may or may not be aromatic or may contain a heteroatom, provided that the point of attachment is through an atom of the aromatic heteroaryl group. In some embodiments, heteroaryl groups are substituted with one or more groups other than hydrogen, such as alkyl, as well as any substitution groups described herein for alkyl. An exemplary heteroaryl includes a subset of heterocyclyl groups, as defined herein, which are aromatic, e.g., they contain 4n+2 pi electrons within the mono- or multicyclic ring system.

By “heteroarylene” is meant a multivalent (e.g., bivalent) form of a heteroaromatic or heteroaryl group, as described herein. Exemplary heteroarylene groups include pyridinylene and the like. In some embodiments, the heteroarylene group is a C₄₋₁₈, C₄₋₁₄, C₄₋₁₂, C₄₋₁₀, C₆₋₁₈, C₆₋₁₄, C₆₋₁₂, or C₆₋₁₀ heteroarylene group. In some embodiments, the heteroarylene group is branched or unbranched. In some embodiments, the heteroarylene group is further substituted or unsubstituted. For example, in some embodiments, the heteroarylene group is substituted with one or more substitution groups, as described herein for alkyl or aryl.

By “heterocyclyl” is meant a 3-, 4-, 5-, 6- or 7-membered ring (e.g., a 5-, 6- or 7-membered ring), unless otherwise specified, containing one, two, three, or four noncarbon heteroatoms (e.g., independently selected from the group consisting of nitrogen, oxygen, phosphorus, selenium, silicon, or sulfur). The 3-membered ring has zero to one double bonds, the 4- and 5-membered ring has zero to two double bonds, and the 6- and 7-membered rings have zero to three double bonds. The term “heterocyclyl” also includes bicyclic, tricyclic, tetracyclic, or other multicyclic groups. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl, benzylsultimyl, bipyrazinyl, bipyridinyl, carbazolyl (e.g., 4H-carbazolyl), carbolinyl (e.g., β-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxooxolanyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxolanyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for alkyl.

By “heterocyclyloxy” is meant a heterocyclyl group, as defined herein, attached to the parent molecular group through an oxygen atom. In some embodiments, the heterocyclyloxy group is —O—R, in which R is a heterocyclyl group, as defined herein.

By “heterocyclyloyl” is meant a heterocyclyl group, as defined herein, attached to the parent molecular group through a carbonyl group. In some embodiments, the heterocyclyloyl group is —C(O)—R, in which R is a heterocyclyl group, as defined herein.

By “hydroxyl” is meant —OH.

By “hydroxyalkyl” is meant an alkyl group, as defined herein, substituted by one to three hydroxy groups, with the proviso that no more than one hydroxy group may be attached to a single carbon atom of the alkyl group and is exemplified by hydroxymethyl, dihydroxypropyl, and the like.

By “hydroxyaryl” is meant an aryl group, as defined herein, substituted by one to three hydroxy groups, with the proviso that no more than one hydroxy group may be attached to a single carbon atom of the aryl group and is exemplified by hydroxyphenyl, dihydroxyphenyl, and the like.

By “imido” is meant a ═NR group, where R is selected from H, aliphatic, alkyl, heteroaliphatic, heteroalkyl, aromatic, or aryl, as defined herein, or any combination thereof.

By “imino” is meant —NR—, in which R can be H, optionally substituted aliphatic, alkyl, heteroaliphatic, heteroalkyl, aromatic, or aryl.

By “isocyanato” is meant a —NCO griyo.

By “nitro” is meant an —NO₂ group.

By “nitroalkyl” is meant an alkyl group, as defined herein, substituted by one to three nitro groups. In some embodiments, the nitroalkyl group is -L-NO, in which L is an alkylene group, as defined herein. In other embodiments, the nitroalkyl group is -L-C(NO) (R¹)—R², in which L is a covalent bond or an alkylene group, as defined herein, and each of R¹ and R² is, independently, H or alkyl, as defined herein.

By “oxiranyl” is meant a

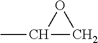

group or a

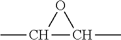

group, in which one or more hydrogen atoms can be optionally substituted with another functional group (e.g., halo, alkyl, or any described herein as a substituent for alkyl).

By “oxy” is meant —O—.

By “phosphono” or “phosphonic acid” is meant a —P(O)(OH)₂ group or a compound including such a group, including deprotonated and protonated forms thereof.

By “perfluoroalkyl” is meant an alkyl group, as defined herein, having each hydrogen atom substituted with a fluorine atom. Non-limiting examples of perfluoroalkyl groups include trifluoromethyl, pentafluoroethyl, etc. In some embodiments, the perfluoroalkyl group is —(CF₂)ₙCF₃, in which n is an integer from 0 to 20, 1 to 20, 1 to 18, 1 to 16, 1 to 14, 1 to 12, 1 to 10, 1 to 8, 2 to 20, 2 to 18, 2 to 16, 2 to 14, 2 to 12, 2 to 10, 2 to 8, and ranges therebetween.

By “perfluoroalkoxy” is meant an alkoxy group, as defined herein, having each hydrogen atom substituted with a fluorine atom. In some embodiments, the perfluoroalkoxy group is —O—R, in which R is a perfluoroalkyl group, as defined herein.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S. M. et al., “Pharmaceutical salts,” J. Pharm. Sci. 1977 January; 66 (1): 1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium).

By “silane” is meant —SiR^{S1}R^{S2}R^{S3} or a compound having such a group, where each of R³¹, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group.

By “silyl ether” is meant a functional group including a silicon atom covalently bound to an alkoxy group, as defined herein. In some embodiments, the silyl ether is —Si—O—R or Si—O—R, in which R is an alkyl group, as defined herein.

By “sulfinyl” is meant an —S(O)— group.

By “sulfo” or “sulfonic acid” is meant an —S(O)₂OH group or a compound including such a group, including deprotonated and protonated forms thereof.

By “sulfonyl” or “sulfonate” is meant an —S(O)₂— group or a —SO₂R, where R is selected from hydrogen, aliphatic, alkyl, heteroaliphatic, heteroalkyl, haloaliphatic, haloheteroaliphatic, aromatic, aryl, as defined herein, or any combination thereof.

By “thio” is meant —S—.

By “thioalkoxy” is meant an alkyl group, as defined herein, attached to the parent molecular group through a sulfur atom. Non-limiting examples of unsubstituted thioalkoxy groups include C₁₋₆ thioalkoxy. In some embodiments, the thioalkoxy group is —S—R, in which R is an aliphatic or alkyl group, as defined herein.

By “thioalkoxyalkyl” is meant an alkyl group, as defined herein, which is substituted with a thioalkoxy group, as defined herein. Non-limiting examples of unsubstituted thioalkoxyalkyl groups include between 2 to 12 carbons (C₂₋₁₂ thioalkoxyalkyl), as well as those having an alkyl group with 1 to 6 carbons and a thioalkoxy group with 1 to 6 carbons (i.e., C₁₋₆ thioalkoxy-C₁₋₆ alkyl). In some embodiments, the thioalkoxyalkyl group is -L-S—R, in which L is alkylene, as defined herein, and R is an alkyl group, as defined herein.

### Example Embodiments for Coated, Functionalized Materials

Disclosed herein is a functionalized material having a protective polymer coating for reversibly capturing (e.g., adsorbing) carbon dioxide (CO₂) and a method of producing such protected sorbents. In general, in some embodiments, functionalized material (e.g., the sorbent) are beads or powder over which gaseous mixtures including CO₂ are flowed. Without being limited to any one theory of operation, in some embodiments, gas exiting the layer of functionalized material has a lower concentration of CO₂ than the entering gas. During carbon capture adsorption and desorption processes, the functionalized material experiences mechanical attrition through handling, use, and transport through the capture and regeneration processes. Advantageously, providing a protective polymer coating on the functionalized material sorbents decreases friability and attrition of the sorbents, leading to longer product life and reduced production of fines.

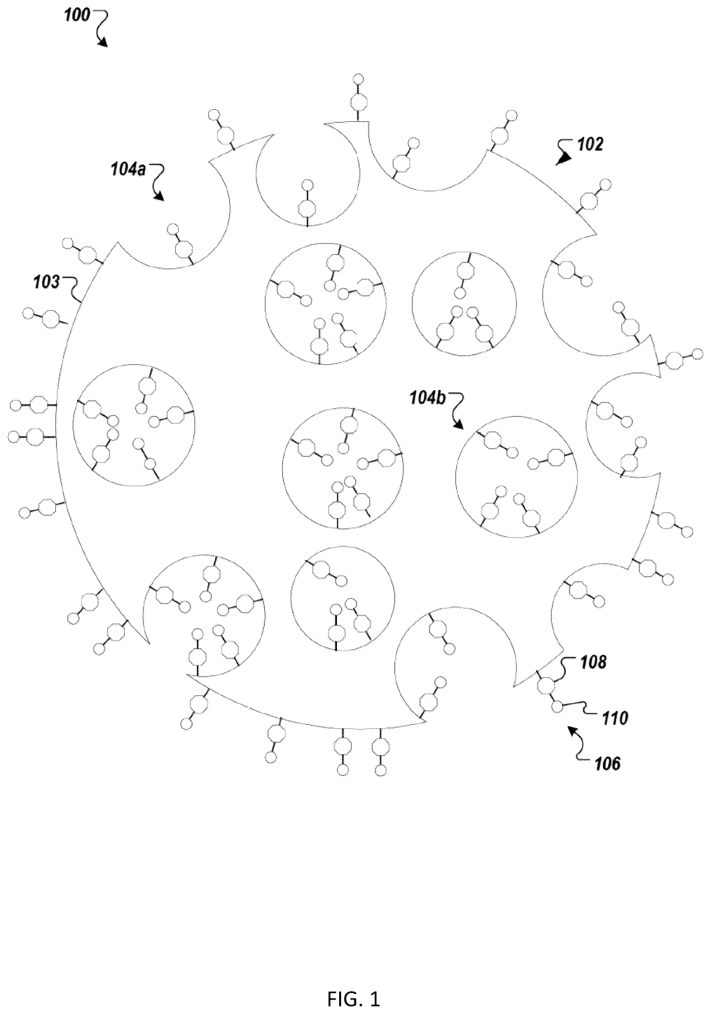

FIG. 1 is an exemplary unit of a coated particle 100, in accordance with some embodiments of the present disclosure. The coated particle 100 includes a substrate particle 102 having a protective polymer coating on at least a portion of the surface 103. The substrate particle 102 includes pores 104 which are openings which extend from the exterior surface of the substrate particle 102 into the interior volume. The pores 104 increase the surface area of the substrate particle 102 and, as such, are considered to be a part of the surface 103 of the substrate particle 102 in some embodiments. The dimensions of the pores 104 vary from pore to pore, and can vary within an individual pore. Two examples of the pores 104 include pore 104a and pore 104b. The polymer coating is disposed on some or all of the surface 103 including within the some or all of pores 104. In some embodiments, the polymer coating coats at least 10 percent, at least 20 percent, at least 30 percent, at least forty percent, at least 50 percent, at least 60 percent, at least 70 percent, at least 80 percent, at least 90 percent, or at least 90 percent of the available surface area of the substrate particle 102.

One example of the substrate particle 102 is composed of amorphous silica, e.g., non-crystalline silica. In some embodiments, other examples of compounds that provide the substrate particle 102 are porous alumina, calcium silicate, and sodium alumino silicate. In some embodiments, other examples of compounds that provide the substrate particle 102 are amorphous borosilicate, amorphous zirconium silicate, porous ziriconia (ZrO₂), calcium aluminate, amorphous magnesium silicate, zeolites, potassium alumino silicate, and amorphous lithium sulfate.

The depicted porous substrate particle 102 is substantially spherical, though, in some embodiments, the overall structure of the porous substrate particle 102 is any shape suitable for production, including having porous structures such as hexagonal tubes (e.g., MCM-41). In some embodiments, the porous substrate particle 102 is bead-shaped, though this is not limiting. In some embodiments, the porous substrate particle 102 is irregular-shaped.

In some embodiments the porous substrate particles have pore sizes from 10 nanometers to 200 nanometers. In other words, referring to FIG. 1, the pore size of pores 104 is between 10 nanometers and 200 nanometers. In some embodiments, the pore sizes of the porous substrate has a distribution of pore sizes, where at least 50 percent of the distribution of pore sizes in the plurality of porous substrate particles is between 10 nanometers and 200 nanometers. In some embodiments, the pore sizes of the porous substrate has a distribution of pore sizes, where at least 60 percent of the distribution of pore sizes in the plurality of porous substrate particles is between 10 nanometers and 200 nanometers. In some embodiments, the pore sizes of the porous substrate has a distribution of pore sizes, where at least 70 percent of the distribution of pore sizes in the plurality of porous substrate particles is between 10 nanometers and 200 nanometers. In some embodiments, the pore sizes of the porous substrate has a distribution of pore sizes, where at least 80 percent of the distribution of pore sizes in the plurality of porous substrate particles is between 10 nanometers and 200 nanometers. In some embodiments, the pore sizes of the porous substrate has a distribution of pore sizes, where at least 90 percent of the distribution of pore sizes in the plurality of porous substrate particles is between 10 nanometers and 200 nanometers. In some embodiments, the pore sizes of the porous substrate has a distribution of pore sizes, where at least 95 percent of the distribution of pore sizes in the plurality of porous substrate particles is between 10 nanometers and 200 nanometers. In some embodiments, the pore sizes of the porous substrate has a distribution of pore sizes, where the entire distribution of pore sizes in the plurality of porous substrate particles is between 10 nanometers and 200 nanometers.

In some embodiments the porous substrate particles have a distribution of sieve diameters between 0.4 millimeters and 4 millimeters. In some such embodiments, at least fifty percent of the porous substrate particles have a sieve diameter that is between 0.4 millimeters and 4 millimeters. In some such embodiments, at least sixty percent of the porous substrate particles have a sieve diameter that is between 0.4 millimeters and 4 millimeters. In some such embodiments, at least seventy percent of the porous substrate particles have a sieve diameter that is between 0.4 millimeters and 4 millimeters. In some such embodiments, at least eighty percent of the porous substrate particles have a sieve diameter that is between 0.4 millimeters and 4 millimeters. In some such embodiments, at least ninety percent of the porous substrate particles have a sieve diameter that is between 0.4 millimeters and 4 millimeters. In some such embodiments, at least 95 percent of the porous substrate particles have a sieve diameter that is between 0.4 millimeters and 4 millimeters. In some such embodiments, all of the porous substrate particles have a sieve diameter that is between 0.4 millimeters and 4 millimeters.

In some embodiments the porous substrate particles have pore sizes from 50 Angstroms to 300 Angstroms. In other words, referring to FIG. 1, the pore size of pores 104 is between 50 Angstroms and 300 Angstroms. In some embodiments, the pore sizes of the porous substrate has a distribution of pore sizes, where at least 50 percent of the distribution of pore sizes in the plurality of porous substrate particles is between 50 Angstroms and 300 Angstroms. In some embodiments, the pore sizes of the porous substrate has a distribution of pore sizes, where at least 60 percent of the distribution of pore sizes in the plurality of porous substrate particles is between 50 Angstroms and 300 Angstroms. In some embodiments, the pore sizes of the porous substrate has a distribution of pore sizes, where at least 70 percent of the distribution of pore sizes in the plurality of porous substrate particles is between 50 Angstroms and 300 Angstroms. In some embodiments, the pore sizes of the porous substrate has a distribution of pore sizes, where at least 80 percent of the distribution of pore sizes in the plurality of porous substrate particles is between 50 Angstroms and 300 Angstroms. In some embodiments, the pore sizes of the porous substrate has a distribution of pore sizes, where at least 90 percent of the distribution of pore sizes in the plurality of porous substrate particles is between 50 Angstroms and 300 Angstroms. In some embodiments, the pore sizes of the porous substrate has a distribution of pore sizes, where at least 95 percent of the distribution of pore sizes in the plurality of porous substrate particles is between 50 Angstroms and 300 Angstroms. In some embodiments, the pore sizes of the porous substrate has a distribution of pore sizes, where the entire distribution of pore sizes in the plurality of porous substrate particles is between 50 Angstroms and 300 Angstroms.

In some embodiments, the polymer coating disposed on the surface 103 is a polymer, or mixture of polymers, which alters the mechanical characteristics of the porous substrate particle 102. One example of the polymer that makes up the polymer coating is polyvinyl alcohol (PVA), a water-soluble synthetic polymer having the formula [CH₂CH(OH)]ₙ, where n is a positive integer. PVA is readily available from commercial sources and has low toxicity for safe handling during application.

Additional non-limiting examples of polymers which provide the coating contemplated for use in the present disclosure include pebax, polyether block amide (PEBA), polysulfones, polyethersulfones, polyethers, polyamides, ethylcellulose, polyethylene glycol, cellulose acetate, polyurethanes, polystyrenes, polyesters, polyolefins, polyacrylamides, polyacrylates, and combinations, copolymers, and/or block copolymers of those listed herein.

In some embodiments, the polymer coating is disposed on the porous substrate particle 102 to achieve desirable outcomes for the total coated particle 100 under mechanical stresses, such as abrasion. In some embodiments, the polymer coating decreases the attrition of the coated particle 100 according to one or more standardized testing requirements. Briefly, attrition is the propensity of a product to produce fines in the course of transportation, handling, and use. In some embodiments, the polymer coating reduces the attrition such that an attrition loss of the particles 100 is 1% or less (e.g., 0.9% or less, 0.8% or less) as measured by ASTM D4058-96 or comparable standards by which attrition, friability, or attrition loss, is quantified. In some embodiments, the coated particle 100 is characterized by mechanical properties including compressive strength. In some embodiments, the functionalized material is durable, e.g., having a 50% strain crush strength of at least 1.5 megapascals (MPa) (e.g., at least 2 MPa, at least 3 MPa), e.g., have a 50% strain crush strength in a range from 1.5 to 3.5 MPa.

In some embodiments, the coated particle 100 reversibly adsorbs CO₂ over a number of cycles, e.g., a number of adsorption and desorption steps. Higher cycle counts achieve longer product lifetimes when used in CO₂ capture application. In some implementations, the coated particle 100 reversibly adsorbs CO₂ over 100 cycles (e.g., over 500 cycles, over 1000 cycles, over 2000 cycles, over 3000 cycles). Here and throughout the specification, reference to a measurable value such as an amount, a temporal duration, and the like, the recitation of the value encompasses the precise value, approximately the value, and within ±10% of the value. For example, here 100 cycles includes precisely 100 cycles, approximately 100 cycles, and within ±10% of 100 cycles.

In some embodiments, CO₂ adsorbed to the coated particle 100 is released (e.g., desorbed) under some conditions. As one example, in some embodiments, reducing the gas pressure surrounding the coated particle 100 desorbs captured CO₂. This facilitates recapture of the adsorbed CO₂ in a secondary environment. In some implementations, the coated particle 100 is exposed to a reduced gas pressure of less than 5 psi (e.g., less than 3 psi, less than 1.5 psi, less than 1 psi, or less than 0.1 psi).

As a second example, in some embodiments, increasing the temperature of the coated particle 100 destabilizes the bond between the amine moiety and the CO₂, thereby desorbing the CO₂ from the coated particle 100. In some implementations, the coated particle 100 desorbs CO₂ at temperatures above 40° C. (e.g., above 50° C., above 60° C., above 70° C., above 80° C., or above 90° C.). Increasing the temperature and decreasing gas pressure concurrently can increase the rate at which the CO₂ desorbs from the coated particle 100.

### Substrate Particles.

In some embodiments, the sieve diameter of the porous substrate particle is a measure of central tendency determined over the sieve diameter of a plurality of porous substrate particles. As used herein, the term sieve diameter is the smallest mesh size through which a particle can pass. As used herein, the term “measure of central tendency” refers to a central or representative value for a distribution of values. Non-limiting examples of measures of central tendency include a mean, arithmetic mean, weighted mean, midrange, midhinge, trimean, geometric mean, geometric median, Winsorized mean, median, and mode of the distribution of values. For instance, in some embodiments, the sieve diameter of the porous substrate particles is an average sieve diameter of a plurality of porous substrate particles used for generating the functionalized material.

In some embodiments, the plurality of porous substrate particles comprises a distribution of sieve diameters.

In some embodiments, the sieve diameter, or the measure of central tendency (e.g., mean) thereof, for the plurality of porous substrate particles is at least 0.2 millimeters (mm), at least 0.3 mm, at least 0.4 mm, at least 0.5 mm, at least 0.6 mm, at least 0.7 mm, at least 1 mm, at least 1.5 mm, at least 2 mm, at least 2.5 mm, at least 3 mm, at least 3.5 mm, at least 4 mm, or at least 5 mm. In some embodiments, the sieve diameter, or the measure of central tendency (e.g., mean) thereof, for the plurality of porous substrate particles is no more than 10 mm, no more than 5 mm, no more than 4 mm, no more than 3.5 mm, no more than 3 mm, no more than 2.5 mm, no more than 2 mm, no more than 1.5 mm, no more than 1 mm, no more than 0.5 mm, or no more than 0.3 mm. In some embodiments, the sieve diameter, or the measure of central tendency (e.g., mean) thereof, for the plurality of porous substrate particles is from 0.2 mm to 1 mm, from 0.5 mm to 2 mm, from 1 mm to 4 mm, from 0.4 mm to 4 mm, from 3 mm to 5 mm, or from 4 mm to 10 mm. In some embodiments, the sieve diameter, or the measure of central tendency (e.g., mean) thereof, for the plurality of porous substrate particles falls within another range starting no lower than 0.2 mm and ending no higher than 10 mm.

In some embodiments, the sieve diameter of the porous substrate particle 102 varies based on the application and/or the source. In some embodiments, the porous substrate particle 102 has an average sieve diameter in the range from 0.25 mm to 4.0 mm (e.g., 0.25 mm to 1.5 mm, 0.5 mm to 1.5 mm, 0.5 mm to 1.0 mm, 1.0 mm to 2.0 mm, 1.5 to 2.0 mm, 0.5 mm to 4.0 mm, 1.0 mm to 4.0 mm, or 2.0 mm to 4.0 mm). In some embodiments, the porous substrate particle 102 has a distribution of sieve diameters having an average (e.g., mean) diameter ranging from 1 mm to 1.2 mm. In some embodiments, the distribution of sieve diameters for the plurality of porous substrate particles comprises sieve diameters of from 0.2 mm to 1 mm, from 0.5 mm to 2 mm, from 1 mm to 4 mm, from 0.4 mm to 4 mm, from 3 mm to 5 mm, from 0.2 mm to 5 mm, from 1 mm to 8 mm, from 0.3 mm to 5 mm, from 0.2 mm to 10 mm, or from 4 mm to 10 mm. In some embodiments, the distribution of sieve diameters for the plurality of porous substrate particles falls within another range starting no lower than 0.2 mm and ending no higher than 10 mm.

The width of the distribution around the average sieve diameter affects adsorption performance of the porous substrate particle 102. In some implementations, the width of the distribution is in a range from 100 μm to 500 μm around the average (e.g., from 100 μm to 400 μm, or 200 μm to 300 μm). In some embodiments, the width of the distribution is at least 25 μm, at least 50 μm, at least 100 μm, at least 200 μm, at least 300 μm, at least 400 μm, at least 500 μm, at least 800 μm, at least 1 mm, at least 2 mm, or at least 3 mm. In some embodiments, the width of the distribution is no more than 5 mm, no more than 3 mm, no more than 2 mm, no more than 1 mm, no more than 500 μm, no more than 200 μm, or no more than 100 μm. In some embodiments, the width of the distribution is from 25 μm to 200 μm, from 100 μm to 500 μm, from 100 μm to 1 mm, from 500 μm to 2 mm, from 1 mm to 3 mm, or from 2 mm to 5 mm. In some embodiments, the width of the distribution falls within another range starting no lower than 2 μm and ending no higher than 10 mm.

Without being limited to any one theory of operation, in general, larger particles take longer to saturate with CO₂ since the CO₂ has further to travel to reach the interior, e.g., higher overall absorptive surface area, and therefore have slower adsorption/desorption kinetics than smaller particles. Advantageously, in some embodiments, larger particles last longer under attrition conditions, e.g., regular handling or movement, as they have a higher breakdown capacity before the particles are converted completely to fines (<0.5 mm) than smaller particles. Larger particles utilize higher coating materials in some manufacturing methods (e.g., spray on coating) to achieve complete coating as the larger particles have larger interiors that are further from the surfaces compared to smaller particles.

In some embodiments, the width of the distribution is alternatively described using D90, D50, or D10 values. These values signify a percentage of the total distribution of the material diameters in the sample is contained, up to and including the value. For example, a D90 of 500 μm indicates 90% of the sample (e.g., the plurality of porous particles) within a sample has a size of 500 μm or smaller. In some embodiments, the coated particle 100 has a D10 value of 30 μm or a D90 value of 150 μm. In some examples, the coated particle 100 has a D10 value of 100 μm or a D90 value of 500 μm, a D10 value of 150 μm or a D90 value of 400 μm, a D10 value of 200 μm or a D90 value of 300 μm.

In some embodiments, the plurality of porous substrate particles comprises a D90 for any of the sieve diameters disclosed herein, and/or any of the measures of central tendency or distributions thereof. For instance, in some embodiments, the plurality of porous substrate particles comprises a D90 of 2 mm, indicating that 90% of the porous substrate particles have a sieve diameter of 2 mm or smaller. In some embodiments, the plurality of porous substrate particles comprises a D50 for any of the diameters disclosed herein, and/or any of the measures of central tendency or distributions thereof. In some embodiments, the plurality of porous substrate particles comprises a D10 for any of the sieve diameters disclosed herein, and/or any of the measures of central tendency or distributions thereof.

In general and without wishing to be bound by theory, smaller particle 100 size advantageously facilitates better mechanical resistance to attrition, decreased friability, and enables higher CO₂ capture capacity. In some embodiments, smaller porous substrate particle 102 results in higher inter-particle volumes that enables higher gas flow capacity and faster adsorption as gas diffusion paths are shorter in the coated particle 100 as a whole. Further, smaller porous substrate particle 102 size enables relatively higher total coated particle 100 surface area leading to higher amine coating concentrations. Smaller porous substrate particle 102 size, e.g., average sieve diameter, reduces the adsorption process energy cost for a fluidization process.

In some embodiments, the pore size of the porous substrate particle is a measure of central tendency determined over the pore size found in a plurality of porous substrate particles. For instance, in some embodiments, the pore size of the porous substrate particles is an average pore size over the pores found in a plurality of porous substrate particles used for generating the functionalized material. In some embodiments, the plurality of porous substrate particles comprises a distribution of pore sizes.

In some embodiments, the pore size for the porous substrate particle, or the plurality of porous substrate particles, is measured as a diameter of a pore, pore volume, and/or surface area for the porous substrate particle, including but not limited to a Brunauer, Emmett and Teller (BET) surface area. Generally, BET surface area refers to a technique for determining the surface area of particles. Samples are introduced to a probe gas that physically adsorbs to the surface of the sample. The volume of probe gas adsorbed is measured to determine the quantity of gas required to cover the surface of the sample. The BET theory is then applied to the adsorption data to generate a specific surface area, reported in units of area per mass of sample (m²/g). See, for example, “BET Specific Surface Area,” available on the Internet at particletechlabs.com/analytical-testing/bet-specific-surface-area.

In some embodiments, the pore size of the pores 104 is in a range from 60 angstroms (Å) to 700 Å (e.g., 80 Å to 300 Å, 100 Å to 200 Å, 150 Å to 250 Å, 60 Å to 300 Å, 100 Å to 700 Å, 200 Å to 700 Å, 300 Å to 700 Å, 500 Å to 700 Å, 100 Å to 500 Å, or 300 Å to 500 Å). In some implementation, the pores 104 have an average pore size or a mean pore size from about 60 Angstroms to 400 Angstroms. In some implementations, the diameter of the pores 104 is greater than 90 Å (e.g., greater than 100 Å, greater than 120 Å, greater than 150 Å). Larger pore sizes of the pores 104 increases adsorption and desorption rates and facilitates higher filling of the pores 104 with amine moieties without pore-clogging which can reduce adsorption and desorption efficiency.

In some embodiments, the pore size, or the measure of central tendency (e.g., mean) thereof, for the pores in the plurality of porous substrate particles is at least 10 Å, at least 20 Å, at least 40 Å, at least 50 Å, at least 60 Å, at least 80 Å, at least 100 Å, at least 200 Å, at least 300 Å, at least 400 Å, at least 500 Å, at least 800 Å, at least 1000 Å, at least 1500 Å, at least 2000 Å, or at least 3000 Å. In some embodiments, the pore size, or the measure of central tendency (e.g., mean) thereof, for the pores in the plurality of porous substrate particles is no more than 5000 Å, no more than 3000 Å, no more than 2000 Å, no more than 1000 Å, no more than 800 Å, no more than 500 Å, no more than 200 Å, no more than 100 Å, no more than 60 Å, or no more than 20 Å. In some embodiments, the pore size, or the measure of central tendency (e.g., mean) thereof, for the pores in the plurality of porous substrate particles is from 10 Å to 200 Å, from 60 Å to 1000 Å, from 100 Å to 800 Å, from 200 Å to 2000 Å, or from 500 Å to 5000 Å. In some embodiments, the pore size, or the measure of central tendency (e.g., mean) thereof, for the pores in the plurality of porous substrate particles falls within another range starting no lower than 10 Å and ending no higher than 5000 Å.

In some embodiments, the pore size, or the measure of central tendency (e.g., mean) thereof, for the pores in the plurality of porous substrate particles is from 10 nanometers (nm) to 200 nm (100 Å to 2000 Å), from 1 nm to 200 nm (10 Å to 2000 Å), and/or from 30 nm to 80 nm (300 Å to 800 Å).

In some embodiments, the pores 104 extend into the central volume of the porous substrate particle 102 and form interconnected channels. In some embodiments, the pores 104 create a volume within the porous substrate particle 102 in which gases may flow and create additional surface area for functionalization. In some embodiments, the volume of the pores 104 is greater than 0.5 mL/g, and preferentially greater than 0.8 mL/g (e.g., greater than 1 mL/g, greater than 1.2 mL/g, greater than 1.5 mL/g, or greater than 1.8 mL/g). In some embodiments, advantageously, increased total volume of the pores 104 increases the adsorption potential of the coated particle 100. In some embodiments, the pores 104 have an irregularly round cross-sectional shape, or a hexagonal cross-sectional shape, though this is not limiting.

In some embodiments, the pore volume, or the measure of central tendency (e.g., mean) thereof, for the plurality of porous substrate particles is at least 0.1 mL/g, at least 0.2 mL/g, at least 0.5 mL/g, at least 0.1 mL/g, at least 1 mL/g, at least 1.2 mL/g, at least 1.5 mL/g, at least 2 mL/g, at least 2.5 mL/g, at least 3 mL/g, at least 3.5 mL/g, at least 4 mL/g, at least 4.5 mL/g, at least 5 mL/g, or at least 8 mL/g. In some embodiments, the pore volume, or the measure of central tendency (e.g., mean) thereof, for the plurality of porous substrate particles is no more than 10 mL/g, no more than 5 mL/g, no more than 3 mL/g, no more than 2 mL/g, no more than 1.5 mL/g, no more than 1 mL/g, no more than 0.5 mL/g, no more than 0.3 mL/g, or no more than 0.2 mL/g. In some embodiments, the pore volume, or the measure of central tendency (e.g., mean) thereof, for the plurality of porous substrate particles is from 0.1 mL/g to 0.8 mL/g, from 0.5 mL/g to 1.5 mL/g, from 0.8 mL/g to 3 mL/g, from 1 mL/g to 4 mL/g, from 3 mL/g to 10 mL/g, from 0.5 mL/g to 5 mL/g, or from 0.1 mL/g to 10 mL/g. In some embodiments, the pore volume, or the measure of central tendency (e.g., mean) thereof, for the plurality of porous substrate particles falls within another range starting no lower than 0.1 mL/g and ending no higher than 10 mL/g.

In some embodiments, the surface area of the porous substrate particle is total surface area. In some embodiments, the total surface area of the porous substrate particle 102 includes the surface 103 and the surface area within the pores 104. In some embodiments, the total surface area is greater than 100 m² per dry gram (m²/g) of porous substrate particle 102, and in some implementations, the total surface area is greater than 300 m²/g (e.g., greater than 200 m²/g, greater than 400 m²/g, greater than 500 m²/g, or greater than 700 m²/g). Advantageously, in some embodiments, higher total surface area increases the available area for functionalization, and increases the adsorption potential of the coated particle 100. In some embodiments, the surface area of a porous substrate particle is a BET surface area.

In some embodiments, the surface area of the porous substrate particle comprises at least 10 m²/g, at least 50 m²/g, at least 100 m²/g, at least 200 m²/g, at least 300 m²/g, at least 400 m²/g, at least 500 m²/g, at least 600 m²/g, at least 700 m²/g, at least 1000 m²/g, or at least 2000 m²/g. In some embodiments, the surface area of the porous substrate particle comprises no more than 5000 m²/g, no more than 2000 m²/g, no more than 1000 m²/g, no more than 500 m²/g, no more than 200 m²/g, no more than 100 m²/g, or no more than 50 m²-/g. In some embodiments, the surface area of the porous substrate particle comprises from 10 m²/g to 200 m²/g, from 50 m²/g to 500 m²/g, from 100 m²/g to 1000 m²/g, from 200 m²/g to 800 m²/g, from 500 m²/g to 2000 m²/g, or from 1000 m²/g to 5000 m²/g. In some embodiments, the surface area of the porous substrate particle falls within another range starting no lower than from 10 m²/g and ending no higher than from 5000 m²/g.

### Surface Modifications.

In some embodiments, the surface 103 of the coated particle 100 is functionalized by a CO₂ absorbing compound 106 including an aminosilane (silane-functionalized amine or an amino-functionalized silane) 108 and a polymeric amine 110. In some embodiments, together the aminosilane 108 and a polymeric amine 110 form a network and provide the stable CO₂ absorbing function. In some embodiments, the aminosilane 108 includes at least one silane group (e.g., one, two, three, or more silane groups) and at least one amine group. In some embodiments, the aminosilane 108 is covalently bonded to the exterior surface of the porous substrate particle 102 and within the pores 104. In some embodiments, the aminosilane 108 includes one to three or more silane groups, e.g., silane group 208. In some implementations, the silane group is a methoxysilane, triethoxysilane, and the like), a dialkoxysilanol group (e.g., Si(OR)₂OH, in which each R is independently alkyl), a hydrosilane group (e.g., —SiH₃), a dialkylsilane (e.g., -SiR^{S1}R^{S2}R^{S3}, in which each of R^{S1} and R^{S2} is independently alkyl, and R^{S3} is a reactive group or a leaving group, such as any described herein; and in which a non-limiting example of dialkylsilane is dialkylalkoxysilane or dialkylhalosilane), a monoalkylsilane group (e.g., -SiR^{S1}R^{S2}R^{S3}, in which R^{S1} is alkyl, and each of R^{S2} and R^{S3} is independently a leaving group or a reactive group, such as any described herein; and in which a non-limiting example of monoalkysilane is alkyldialkoxysilane or alkyldihalosilane), a trihalosilane group (e.g., —SiZ₃, in which each Z is independently halo, such as trichlorosilane), or a silanetriol group (e.g., —Si(OH)₃), as well as others described herein. Without being limited to any one theory of operation, higher numbers (e.g., three or more) of silane moieties in the aminosilane 108 increase the covalent bond stability with the porous substrate particle 102 as higher numbers of siloxane bonds between the silane moieties and the porous substrate particle 102 surfaces increase. In the case of more than three silane groups, this refers to a molecule such as, but not limited to, bis(3-trimethoxysilylpropyl)amine. Additionally, a silane moiety can form up to 3 siloxane bonds (Si—O—Si) to the porous substrate surface which increases stability. The number of siloxane bonds that can be formed by the silane moiety depends on the composition of the groups (X¹-X³) capable of forming siloxane bonds (e.g., —OMe, —OEt, —Cl, —OH, or a combination of any of these).

In some embodiments, the aminosilane compound has any useful structure. In one non-limiting example, the aminosilane includes a structure having formula (I):

[R^{A}]ₐSi[X]₄₋ₐ (I),

where each R^{A} is, independently, an amine moiety comprising at least one amine group, each X is, independently, a side group, a reactive group, or a leaving group, and a is an integer from 1 to 4.

In some embodiments, the amine moiety (e.g., R^{A}) includes one or more amine groups. In one instance, the amine group is —NR^{N1}R^{N2} or —NR^{N1}—, in which each of R^{N1} and R^{N2} is, independently, hydrogen (H), halo (e.g., F, Cl, Br, or I), hydroxyl (e.g., —OH), optionally substituted alkyl, optionally substituted aminoalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl). In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety (e.g., R^{A}) includes one, two, three, or more amine groups. In other embodiments, the amine moiety includes a terminal amine group (e.g., as —NR^{N1}R^{N2}) and/or an internal amine group (e.g. as —NR^{N1}—).

Non-limiting examples of amine moieties (e.g., R^{A}) include —NR^{N1}R^{N2}, -L-NR^{N1}R^{N2}, —NR^{N3}-L-NR^{N1}R^{N2}, -L²-NR^{N3}-L¹-NR^{N1}R^{N2}, -L³-NR^{N4}-L²-NR^{N3}-L¹-NR^{N1}R^{N2}, L²-SiR^{S1}R^{S2}-L¹-NR^{N1}R^{N2}, and -L³-SiR^{S1}R^{S2}-L²-NR^{N3}-L¹-NR^{N1}R^{N2} in which each of R^{N1}, R^{N2}, R^{S1}, and R^{S2} are any described herein; in which each of R^{N3} and R^{N4} are any described herein for R^{N1} and R^{N2}; and in which each L, L¹, L², or L³ is independently a linker. Non-limiting examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{N1}, R^{N2}, R^{N3}, R^{N4}, R^{S1}, and R^{S2} is, independently, H, optionally substituted aliphatic, or optionally substituted alkyl. Other examples of R^{N1}, R^{N2}, and R^{N3} are described herein.

In some embodiments, the aminosilane includes a reactive group, a leaving group, or another group (e.g., X). Non-limiting examples of such groups include H, halo (e.g., F, Cl, Br, or I), hydroxyl (e.g., —OH), optionally substituted alkyl, optionally substituted aminoalkyl, optionally substituted alkoxy (e.g., —OR, in which R is an optionally substituted alkyl), optionally substituted aryl, optionally substituted aryloxy (e.g., —OR, in which R is an optionally substituted aryl), or optionally substituted alkanoyloxy. In some embodiments, X is, independently, H, optionally substituted aliphatic, optionally substituted heteroaliphatic, optionally substituted aromatic, or optionally substituted heteroaromatic.

In one non-limiting example, the aminosilane includes a structure having formula Ia:

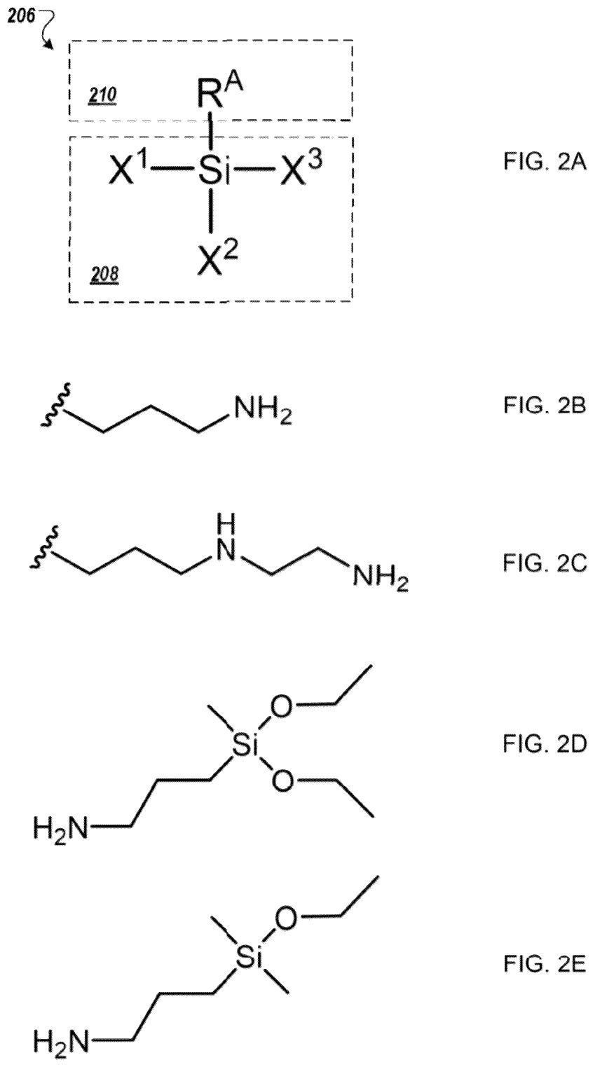

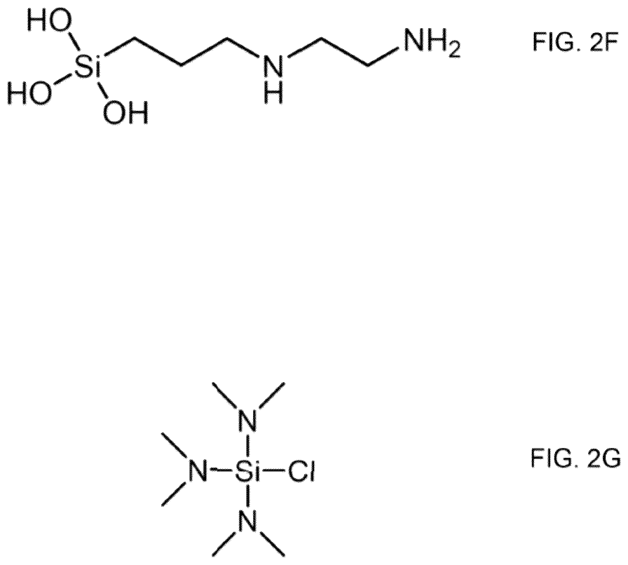

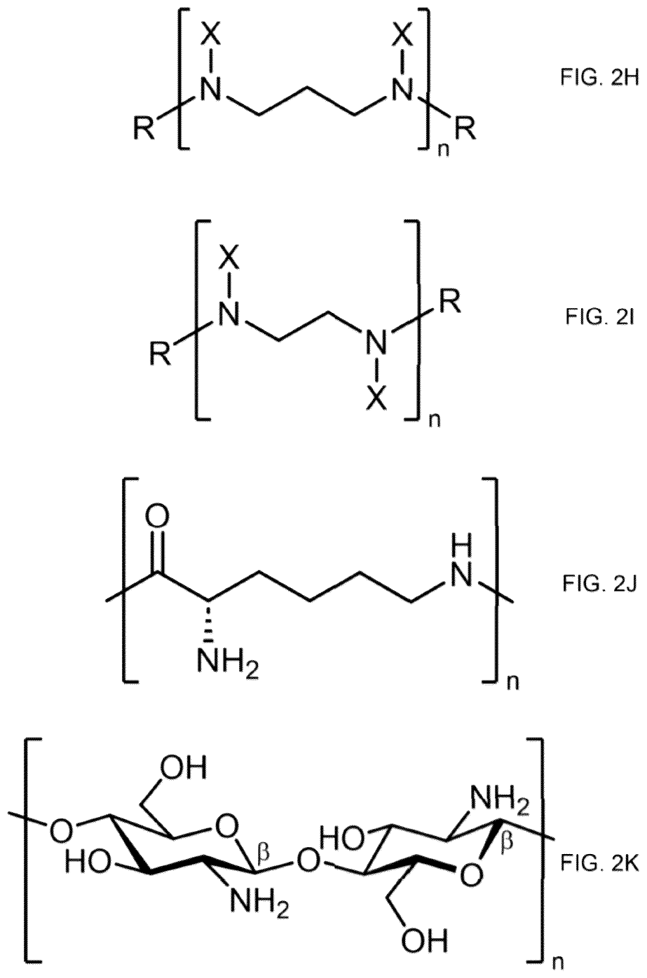

R^{A1}SiX¹X²X₃ (Ia),

where R^{A1} is an amine moiety comprising at least one amine group; and each of X¹, X², and X³ is, independently, a side group, a reactive group, or a leaving group. Each of R^{A1}, X¹, X², and X³ is any described herein for R^{A} and X. An example of formula IA is shown in FIG. 2A (where the terms R^{A1} and R^{A} are interchangeable).

In another non-limiting example, the aminosilane includes a structure having formula Ib, Ic, Id, or Ie:

R^{A1}-L¹-SiX¹X²X³ (Ib),

R^{N1}R^{N2}N-L¹-SiX¹X²X³ (Ic),

R^{A1}-L¹-R^{A2}-L²-SiX¹X²X³ (Id), or

R^{N1}R^{N2}N-L¹-N(R^{N3})-L²-SiX¹X²X³ (Ie),

where Nis nitrogen, each R^{A1} or R^{A2} is, independently, an amine moiety comprising at least one amine group, each of R^{N1}, R^{N2}, and R^{N3} is any described herein, each of X¹, X², and X³ is, independently, a side group, a reactive group, or a leaving group, and each of L¹ and L² is a linker. In some embodiments, each of R^{A1}, R^{A2}, X¹, X², X³, L¹, and L² is any described herein for R^{A}, X, and L, respectively. In some embodiments, each of X¹, X², and X³ is, independently, H, halo, optionally substituted alkyl (e.g., optionally substituted C₁₋₃ alkyl), or optionally substituted alkoxy (e.g., optionally substituted C₁₋₃ alkoxy). In other embodiments, each of X¹, X², and X³ is, independently, optionally substituted alkoxy (e.g., optionally substituted C₁₋₃ alkoxy). In yet other embodiments, L is optionally substituted alkylene (e.g., optionally substituted C₁₋₁₂, C₁₋₁₀, C₁₋₈, or C₁₋₆ alkylene).

In yet another non-limiting example, the aminosilane includes a structure having formula If:

R^{A1}R^{A2}R^{A3}SiX¹ (If),

where each R^{A1}, R^{A2}, or R^{A3} is, independently, an amine moiety comprising at least one amine group; and X¹ is a side group, a reactive group, or a leaving group. In some embodiments, each of R^{A1}, R^{A2}, R^{A3}, and X¹ is any described herein for R^{A} and X, respectively.

In some embodiments, the aminosilane includes a structure of formula II:

[R^{B}]_{b}N[Y]_{3-b} (II),

where N is nitrogen, each R^{B} is, independently, a silane moiety comprising at least one silane group, each Y is, independently, H, optionally substituted alkyl, or optionally substituted aryl; and b is an integer from 1 to 3. In some embodiments, each Y is, independently, H, optionally substituted aliphatic, optionally substituted heteroaliphatic, optionally substituted aromatic, or optionally substituted heteroaromatic.

In some embodiments, the silane moiety (e.g., R^{B}) includes one or more silane groups. In one instance, the silane group is —SiR^{S1}R^{S2}R^{S3} or —SiR^{S1}R^{S2}—, in which each of R^{S1}, R^{S2}, and R^{S3} is, independently, hydrogen (H), halo (e.g., F, Cl, Br, or I), hydroxyl (e.g., —OH), optionally substituted alkyl, optionally substituted aminoalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl). In some embodiments, each of R^{S1}, R^{S2}, R^{S3}, and R is, independently, H, optionally substituted aliphatic, optionally substituted heteroaliphatic, optionally substituted aromatic, or optionally substituted heteroaromatic.

In some embodiments, the silane moiety (e.g., R^{B}) includes one, two, three, or more silane groups. In some embodiments, the silane moiety includes a terminal silane group (e.g., as —SiR^{S1}R^{S2}R^{S3}) and an internal silane group (e.g. as —SiR^{S1}R^{S2}—).

Non-limiting examples of silane moieties (e.g., R^{B}) include —SiR^{S1}R^{S2}R^{S3}, Si(OR^{S1})(R^{S2})(R^{S3}), —Si(OR^{S1})(OR^{S2})(R^{S3}), —Si(OR^{S1})(OR^{S2})(OR^{S3}), -L-SiR^{S1}R^{S2}R^{S3}, -L-Si(OR^{S1})(R^{S2})(R^{S3}), -L-Si(OR^{S1})(OR^{S2})(R^{S3}), -L-Si(OR^{S1})(OR^{S2}) (OR^{S3}), —SiR^{S4}R^{S5}-LSiR^{S1}R^{S2}R^{S3}, and —SiR^{S1}R^{S2}—NR^{N1}R^{N2}, in which each of R^{S1}, R^{S2}, R^{S3}, R^{N1}, and R^{N2} is any described herein, in which each of R^{S4} and R^{S5} can be any described herein for R^{S1}, R^{S2}, and R^{S3}, and in which L is a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{S1}, R^{S2}, R^{S3}, R^{S4}, R^{S5}, R^{N1}, and R^{N2} is, independently, H, optionally substituted aliphatic, or optionally substituted alkyl.

In one non-limiting example, the aminosilane includes a structure having formula IIa:

R^{B1}NY¹Y² (IIa),

where Nis nitrogen, R^{B1} is a silane moiety comprising at least one silane group; and each of Y¹ and Y² is any described herein for Y, and R^{B1} is any described herein for R^{B}.

In another non-limiting example, the aminosilane includes a structure having formula IIb, IIc, or IId:

R^{B1}R^{B2}NY¹ (IIb),

[R^{S1}R^{S2}R^{S3}Si-L¹-]NY¹Y² (IIc), or

[R^{S1}R^{S2}R^{S3}Si-L¹-]NY¹[-L²-SiR^{S1}R^{S2}R^{S3}] (IId),

where N is nitrogen, each R^{B1} or R^{B2} is, independently, a silane moiety comprising at least one silane group, each of Y¹ and Y² is, independently, a side group, a reactive group, or a leaving group, each of R^{S1}, R^{S2}, and R^{S3} is any described herein; and each of L¹ and L² is a linker. Each of R^{B1}, R^{B2}, Y¹, Y², L¹, and L² is any described herein for R^{B}, Y, and L, respectively.

FIGS. 2A-2C depict examples of an aminosilane having a non-limiting silane group (FIG. 2A), as well as examples of amine moieties (FIGS. 2B and 2C). In FIG. 2A, an example of an aminosilane 206 having a silane group 208 is depicted having three potential interaction sites. The aminosilane 206 is an example of chemicals that can provide the aminosilane 108. The aminosilane 206 has an amine group 210, denoted R^{A}, and three silane groups 208, X¹-X³. Silane groups 208 X¹-X³ are occupied by functional groups that include, but are not limited to, a methoxy group (—OMe), an ethoxy group (—OEt), a chloro (—Cl), a hydroxyl group (—OH), a hydrogen (—H), or an alkyl group (e.g., a linear alkyl group such as —(CH₂)ₙ(CH₃), in which n is an integer from 010; or a branched alkyl group). Yet other examples of functional groups include any reactive or leaving group described herein. In some embodiments, non-limiting examples of functional groups for X include halo, as well as optionally substituted aliphatic, alkyl, alkoxy, alkanoyloxy, heteroaliphatic, heteroalkyl, aromatic, aryl, aryloxy, and the like.

In some embodiments, an aminosilane 206 used as aminosilane 108 has any combination of these functional groups, e.g., amine group 210 and silane groups 208 (e.g., X¹-X³), and has at least one amine group 210 and at least one group silane group 208 (e.g., OMe, —OEt, —Cl, —OH, or others described herein) capable of forming a siloxane bond (e.g., an Si—O or Si—O—Si linkage). FIG. 2B is a non-limiting example of a 3-aminopropyl group which, in some examples, serves as one or more silane groups 208 or amine groups. FIG. 2C is an example of an N-(2-aminoethyl)-3-aminopropyl group which, in some examples, serves as one or more amine groups 210.

As non-limiting examples, FIGS. 2D-2G indicate examples of aminosilane 206 functionalized with silane groups 208 and an amine group 210 that would be suitable for this application, e.g., which function as aminosilane 108. FIGS. 2D and 2E are examples of an alkylalkoxyaminosilane of the type R^{A}(CH₃)_{c}Si(OEt)_{d} (e.g., in which each of c and d can be 1 or 2, such as in 3-aminopropyl(diethoxy)methylsilane and 3 (ethoxydimethylsilyl) propylamine, respectively) which, in some examples, serves as aminosilanes 108 or 206. In general and without being bound by any particular theory, the amine groups 210 (e.g., amine moieties) of one aminosilane 206 interact with one or more of the silane groups 208 of neighboring aminosilanes 206. FIG. 2F is an example of an aminosilantriol of the type (OH)₃SiR^{A} (e.g., (3-((2-aminoethyl)amino) propyl) silanetriol) which, in some examples, serves as aminosilanes 108 or 206. FIG. 2G is an example of a chloroaminosilane of the type (R^{A})₃SiCl (e.g., tris(dimethylamino) chlorosilane, tris(ethylmethylamino) chlorosilane, and the like) which, in some examples, serves as aminosilanes 108 or 206.

In some embodiments, the aminosilane 108 has the structure of formula IIIa:

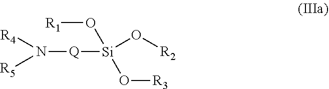

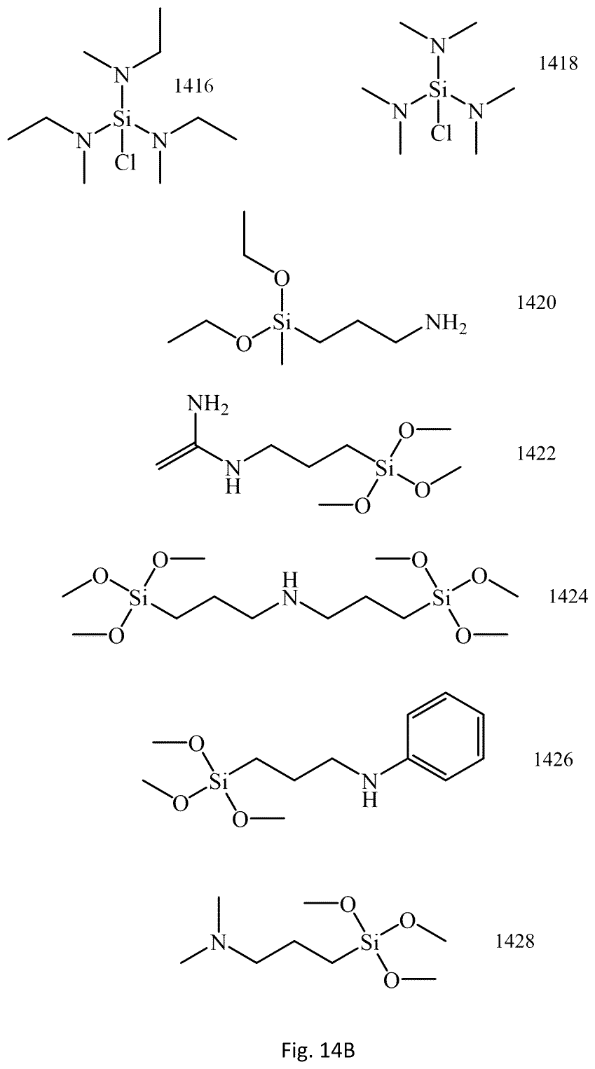

In formula IIIa, Q is —(CP₂)ₙ— where n is 2, 3, 4, or 5, and each P is independently a hydrogen, hydroxy, or halogen. In one embodiment, each P is halogen and n is 3:—CH₂—CH₂—CH₂— (e.g., compounds 1402, 1404, 1406, 1408, 1410, 1412, 1414, 1422, 1424, and 1426 of FIG. 14).

In formula IIIa, each R₁, R₂, and R₃ is independently hydrogen, alkyl, a substituted alkyl, an alkylene, or a substituted alkylene. In some embodiments, each R₁, R₂, and R₃ is —CH₃, —CH₂—CH₃, or —CH₂—CH₂—CH₃. In one embodiment, each R₁, R₂, and R₃ is hydrogen (e.g., compounds 1408, 1412 and 1414 of FIG. 14). In one embodiment, each R₁, R₂, and R₃ is —CH₂—CH₃ (e.g., compound 1404 of FIG. 14). In one embodiment, each R₁, R₂, and R₃ is —CH₃ (e.g., compounds 1402, 1406, 1422, 1424, 1426, and 1428 of FIG. 14).

In formula IIIa, each R₄ and R₅ is independently hydrogen, a substituted alkane, a substituted alkylene, an aryl, or a substituted aryl.

In some embodiments R₄ and R₅ are each methyl (e.g., compound 1428 of FIG. 14).

In one embodiment one of R₄ and R₅ is —(CH₂)ₘ—NH(R₅), where m is 1, 2, 3, 4 or 5, and R₅ is hydrogen or a substituted alkane, while the other of R₄ and R₅ is hydrogen.

In one embodiment R₄ is —(CH₂)ₘ—NH(R₆), where m is 1, 2, 3, 4 or 5, and R₆ is hydrogen or a substituted alkane, and R₄ is hydrogen. In some such embodiments, m is 2 and R₆ is hydrogen:—CH₂—CH₂—NH₂ (e.g., compounds 1406 and 1408 of FIG. 14). In other embodiments, R₆ is —(CH₂)ₚ—NH(R₇), where p is m is 1, 2, 3, 4 or 5, and R₇ is hydrogen or a substituted alkane. In one embodiment, R₇ is —(CH₂)—(CH₂)—NH₂ (e.g., compound 1414 of FIG. 14).

In some embodiments, the aminosilane 108 has the structure of formula IIIb:

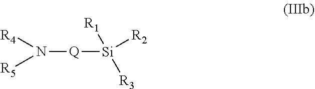

In formula IIIb, Q is —(CP₂)ₙ— where n is 2, 3, 4, or 5, and each P is independently a hydrogen, hydroxy, or halogen. In one embodiment, each P is halogen and n is 3:—CH₂—CH₂—CH₂— (e.g., compounds 1402, 1404, 1406, 1408, 1410, 1412, 1414, 1420, 1422, 1424, and 1426 of FIG. 14).

In formula IIIb, each R₁, R₂, and R₃ is independently hydrogen, alkyl, a substituted alkyl, an alkylene, a substituted alkylene, an alkoxy, or a substituted alkoxy. In some embodiments, R₁ and R₂ are each —OCH₂—CH₃, and R₃ is —CH3 (e.g., compound 1420 of FIG. 14).

In formula IIIa, each R₄ and R₅ is independently hydrogen, a substituted alkane, a substituted alkylene, an aryl, or a substituted aryl.

In some embodiments R₄ and R₅ are each methyl (e.g., compound 1428 of FIG. 14).

In some embodiments R₄ and R₅ are each hydrogen (e.g., compound 1420 of FIG. 14).

In some embodiments, one of R₄ and R₅ is —(CH₂)ₘ—NH(R₅), where m is 1, 2, 3, 4 or 5, and R₅ is hydrogen or a substituted alkane, while the other of R₄ and R₅ is hydrogen.

In some embodiments, R₄ is —(CH₂)ₘ—NH(R₆), where m is 1, 2, 3, 4 or 5, and R₆ is hydrogen or a substituted alkane, and R₅ is hydrogen. In some such embodiments, m is 2 and R₆ is hydrogen:—CH₂—CH₂—NH₂ (e.g., compounds 1406 and 1408 of FIG. 14). In other embodiments, R₆ is —(CH₂)ₚ—NH(R₇), where p is m is 1, 2, 3, 4 or 5, and R₇ is hydrogen or a substituted alkane. In one embodiment, R₇ is —(CH₂)—(CH₂)—NH₂ (e.g., compound 1414 of FIG. 14).

In some embodiments, the aminosilane 108 has the structure of formula IV:

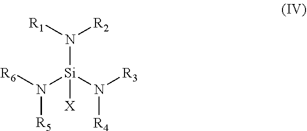

In formula IV, each R₁, R₂, R³, R₄, R₅, and R₆ is independently hydrogen, alkyl, a substituted alkyl, an alkylene, or a substituted alkylene. In one embodiment, each R¹, R², R³, R₄, R₅, and R₆ is —CH₃ (e.g., compound 1418 of FIG. 14). In one embodiment, each R¹, R², R₃, R₄, R₅, and R₆ is —CH₃ or —CH₂CH₃ (e.g., compound 1416 of FIG. 14). In formula IV, X is halogen. In one embodiment, X is Cl (e.g., compounds 1416 and 1418 of FIG. 14).

In some embodiments, the amine moieties of the aminosilane 108 interact with one or more of the X¹-X³ sites of neighboring aminosilanes 108 or interact with polymeric amines 110. In some embodiments, the amine moiety is or includes an amine group such as the amine groups of FIGS. 2B and 2C, which depict example aminopropyl, and N-(2-aminoethyl)-3-aminopropyl groups, respectively. In some implementations, the amine moiety is a primary, secondary, or tertiary amine. For example, in some embodiments, the amine moiety includes one or more aminopropyl or diethylenetriamine groups. In some implementations, the amine moiety includes more than one amine group connected through various alkyl groups. For instance, in some embodiments, the amine moiety includes a terminal amine group, an internal amine group, and a linker disposed between the terminal and internal amine group.

Optionally, in some embodiments, a further linker is present between the amine moiety and the silane moiety of the aminosilane compound.

In some implementations, the aminosilanes (silane-functionalized amines or amino-functionalized silanes) 108 include (3-aminopropyl) trimethoxysilane (compound 1402 in FIG. 14), (3-aminopropyl)triethoxysilane (compound 1404 in FIG. 14), [3-(2-aminoethylamino) propyl]trimethoxysilane (compound 1406 in FIG. 14), N-(2-aminoethyl)-3-aminopropyl silanetriol (compound 1408 in FIG. 14), N1-(3-trimethoxysilylpropyl) diethylenetriamine (compound 1410 in FIG. 14), 3-aminopropylsilanetriol (compound 1412 in FIG. 14), N-(2aminoethyl)-3-aminopropylsilanetriol (compound 1414 in FIG. 14), tris(ethylmethylamino) chlorosilane (compound 1416 in FIG. 14), tris(dimethylamino) chlorosilane (compound 1418 in FIG. 14) or an aminosilane oligomer (e.g., such as VPS SIVO 280, a modified organofunctional polysiloxane from Evonik Industries AG, Essen, Germany), 3-aminopropyl (diethoxy)methylsilane (compound 1420 in FIG. 14), N-[3-(trimethoxysilyl) propyl]ethylenediamine (compound 1422 in FIG. 14), bis[3-(methylamino) propyl]trimethoxysilane, bis[3-(trimethoxysilyl) propyl]amine (compound 1424 in FIG. 14), N-[3-(trimethoxysilyl) propyl]aniline (compound 1426 in FIG. 14), or (N,N-dimethylamino propyl) trimethoxysilane (compound 1428 in FIG. 14).

In some embodiments, the amine moieties of the aminosilane 108 and polymeric amine compound interact with silanol groups (or other groups) of the aminosilane 108 through hydrogen bonding and ionic interactions to form a network over the porous substrate surface. In some examples, the polymeric amine 110 is a polymeric/oligomeric amine such as polyethylenimine (PEI), poly(propylenimine) (PPI), or other large molecule amine mixture (e.g., Amix 1000, as produced by BASF, Ludwigshafen, DE). In some embodiments, the polymeric amine 110 is a small molecule containing amine moieties, such as tetraethylenepentamine (TEPA), triethylenetetramine (TETA), ethanolamine, diethylenetriamine, piperazine, pentaethylenehexamine, or tetramethylethylenediamine.

In some embodiments, the polymeric amine has any useful structure. In one non-limiting example, the polymeric amine includes a structure having formula V:

—(R^{A}-L)ₙ- (V).

where each R^{A} is, independently, an amine moiety comprising at least one amine group; each L is, independently, a linker; and n is an integer greater than 1 (e.g., from 1-1000, 1-100, 1-50, 1-20, 1-10, 5-1000, 5-100, 5-50, 5-20, 5-10, as well as ranges therebetween). In some embodiments, R^{A} and L are any described herein. In some embodiments, R^{A} is or includes-NH—, —NR^{N1}—, —N(-L-NR^{N1}R^{N2})—, —N(-L²-NR^{N3}-L¹-NR^{N1}R^{N2})—, —N[-L²-N(-L¹NR^{N1}R^{N2})₂]—, —NH₂, or —NR^{N1}R^{N2}, in which each of R^{N1} and R^{N2} is any described herein; in some embodiments, each of R^{N3} is any described herein for R^{N1} and R^{N2}; and in which each L, L¹, or L² is independently a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene.

FIGS. 2H and 2I depict non-limiting, general examples of polymeric amine chains that can provide polymeric amine 110. The polymeric amines of FIGS. 2H and 2I include repeating units composed of amine groups (e.g., —NH—, —NR^{N1}—, —NH₂, or NR^{N1}R^{N2}) and linkers. In some embodiments, the linker is a carbon aliphatic —(CH₂)ₙ-spacer group, in which n is an integer greater than one (e.g., an integer from 1 to 20, 1 to 10, 1 to 12, 1 to 6, etc.). FIG. 2H shows an n-propylene (—CH₂CH₂CH₂—) (C₃H₆) spacer group. FIG. 2I shows an ethylene (—CH₂CH₂—) (C2H4) spacer group. The polymeric amine has a repeating chain portion (bracketed) having a length of n active groups in the chain portion of the polymer (e.g., if n=2, there are two repeating groups in the chain portion). In some embodiments, other linkers are used, such as any described herein (e.g., optionally substituted alkylene, as described herein), as well as linkers having peptidic bonds (e.g., —C(O)NH—) or glycosidic linkages. In some embodiments, linkers include peptides, polysaccharides, and the like. Furthermore, in some embodiments, the polymeric amine includes linear or branched structures, such as those present in linear polymers, branched polymers, block polymers, or dendrimers.

FIG. 2H depicts a polymeric amine having a length of n active groups in the repeating chain portion, where n is a positive integer. In some embodiments n is 2, 3, 4, 5, 6, 7, 8, 9, 10, or greater. In some embodiments n is between 2 and 1000. FIGS. 2H and 2I depict the repeating chain portion including two amine groups (—N(X)—), separated by either three (FIG. 2H) or two (FIG. 2I) carbon spacer groups. In some embodiments, in the expression NX, X is any side group, reactive group, leaving group, or other group described herein. For example, X can be H, optionally substituted aliphatic, heteroaliphatic, aromatic, and the like. Furthermore, in some embodiments, X includes further amine groups. Thus, in some non-limiting embodiments, X includes any R^{A} group described herein. FIG. 2I depicts the amine groups extending in different orientations from the carbon chain, whereas FIG. 2H depicts the amine groups extending in similar orientations. FIG. 2J is an example of a polylysine which, in some examples, serves as polymeric amine 110. FIG. 2K is an example of a natural chitosan which, in some examples, serves as polymeric amine 110.

### Adsorption and Desorption.

In some embodiments, when exposed to a gaseous mixture including CO₂, the amine compound reacts with the CO₂ to bond the CO₂ to the functional groups. This thereby functionally adsorbs the CO₂ to the porous substrate particle 102 through the compound 106 bonded to the porous substrate particle 102 surface. Without wishing to be bound by theory, the total surface area, volume of the pores 104, and number of amine groups within the amine compound and silane compound determine the adsorption capacity of the coated particle 100. In some embodiments, the adsorption capacity (e.g., uptake) of the functionalized material is in a range from 0.1 to 2.5 mol CO₂/kg of functionalized material (e.g., from 0.1 to 2 mol CO₂/kg, 0.1 to 1.8 mol CO₂/kg, 0.1 to 1.5 mol CO₂/kg, 0.1 to 1.2 mol CO₂/kg, 0.1 to 1.0 mol CO₂/kg, 0.1 to 0.5 mol CO₂/kg, 0.2 to 2 mol CO₂/kg, 0.2 to 1.0 mol CO₂/kg, 0.2 to 0.8 mol CO₂/kg, 0.5 to 2.5 mol CO₂/kg, 0.5 to 2.2 mol CO₂/kg, 0.5 to 2 mol CO₂/kg, 0.5 to 1.8 mol CO₂/kg, 0.5 to 1.5 mol CO₂/kg, 0.5 to 0.8 mol CO₂/kg, 0.8 to 2.5 mol CO₂/kg, 0.8 to 2.2 mol CO₂/kg, 0.8 to 2 mol CO₂/kg, 0.8 to 1.8 mol CO₂/kg, 0.8 to 1.5 mol CO₂/kg, 1 to 2 mol CO₂/kg, 1 to 1.4 mol CO₂/kg, 1 to 1.5 mol CO₂/kg, 1.2 to 2.0 mol CO₂/kg, 1.2 to 1.8 mol CO₂/kg, 1.5 to 2.5 mol CO₂/kg, 1.5 to 2 mol CO₂/kg, or 2 to 2.5 mol CO₂/kg). In some embodiments, the range is greater than 0.5, 1, 1.5, 2, or 2.5 mol CO₂/kg. In some implementations, the functionalized material achieves CO₂ adsorption capacity up to 1 mol CO₂/kg or up to 2 mol CO₂/kg at 420 ppm CO₂ in ambient air conditions.

In some embodiments, the functionalized material adsorbs CO₂ per dry kilogram in a range from 0.5 mol to 2.5 mol. In some embodiments, the functionalized material adsorbs at least 0.1, at least 0.2, at least 0.5, at least 0.8, at least 1, at least 1.5, at least 2, at least 2.5, or at least 3 mol CO₂/kg. In some embodiments, the functionalized material adsorbs no more than 5, no more than 3, no more than 2.5, no more than 2, no more than 1.5, no more than 1, no more than 0.5, or no more than 0.2 mol CO₂/kg. In some embodiments, the functionalized material adsorption falls within another range starting no lower than 0.1 mol CO₂/kg and ending no higher than 5 mol CO₂/kg.

In environmental conditions, the atmosphere includes a concentration of water vapor (e.g., humidity). The coated particle 100 captures CO₂ from atmospheric conditions in a range of relative humidity levels. For example, the coated particle 100 captures CO₂ from atmospheric conditions in a range from 0% to 100% relative humidity (RH), such as for example 5% to 95% RH (e.g., 15% to 50% RH, 25% to 40% RH, or 10% to 60% RH, 5% to 90% RH, 10% to 90% RH, or 20% to 80% RH). In some implementations, the coated particle 100 captures CO₂ from atmospheric conditions having greater than 60% RH, greater than 75% RH, greater than 90% RH, or greater than 95% RH.

In some embodiments, the present disclosure provides a composition (e.g., a functionalized material) comprising porous substrate particles modified according to any of the methods and/or embodiments disclosed herein. In some embodiments, the functionalized material is reactive to carbon dioxide. In some embodiments, the functionalized material comprises a polymeric amine that is reactive to carbon dioxide.

In some embodiments, the functionalized material desorbs in a temperature range between about 65° C. to 90° C. In some embodiments, the functionalized material desorbs at a temperature of at least 40, at least 50, at least 60, at least 65, at least 70, at least 75, at least 80, at least 85, at least 90, or at least 95° C. In some embodiments, the functionalized material desorbs at a temperature of no more than 100, no more than 90, no more than 80, no more than 70, no more than 60, or no more than 50° C. In some embodiments, the functionalized material desorbs at a temperature from 40° C. and 80° C., from 60° C. to 90° C., from 65° C. to 95° C., or from 80° C. to 100° C. In some embodiments, the functionalized material desorbs at a temperature that falls within another range starting no lower than 40° C. and ending no higher than 100° C.

In some embodiments, the functionalized material has an abrasion resistance determined using an attrition and/or abrasion test. Non-limiting examples of attrition and/or abrasion tests include the American Society for Testing and Materials (ASTM) D4058-96 test and the L.A. abrasion test. In some embodiments, the functionalized material has an abrasion resistance of less than 1% weight per weight (w/w) loss according to an ASTM D4058-96 test.

In some embodiments, the functionalized material has an abrasion resistance of at least 0.01%, at least 0.05%, at least 0.1%, or at least 0.5% w/w loss. In some embodiments, the functionalized material has an abrasion resistance of no more than 10%, no more than 5%, no more than 3%, no more than 2%, no more than 1%, no more than 0.5%, or no more than 0.1% w/w loss. In some embodiments, the functionalized material has an abrasion resistance of from 0.01% to 0.1%, from 0.01% to 1%, from 0.1% to 1%, from 0.5% to 2%, or from 1% to 10% w/w loss. In some embodiments, the functionalized material has an abrasion resistance that falls within another range starting no lower than 0.01% w/w loss and ending no higher than 10% w/w loss.

In some embodiments, the functionalized material has a crush strength of at least 1.5 (megapascal) MPa. In some embodiments, the functionalized material has a crush strength of at least 0.1, at least 0.5, at least 1, at least 1.5, at least 2, at least 2.5, at least 3, or at least 5 MPa. In some embodiments, the functionalized material has a crush strength of no more than 10, no more than 5, no more than 3, no more than 2, no more than 1.5, or no more than 1 MPa. In some embodiments, the functionalized material has a crush strength of from 0.1 to 1 MPa, from 0.5 to 2 MPa, from 1 to 4 MPa, from 1.5 to 5 MPa, or from 4 to 10 MPa. In some embodiments, the functionalized material has a crush strength falling within another range starting no lower than 0.1 MPa and ending no higher than 10 MPa.

### Additional Additives.

In some implementations, the coated particle 100 includes antioxidant additives which prevent the degradation of the amine polymeric amines 110 by atmospheric oxygen and extends the cycling lifetime of the coated particle 100. For example, in some embodiments, the antioxidant additives are organic sulfur-containing compounds, such as 2,2-thiodiethanol, 2-hydroxyethyl disulfide, and 3,3′-dithiodipropionic acid. In another example, the antioxidant additives are hindered amine light stabilizers (HALS). In some embodiments, the amount of antioxidant additives in the coated particle 100 is 5% wt/wt to porous substrate (e.g., 3% wt/wt, 4% wt/wt, 6% wt/wt, or 8% wt/wt). The term wt/wt is in reference to a ratio of the weight of a first component to a second component. For example, 1 g of a first substance and 10 g of a second substance defines a 10% wt/wt ratio of the first substance to the second substance.

In some embodiments, the amount of antioxidant additives is at least 1% wt/wt, at least 2% wt/wt, at least 3% wt/wt, at least 4% wt/wt, at least 5% wt/wt, at least 6% wt/wt, at least 7% wt/wt, at least 8% wt/wt, at least 9% wt/wt, at least 10% wt/wt, or at least 15% wt/wt. In some embodiments, the amount of antioxidant additives is no more than 20% wt/wt, no more than 15% wt/wt, no more than 10% wt/wt, no more than 8% wt/wt, no more than 5% wt/wt, or no more than 3% wt/wt. In some embodiments, the amount of antioxidant additives is from 1% to 5% wt/wt, from 2% to 10% wt/wt, from 3% to 15% wt/wt, or from 5% to 20% wt/wt. In some embodiments, the amount of antioxidant additives falls within another range starting no lower than 1% wt/wt and ending no higher than 20% wt/wt.

In some embodiments, the antioxidant additives are added during steps 304, 306, or 308 of the following synthesis procedure or afterward through dissolving in methanol and then soaking the porous substrate in the additive/methanol mixture for 1 hr.

In some implementations, the functionalized particles 100 include, or are functionalized with, other hydrophobic compounds including hydrophobic silanes or hydrophobic polymer coatings. In some embodiments, for the hydrophobic silane, it is a silane molecule with one or two or three alkyl chains. Alkyl chains on the silane molecule can increase the hydrophobicity of the silane molecule. When the silane molecule bonds to the porous substrate, the hydrophobicity of the coated particle 100 increases. Thus, the water adsorption capacity of the coated particle 100 could be reduced, which can be beneficial for some cases such as when using the sorbent in high humidity conditions. For the same purpose of increasing the hydrophobicity of the coated particle 100, in some embodiments, additional hydrophobic polymer coatings are used. In some embodiments, polydimethylsiloxane (PDMS), silicone oil, polyethylene, polytetrafluorethylene, and polyurethanes are possible hydrophobic polymers used to coat the outer surface of the coated particle 100 to reduce water adsorption for high humidity applications.

In some embodiments, the plurality of functionalized coated particles comprises 15% wt/wt polyvinylalcohol, 1% wt/wt etidronic acid (ETDA), 10% wt/wt polyethyleneimine (PEI), 45% wt/wt aminopropyltrimethoxysilane (DAMO), 1% hindered amine light stabilizer, and 1% wt/wt terephthalaldehyde (TALD).

In some embodiments, the plurality of functionalized coated particles comprises between 5% wt/wt and 25% wt/wt polyvinylalcohol, between 0.3% wt/wt and 2% wt/wt etidronic acid (ETDA), between 3% wt/wt and 20% wt/wt polyethyleneimine (PEI), between 25% wt/wt and 60% wt/wt aminopropyltrimethoxysilane (DAMO), between 0.5% wt/wt and 2% hindered amine light stabilizer, and between 0.5% wt/wt and 2% wt/wt terephthalaldehyde (TALD).

In some embodiments, the plurality of functionalized coated particles comprises: between 1% wt/wt and 15% wt/wt polyvinylpyrrolidone (PVP), between 0.3% wt/wt and 2% wt/wt etidronic acid (ETDA), between 3% wt/wt and 20% wt/wt polyethyleneimine (PEI), between 25% wt/wt and 60% wt/wt aminopropyltrimethoxysilane (DAMO), between 0.5% wt/wt and 2% hindered amine light stabilizer, and between 0.5% wt/wt and 2% wt/wt terephthalaldehyde (TALD).

In some embodiments, the plurality of functionalized coated particles comprises: between 1% wt/wt and 15% wt/wt cellulose acetate (CA), between 0.3% wt/wt and 2% wt/wt etidronic acid (ETDA), between 3% wt/wt and 20% wt/wt polyethyleneimine (PEI), between 25% wt/wt and 60% wt/wt aminopropyltrimethoxysilane (DAMO), between 0.5% wt/wt and 2% hindered amine light stabilizer, and between 0.5% wt/wt and 2% wt/wt terephthalaldehyde (TALD).

In some embodiments, the plurality of functionalized coated particles comprises: between 1% wt/wt and 20% wt/wt polysulfone coating, between 0.3% wt/wt and 2% wt/wt etidronic acid (ETDA), between 3% wt/wt and 20% wt/wt polyethyleneimine (PEI), between 25% wt/wt and 60% wt/wt aminopropyltrimethoxysilane (DAMO), between 0.5% wt/wt and 2% hindered amine light stabilizer, and between 0.5% wt/wt and 2% wt/wt terephthalaldehyde (TALD).

In some embodiments, the plurality of functionalized coated particles comprises: between 3% wt/wt and 20% wt/wt polyethyleneimine (PEI), between 25% wt/wt and 60% wt/wt aminopropyltrimethoxysilane (DAMO), between 0.5% wt/wt and 2% hindered amine light stabilizer, and between 0.5% wt/wt and 2% wt/wt terephthalaldehyde (TALD).

In some embodiments, the hindered amine light stabilizer is Poly[[6-[(1,1,3,3-tetramethylbutyl)amino]-1,3,5-triazine-2,4-diyl][imino(2,2,6,6-tetramethyl-4-piperidinyl)]-1,6-hexanediylimino(2,2,6,6-tetramethyl-4-piperidinyl)]] (Chimassorb 944 FDL).

### Example Embodiments for Processes

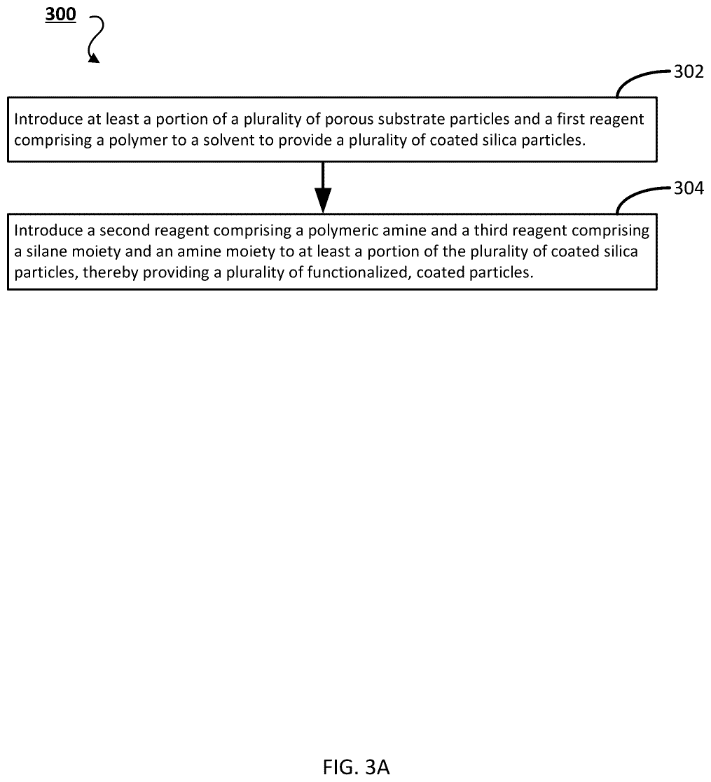

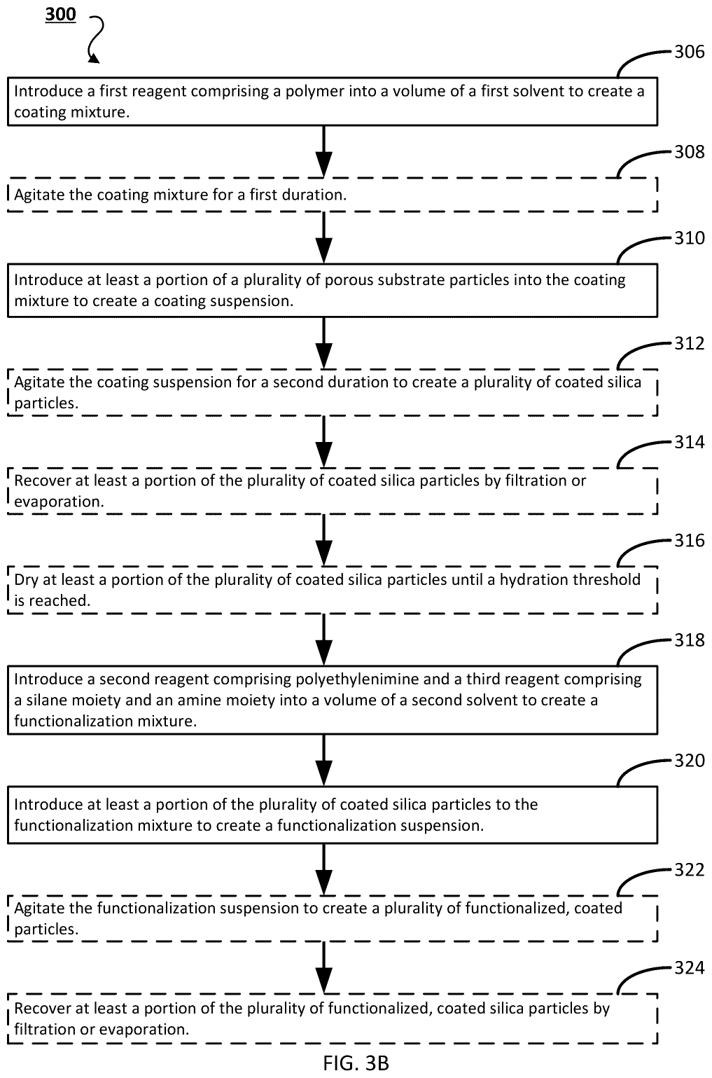

In some embodiments, the synthesis of the coated particle 100 is done under industrially applicable reaction conditions, such as liquid application to particles undergoing tumbling or mixing motion. After synthesis, the adsorbent is purified, dried, and activated before using it as a CO₂ adsorbent, such as coated particle 100. FIGS. 3A-B collectively illustrate example processes 300 for making functionalized particles, in accordance with some embodiments of the present disclosure. For example, FIGS. 3A-B collectively illustrate flow chart diagrams detailing a process 300 for making functionalized particles for use in a reversible adsorbent material, e.g., synthesizing a reversible CO₂ adsorbent, such as coated particle 100.

Referring to FIG. 3A, in some implementations, the process 300 is performed at large scale, e.g., producing 1 kilogram or more of coated particle 100 in a single process. In some implementations, the process 300 produces 100 kilograms or more of coated particle 100, e.g., up to 10,000 kg). To maintain the original particle size distribution and reduce further attrition, in some embodiments, agitation methods in which the particles are subjected to comparatively low friction or stirring forces are preferred, such as overhead stirring, gentle tumbling, slow and periodic stirring, or vibration.

In some embodiments, the process produces at least 10, at least 20, at least 50, at least 100, at least 500, at least 1000, at least 2000, at least 5000, at least 10,000, or at least 100,000 kg of coated particle. In some embodiments, the process produces no more than 500,000, no more than 100,000, no more than 10,000, no more than 5000, no more than 1000, no more than 500, no more than 100, or no more than 50 kg of coated particle. In some embodiments, the process produces from 10 to 500, from 100 to 1000, from 500 to 2000, from 1000 to 10,000, from 5000 to 50,000, or from 50,000 to 500,000 kg of coated particle. In some embodiments, the process produces another range of coated particle starting no lower than 10 kg and ending no higher than 500,000 kg of coated particle.

In some embodiments, the process 300 includes introducing porous substrate particles and a first reagent including a polymer to a solvent to provide a plurality of coated porous substrate particles (step 302). In some embodiments, the porous substrate particles are provided by porous substrate particle 102 of FIG. 1. In some embodiments, the solvent into which the porous substrate particles and the first reagent are introduced solvates the polymer into solution and provides the dissolved molecules to the porous substrate particles. In some embodiments, the dissolved molecules adsorb to the surfaces and pores of the porous substrate particles to form coated porous substrate particles.

In some embodiments, the porous substrate particles comprise any of the substrate particles disclosed above (see, for example, the section entitled “Substrate particles,” above). In some embodiments, the first reagent comprises any of the polymers and/or polymer coatings disclosed above (see, for example, the section entitled “Surface modifications,” above).

Optionally, referring to FIG. 3B, in some embodiments, process 300 includes obtaining a coating mixture prior to introducing the porous substrate particles to the first reagent including the polymer.

Referring to Block 306, in some embodiments, the process 300 includes introducing a first reagent comprising a polymer into a volume of a first solvent to create a coating mixture. Referring to Block 308, in some embodiments, the process 300 further includes agitating the coating mixture for a first duration. Referring to Block 310, the process 300 further includes introducing at least a portion of a plurality of porous substrate particles into the coating mixture to create a coating suspension.

Referring to Block 302, in some embodiments, the solvent depends on the polymer to be suspended. Using the example polymer provided herein, PVA is water-soluble and therefore an example of the solvent is water. Other solvents can be selected based on the criteria of the polymer which creates the protective coating.

In some embodiments, the process 300 is a “wet” method, such as dip-coating, in which the volume of solvent is much larger than the volume of liquid the porous substrate particles are capable of absorbing. In some embodiments, the porous substrate particles are introduced to the solvent such that the particles are fully submerged in the solvent and at a wt/wt ratio in a range from 1.5 to 4:1 solvent to porous substrate particles. In some embodiments, the solvent to particle ratio is at least 0.5:1, at least 1:1, at least 1.5:1, at least 2:1, at least 2.5:1, at least 3:1, at least 3.5:1, or at least 4:1 wt/wt. In some embodiments, the solvent to particle ratio is no more than 5:1, no more than 4:1, no more than 3:1, no more than 2:1, or no more than 1:1 wt/wt. In some embodiments, the solvent to particle ratio falls within another range starting no lower than 0.5:1 wt/wt and ending no higher than 5:1 wt/wt.

In some embodiments of the batch method, the polymer is introduced to the solvent at a ratio sufficient that the polymer is fully dissolved in the solvent, e.g., no precipitation occurs, no precipitant is present. In some embodiments, the quantity of polymer introduced to the solvent is sufficient to coat the quantity of porous substrate particles to be coated in the process 300 to achieve the desired characteristics described herein. In the example of PVA, the polymer is introduced in a wt/wt ratio range of up to 20% of the polymer to the porous substrate particles (e.g., up to 18%, up to 12%, less than 18%, or less than 16%). In some embodiments, the polymer to particle ratio is at least 1%, at least 5%, at least 10%, at least 15%, at least 20%, or at least 25% wt/wt. In some embodiments, the polymer to particle ratio is no more than 30%, no more than 20%, no more than 15%, no more than 10%, or no more than 5% wt/wt. In some embodiments, the polymer to particle ratio is from 1% to 10%, from 5% to 15%, from 10% to 20%, or from 15% to 30% wt/wt. In some embodiments, the polymer to particle ratio falls within another range starting no lower than 1% wt/wt and ending no higher than 30% wt/wt.

Referring Block 312, in some embodiments, the process 300 further includes agitating the coating suspension for a second duration to create a plurality of coated silica particles.

In another example, the process 300 is a spray method in which the volume of solvent is similar to the volume of liquid the porous substrate particles are capable of absorbing. In such an example, the solvent is introduced to the particles such that the particles are ‘wetted’ by the solvent and at a wt/wt ratio in a range from 0.2 to 1.5:1 solvent to porous substrate particles. Higher concentrations of polymer (e.g., wt/wt %) should mean improved mechanical properties (e.g., stronger particles). Higher concentrations of polymer results in reduced CO₂ uptake from the increase in nonfunctional mass of the particles because the kinetics of CO₂ adsorption are decreased since the gas must diffuse through the polymer coating, or both.

In some embodiments, the solvent to particle ratio is at least 0.1:1, at least 0.2:1, at least 0.3:1, at least 0.4:1, at least 0.5:1, at least 0.7:1, at least 1:1, or at least 1.5:1 wt/wt. In some embodiments, the solvent to particle ratio is no more than 2:1, no more than 1.5:1, no more than 1:1, no more than 0.5:1, or no more than 0.2:1 wt/wt. In some embodiments, the solvent to particle ratio falls within another range starting no lower than 0.1:1 wt/wt and ending no higher than 2:1 wt/wt.

Referring to Block 314, in some embodiments, process 300 further includes recovering at least a portion of the plurality of coated silica particles by filtration or evaporation. Referring to Block 316, in some embodiments, process 300 further includes drying at least a portion of the plurality of coated silica particles until a hydration threshold is reached.

Referring to Block 304, in some embodiments, the process 300 includes introducing a second reagent comprising a polymeric amine and a third reagent comprising a silane moiety and an amine moiety to the coated porous substrate particles, thereby providing a plurality of functionalized, coated particles. Introducing the second and third reagents functionalizes the surfaces and pores of the coated particles with a silane moiety and an amine moiety, such as silane moiety 108 or amine polymeric amines 110 and generates the plurality of functionalized, coated particles for absorbing CO₂.

In some embodiments, the second reagent comprises any of the surface modifications, silane moieties, and/or amine moieties disclosed elsewhere herein (see, for example, the section entitled “Surface modifications,” above).

In one example, functionalizing the particles includes exposing the particles to a functionalization mixture. In some embodiments, creating the functionalization mixture includes introducing a first reagent including a polymeric amine and a second reagent comprising a silane moiety and an amine functional group into a volume of a second solvent to form a functionalization mixture. In some embodiments, the second solvent is organic solvent. In some embodiments, the second solvent is selected such that the polymer used to coat the particles is not miscible in the second solvent which prevents removing the protective polymer coating from the coated particles while introducing the polymer amine and aminosilane. In some embodiments, a reagent and a compound is used interchangeably. Depending on use, in some embodiments, a reagent optionally includes one or more solvents, salts, or other compounds. In one example, the first solvent is water and the second solvent is hexane.

For instance, referring to FIG. 3B, in some embodiments, process 300 includes introducing at least the plurality of porous substrate particles to a functionalization mixture. Referring to Block 318, in some embodiments, process 300 further includes introducing a second reagent comprising polyethylenimine and a third reagent comprising a silane moiety and an amine moiety into a volume of a second solvent to create a functionalization mixture. Referring to Block 320, in some embodiments, process 300 further includes introducing at least a portion of the plurality of coated silica particles to the functionalization mixture to create a functionalization suspension.

The first reagent, the second reagent, and the volume of second solvent are dispensed and mixed. The first reagent is a polymeric amine material, such as the polymeric amine compounds described herein. The second solvent should be dispensed to fully suspend the polymeric amine, for example, by dispensing 20 mL/g second solvent to polymeric amine material (e.g., 10 mL/g, 15 mL/g, or 25 mL/g). The polymeric amine material is added to the second solvent in a range between 5% wt/wt to 20% wt/wt of the porous substrate sorbent to be functionalized in step 304 (e.g., 6% wt/wt, 8% wt/wt, 10% wt/wt, 12% wt/wt, 14% wt/wt, 16% wt/wt, or 18% wt/wt).

In some embodiments, the polymeric amine material to porous substrate sorbent is at least 1%, at least 5%, at least 10%, at least 15%, at least 20%, or at least 25% wt/wt. In some embodiments, the polymeric amine material to porous substrate sorbent is no more than 30%, no more than 20%, no more than 15%, no more than 10%, or no more than 5% wt/wt. In some embodiments, the polymeric amine material to porous substrate sorbent is from 1% to 10%, from 5% to 15%, from 10% to 20%, or from 15% to 30% wt/wt. In some embodiments, the polymeric amine material to porous substrate sorbent falls within another range of ratios starting no lower than 1% wt/wt and ending no higher than 30% wt/wt.

The second reagent is the silane coupling material which includes the examples of aminosilanes 108 described above. The silane coupling material should be dispensed in a range between 20% wt/wt to 80% wt/wt of porous substrate sorbent to be functionalized in step 304 (e.g., 25% wt/wt, 30% wt/wt, 35% wt/wt, 45% wt/wt, 50% wt/wt, or 60% wt/wt).

In some embodiments, the proportion of silane coupling material to porous substrate sorbent is at least 10%, at least 15%, at least 20%, at least 25%, at least 30%, at least 40%, at least 50%, at least 60%, or at least 70% wt/wt. In some embodiments, the proportion of silane coupling material to porous substrate sorbent is no more than 80%, no more than 70%, no more than 60%, no more than 50%, no more than 30%, no more than 20%, or no more than 15% wt/wt. In some embodiments, the proportion of silane coupling material to porous substrate sorbent is from 10% to 40%, from 15% to 55%, from 30% to 70%, or from 50% to 80% wt/wt. In some embodiments, the proportion of silane coupling material to porous substrate sorbent falls within another range of ratios starting no lower than 10% wt/wt and ending no higher than 80% wt/wt.

In some embodiments, the liquid mixture is stirred until the polymeric amine material and the silane coupling material are fully suspended in the second solvent. In some examples, mechanical stirring with a propeller, a magnetic stirrer, or sonication disperses the polymeric amine material in time in a range from 5 min to 60 min (e.g., from 10 min to 30 min, from 5 min to 30 min, from 10 min to 45 min).

In some implementations, additives are included in the functionalization mixtures to extend the operational lifetime of the particles 100. For example, the addition of Bis[3-(trimethoxysilyl) propyl]amine) (BTMSPA) to the functionalization mixture can increase the operational lifetime of the particles 100. BTMSPA is an aminosilane having two ends, in which each end has a trimethoxysilyl reactive group. The BTMSPA bonds on the porous substrate substrates with six binding points, as contrasted with the three binding points for an aminosilane with a single reactive group, such as would be present in a compound having a methoxydialkylsilyl reactive group. The increased number of binding points increases binding stability with the porous substrate. In some embodiments, the BTMSPA forms a network with other aminosilanes and polymeric amines on the surface which increases binding stability of the overall network.

In some embodiments, the additives to be included in the functionalization mixture comprise any of the additional additives disclosed elsewhere herein, for instance, in the section entitled “Additional additives,” above.

Optionally, in some embodiments, the functionalization mixture is agitated for a duration to allow hydrolysis of and fully dissolve the silane coupling material and polymeric amine materials. In general, the first time period is in a range from 1 minute to 10 minutes (e.g., 5 minutes).

Referring to Block 322, in some embodiments, process 300 further includes agitating the functionalization suspension to create a plurality of functionalized, coated particles. Referring to Block 324, in some embodiments, process 300 further includes recovering at least a portion of the plurality of functionalized, coated silica particles by filtration or evaporation.

In some embodiments, Blocks 302 and 304 are performed in either order, e.g., in other examples, the particles are functionalized and then coated with optional drying separating the coating/functionalization steps. For instance, in some embodiments, silica particles are introduced to the functionalization mixture to create the functionalization suspension and the functionalization suspension is agitated to provide functionalized silica particles before the functionalized silica particles are introduced into the coating mixture to provide the functionalized, coated particles.

Optionally, the process 300 includes one or more steps for drying the coated particles, the functionalized particles, or both. In some embodiments, drying the particles includes increasing the temperature, reducing the atmospheric pressure, passing an inert dry gas over the sample, passing a heated dry gas over the sample, or a combination of these. In some embodiments, drying occurs after the particles are introduced to the coating mixture, after the particles are introduced to the functionalization mixture, or both, in order to remove substantially all of the first solvent, or the second solvent entrained in or on the particles. In the case of drying the coated particles, in some embodiments, the coating is strengthened during drying.

In some embodiments, drying the functionalized silica particles comprises heating the functionalized silica particles at 120° C. for 20 minutes. In some embodiments, drying the functionalized silica particles comprises flowing an inert gas over the functionalized silica particles until a hydration threshold is reached. In some embodiments, the hydration threshold is less than 5% wt/wt of water to functionalized silica particles.

For example, in some implementations, the particles are dried in an oven at 70° C. for between 5 minutes and 20 minutes. Without being limited to any one theory of operation, in some embodiments, drying times longer than 60 minutes reduce the absorption capacity of the final product. In some embodiments, the drying time is scale- or conditions-dependent. For example, where the drying is performed under N₂ or vacuum with no heat, the drying time can be longer. In examples in which batch drying is performed, even with N₂ or vacuum, drying times may be longer than 60 mins, depending on the scale of the functionalized particles which are being dried. Alternatively, the particles are dried in an oven at 70° C. until a hydration threshold is reached. As non-limiting examples, the hydration threshold is a weight lost by the sample of 15% (e.g., weight lost to solvent removal), or no further weight loss @ 70° C. with inert (N₂) flow through measured on thermo-gravimetric analysis (TGA). Alternatively, in some embodiments, the particles are dried in the oven until the solvent content in the material is less than 5% wt/wt.

In some embodiments, the adsorbent particles are reused through the desorption process. For example, in some embodiments, the adsorbent is reused 100 times or more (e.g., 1000 times or more, 10000 times or more). For the desorption process, in some embodiments, samples are heated to 70° C. under vacuum for 30 mins (the duration may change based on temp/vacuum level). This facilitates the CO₂ captured during the adsorption process to be released which can be collected for further sequestration, described with reference to the systems for direct air capture below. An aspect of the desorption process is to maintain the adsorbent heated under a water vapor filled vacuum environment (e.g., >10% relative humidity). This reduces particles degradation.

In some embodiments, the adsorbent particles are reused at least 10, at least 50, at least 100, at least 500, at least 1000, at least 2000, at least 5000, at least 10,000, at least 50,000, or at least 100,000 times. In some embodiments, the adsorbent particles are reused no more than 1×10⁶, no more than 100,000, no more than 10,000, no more than 1000, or no more than 100 times. In some embodiments, the adsorbent particles are reused from 10 to 500, from 100 to 5000, from 500 to 10,000, from 1000 to 50,000, from 10,000 to 100,000, or from 100,000 to 1×10⁶ times. In some embodiments, the adsorbent particles are reused for a number of cycles falling with another range starting no lower than 10 cycles and ending no higher than 1×10⁶ cycles.

In some embodiments, another aspect of the present disclosure provides a method for using the functionalized material (e.g., the functionalized silica particles) to remove atmospheric CO₂ from air by direct air capture.

### Example Embodiments for Production Systems

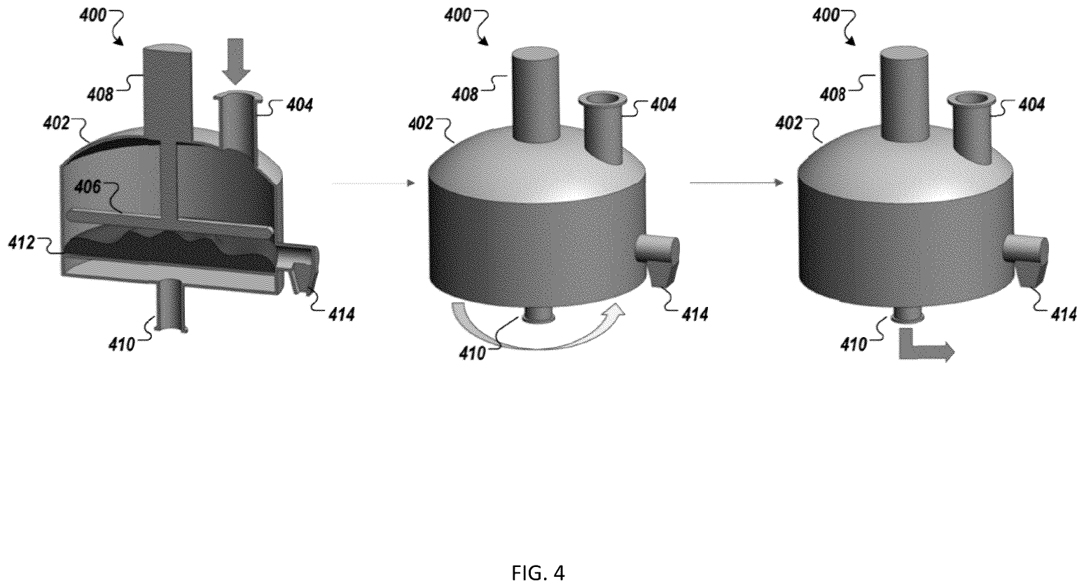

FIGS. 4-6 are example systems by which the functionalized, coated particle 100 is produced in coating and functionalization methods, such as process 300, described herein.

FIG. 4 illustrates three images of an example Nutsche filter mixing system 400 which effectively performs the separation of solid matter from a liquid under pressure or vacuum in a closed system. The left-most image of FIG. 4 shows a cut-away view of the mixing system 400. The mixing system 400 includes a vessel 402 having an inlet 404, filter discharge 410, and outlet 414. Some examples of the vessel 402 are jacketed for temperature control. An agitator 406 is rotatable within the vessel 402 by a drive motor 408 around the drive motor 408 shaft. The inlet 404 receives the coating liquid, functionalization mixture components including the silane compounds, polymeric amines, volume of water, and particles.

The drive motor 408 rotates the agitator 406 such that the mixture is stirred and sheer forces are applied to the particles and functionalization mixture. The particles are mobilized within the coating liquid, and/or functionalization mixture. The vessel 402 includes a filter 412 sized to separate the solid particles and/or particles and the coating liquid/functionalization mixture during agitation, functionalization, and coating. When the discharge 410 and outlet 414 are open, the liquids are removed from the vessel 402 and discarded while the filter 412 separates the functionalized, coated particles. The filter 412 can be wire mesh, a cloth layer, or a perforated metal layer.

Some examples of the mixing system 400 include a heating mechanism integrated into the filter 412 such that, following decanting of the coating liquid/functionalization mixture in the right-most image, the separated functionalized particles can be dried within the vessel 402.

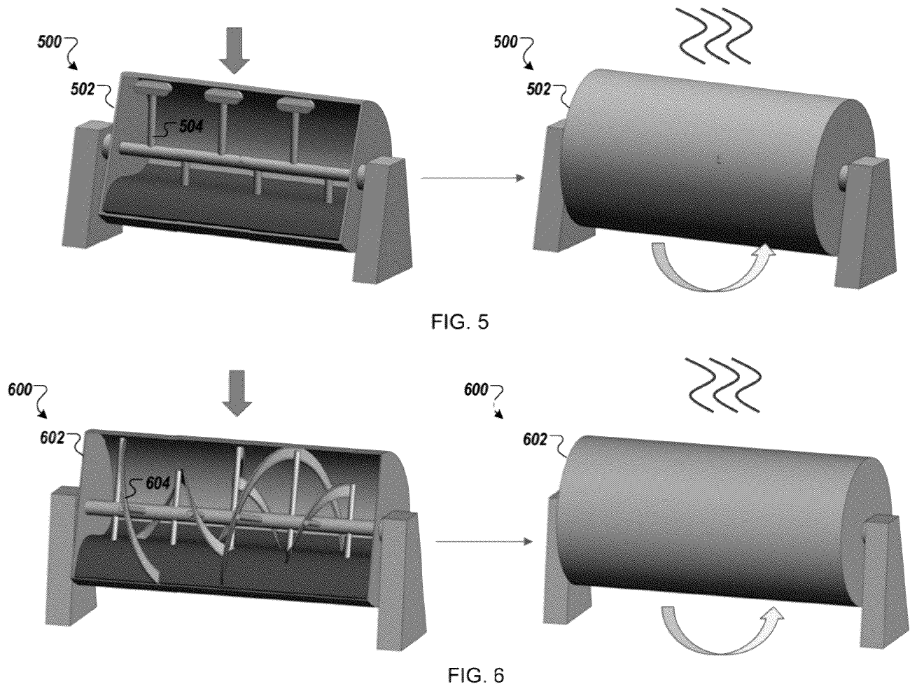

FIGS. 5 and 6 show two different examples of drum mixers which can be used for mixing the functionalization and/or coating mixtures, exposing the particles to the coating liquid/functionalization mixture thereby coating and/or functionalizing the particles, and/or drying of the functionalized particles. In the left image of FIG. 5, a paddle mixer 500 includes a cylindrical drum 502 in which mixing occurs. A paddle agitator 504 rotates independently of the drum 502 to mix the functionalization mixture, or the coating liquid and the particles. Particles are dispensed into the drum 502 and the paddle agitator 504 rotates to agitate the particles in the coating liquid/functionalization mixture.

In the left image of FIG. 6, a ribbon mixer 600 includes cylindrical drum 602 in which mixing occurs by a ribbon agitator 604 which rotates independently of the drum 602. Particles are dispensed into the drum 602 and the ribbon agitator 604 rotates to agitate the particles in the coating liquid and/or functionalization mixture.

In some embodiments, examples of the paddle mixer 500 and ribbon mixer 600 include heating mechanisms, such as jacketed drums 502 and 602, or forced gas venting to flow heated gas over the functionalized material particles after separating the particles from the liquid functionalization mixture. In some examples, the heated gas can be air, or an inert gas (e.g., nitrogen, N₂). In some embodiments, if a heat carrier is flown through a jacket of the paddle mixer 500 or ribbon mixer 600, the heat carrier is heated oil, steam, or hot water. In some embodiments, if the heat carrier is flown inside the vessel (e.g., forced gas venting), an inert gas such as N₂ is used. However, in some embodiments of forced gas venting, air is avoided to prevent oxidation.

### Example Embodiments for Direct Air Capture Systems

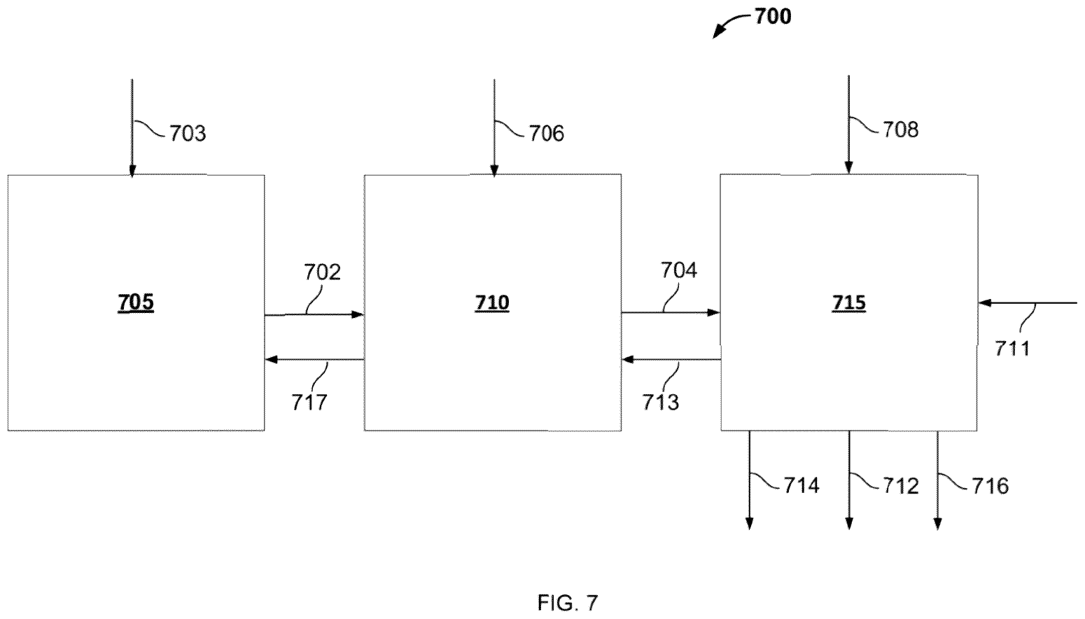

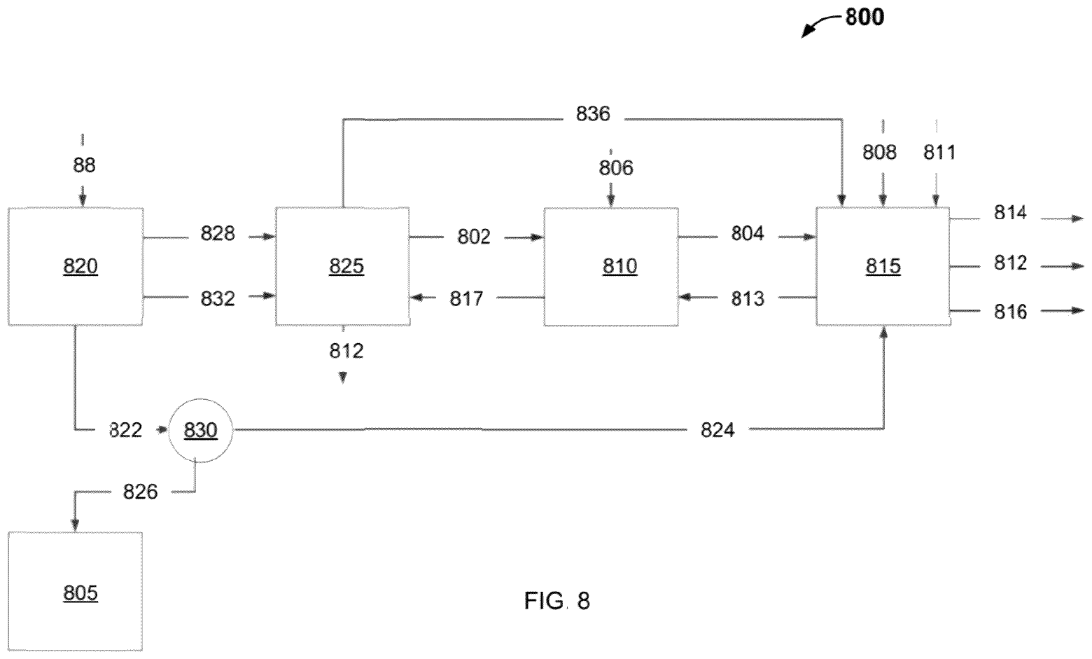

Examples of DAC systems of CO₂ using the regenerated adsorbent of the present disclosure are described with reference to FIGS. 7 and 8, examples of which are described in U.S. Pat. No. 11,685,658 B2, issued Jun. 27, 2023, the disclosure of which is hereby incorporated by reference in its entirety. FIG. 7 is a schematic illustration of an example implementation of a carbon dioxide extraction system 700. As illustrated, the carbon dioxide extraction system 700 includes an industrial process 705 that generates waste heat 702. In some implementations, the industrial process utilizes a power input 703. In some embodiments, the waste heat 702 is supplied, in this example, to a thermal heat-reuse system 710 that also utilizes a power input 706. In some embodiments, the thermal heat-reuse system 710 provides a heated fluid 704 to a carbon dioxide DAC system 715. In some embodiments, the carbon dioxide DAC system 715 also receives a power input 708 and an ambient airflow input 711. In some embodiments, the carbon dioxide DAC system 715 outputs a carbon dioxide supply stream 712, a carbon dioxide reduced airflow output stream 714, and demineralized water 716.

Generally, the carbon dioxide extraction system 700 operates to utilize the heated fluid 704 as thermal energy that is generated from the waste heat 702 by the thermal heat-reuse system 710. In some embodiments, the thermal energy in the heated fluid 704 is used by the carbon dioxide DAC system to separate carbon dioxide captured from the ambient airflow input 711 and supply the separated carbon dioxide as the carbon dioxide supply stream 712. In some embodiments, the heated fluid 704 is then returned via heated fluid return 713 to the thermal heat-reuse system 710 and the waste heat 702 is returned to the industrial process 705 via waste heat return 717. In some aspects, the carbon dioxide supply stream 712 is provided as an injectant into a subterranean formation during hydrocarbon production operations. In some aspects, the injected carbon dioxide is sequestered in the subterranean formation (with or without assisting in the hydrocarbon production operations).

In some embodiments, the industrial process 705 is any process that generates, as an output, thermal energy in the form of waste heat, e.g., energy, that, unless captured, that otherwise would be lost to, e.g., the ambient environment. As an example, in some embodiments, the industrial process 705 is a computer data center that, generally, houses computer systems and associated components, such as telecommunications and storage systems. In some aspects, a data center includes tens, hundreds, thousands, or even more server devices that generate heat, such as hardware processors, voltage regulators, memory modules, switches, and other devices that operate to provide a particular amount of information technology (IT) power.

Such devices, typically, utilize electrical power to operate and output heat during operation. In some embodiments, in order for such devices to operate correctly, the output heat is captured in a cooling fluid flow (e.g., air, water, refrigerant) and expelled from the data center. For instance, in some embodiments, air handling systems (e.g., fans, cooling coils) operate to capture the output heat in an airflow circulated over the heat-generating components. In some embodiments, the output heat now within the airflow is transferred to a cooling liquid, e.g., within a cooling coil. In some embodiments, the heat transferred to the cooling liquid is then typically rejected to the ambient environment as waste heat, such as through evaporative cooling systems, chiller/cooling tower systems, or otherwise. In this example, this waste heat takes the form of waste heat 702.

In some embodiments, the example thermal heat-reuse system 710 utilizes the waste heat 702 and power input 708 to provide the heated fluid 704. In some embodiments, the thermal heat reuse system 710 consists of a bank of heat pumps and a bank of heat exchangers to provide the heated fluid 704. By balancing the use of passive and active heating, power can be saved to provide the carbon dioxide DAC system with the required temperatures of heated fluid 704. Generally, the thermal heat-reuse system 710 includes one or more vapor compression cycles (“heat pumps”) to add thermal energy in the form of heat of compression to the waste heat 702 and transfer the sum of such energy to a fluid to generate the heated fluid 704 (e.g., a heated liquid). Generally, each heat pump and heat exchanger within the thermal heat-reuse system 710 operates to transfer thermal energy from a heat sink to a heat source, i.e., in an opposite direction of spontaneous heat transfer. In some embodiments, the one or more heat pumps of the thermal heat-reuse system 710 use the power input 706 to accomplish the work of transferring energy from the heat source to the heat sink. In some embodiments, each heat pump in the thermal heat-reuse system 710 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components are fluidly coupled within a closed-loop refrigerant circuit in the heat pump.

As is generally known, in a vapor-compression heat pump cycle, a refrigerant exits a first heat exchanger in which heat from the refrigerant is released to a first medium. In some embodiments, the refrigerant then enters a compressor in which it is compressed and a heat of compression is added thereto. In some embodiments, the refrigerant then enters a second heat exchanger in which heat from a second medium is added. In some embodiments, the refrigerant then enters an expansion device and undergoes an isenthalpic pressure drop. In some embodiments, the refrigerant completes the cycle by entering the evaporator to release the heat of compression and the heat from the second medium to the first medium.

Although the present disclosure describes a vapor-compression heat pump cycle as a heat transfer system between a source of waste heat and a carbon dioxide DAC system, other thermodynamic cycles are also contemplated for use in place of (or along with) the described vapor-compression heat pump cycle. For example, in some embodiments, one or more vapor adsorption cycles are used in place of (or along with) the described vapor compression heat pump cycle. In some embodiments, a vapor-adsorption cycle, for example, consists of a cycle of desorption-condensation-expansion-evaporation, followed by adsorption.

In some embodiments, the carbon dioxide DAC system 715, generally, operates to pass the ambient airflow input 711 (which includes gaseous carbon dioxide) over or through one or more media (e.g., “filters”). In some aspects, one or more fans (not shown) utilize the power input 708 to circulate the ambient airflow input 711. The media or filter, in some aspects, includes a solid adsorbent to which the atmospheric carbon dioxide in the airflow input 711 bonds. The adsorbent that is saturated with carbon dioxide may be referred to as “rich adsorbent.”

In the case of a solid sorbent, such as the sorbent described in the present disclosure, as the airflow input 711 passes over the solid media or filter, atmospheric carbon dioxide within the airflow input 711 bonds to the media or filter. When the media or filter is saturated with carbon dioxide, it can be heated (e.g., to 600-620° C., to 60-100° C.) to release the carbon dioxide for collection (as described below).

Using thermal energy from the heated fluid 704, in some embodiments, heat is applied to the solid or liquid adsorbent, which breaks the bonds between the carbon dioxide and the sorbent. In some embodiments, the separated carbon dioxide is provided as the carbon dioxide supply stream 712 from the carbon dioxide DAC system 715. In some embodiments, the now-“lean adsorbent” that is carbon dioxide free (i.e., the solid or liquid) is recycled back to capture more carbon dioxide from the ambient airflow input 711. In some embodiments, the airflow output 714, typically, contains little to no carbon dioxide.

FIG. 8 is a schematic illustration of an example implementation of an integrated power and carbon dioxide DAC system (“integrated system”) 800. As illustrated, the integrated system 800 includes a natural gas plant 820 attached to a CCS flue gas carbon dioxide scrubber 825 that generates waste heat 802. In some embodiments, the waste heat 802 is supplied, in this example, to a thermal heat-reuse system 810 that also utilizes a power input 806. In some embodiments, the thermal heat-reuse system 810 provides a heated fluid 1 to a carbon dioxide direct air capture (DAC) system 815.

A natural gas plant 820 generates flue gas containing carbon dioxide and electrical power 828 that is sent to the CCS flue gas carbon dioxide scrubber system 825. In some embodiments, the scrubber system 825 separates out the carbon dioxide from the flue gas. In some embodiments, the scrubber system 825 provides waste heat 802 to a carbon dioxide direct air capture (DAC) system 815. In some embodiments, the carbon dioxide DAC system 815 also receives a power input 808 and an ambient airflow input 811. In some embodiments, the carbon dioxide DAC system 815 outputs a carbon dioxide supply stream 812 and a carbon dioxide-reduced airflow output stream 814.

Generally, the integrated system 800 operates to capture the waste heat 802, generate the heated fluid 1 that has a thermal energy that includes the waste heat 802, as well as heat of compression from the thermal heat-reuse system 810, and utilize such thermal energy in the heated fluid 1 to separate carbon dioxide captured from the ambient airflow input 811 to supply the separated carbon dioxide as the carbon dioxide supply stream 812. In some aspects, the carbon dioxide supply stream 812 is provided as an injectant into a subterranean formation during hydrocarbon production operations. In some aspects, the injected carbon dioxide is sequestered in the subterranean formation (with or without assisting in the hydrocarbon production operations).

In this implementation, the industrial process 805 is powered by the natural gas plant 820 rather than the electrical power grid since the electrical power 826 would be considered carbon negative electricity.

In some embodiments, the example thermal heat-reuse system 810 utilizes the waste heat 802 from the CCS Flue Gas CO₂ Scrubber 825 and power input 806 to provide the heated fluid 1. Generally, the thermal heat-reuse system 810 includes one or more vapor-compression cycles (“heat pumps”) to add thermal energy in the form of heat of compression to the waste heat 802 and transfer the sum of such energy to a fluid to generate the heated fluid 1 (e.g., a heated liquid). Generally, each heat pump within the thermal heat-reuse system 810 operates to transfer thermal energy from a heat sink to a heat source, i.e., in an opposite direction of spontaneous heat transfer. In some embodiments, the one or more heat pumps of the thermal heat-reuse system 810 use the power input 806 to accomplish the work of transferring energy from the heat source to the heat sink. In some embodiments, each heat pump in the thermal heat-reuse system 810 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). In some embodiments, each of these components are fluidly coupled within a closed-loop refrigerant circuit in the heat pump.

The carbon dioxide DAC system 815, generally, operates to pass the ambient airflow input 811 (which includes gaseous carbon dioxide) over or through one or more media (e.g., “filters”). In some aspects, one or more fans (not shown) utilize the power input 808 to circulate the ambient airflow input 811. In some embodiments, the media or filter, in some aspects, includes a solid adsorbent to which the atmospheric carbon dioxide in the airflow input 811 bonds. The adsorbent that is saturated with carbon dioxide may be referred to as “rich adsorbent.”

In the case of a solid sorbent, such as the sorbent described in the present disclosure, as the airflow input 811 passes over the solid media or filter, atmospheric carbon dioxide within the input 811 bonds to the media or filter. When the media or filter is saturated with carbon dioxide, it can be heated (e.g., to 100-120° C., to 60-100° C.) to release the carbon dioxide for collection (as described below).

Using thermal energy from the heated fluid 1, in some embodiments, heat is applied to the solid adsorbent, which breaks the bonds between the carbon dioxide and the sorbent. In some embodiments, the separated carbon dioxide is provided as the carbon dioxide output stream 812 from the carbon dioxide DAC system 815. In some embodiments, the now-“lean adsorbent” that is carbon dioxide free (i.e., the solid or liquid) is recycled back to capture more carbon dioxide from the ambient airflow input 811. In some embodiments, the airflow output 814, typically, contains little to no carbon dioxide. In some embodiments, the carbon dioxide DAC system 815 outputs carbon dioxide 812 and demineralized water 816.

As further shown in the example embodiment of FIG. 8, in some embodiments, the integrated system 800 includes a power plant 820 (e.g., a natural gas power plant 820) and a scrubbing system 825 (e.g., a CCS Flue Gas CO₂ scrubbing system 825). As shown in this example, in some embodiments, the power plant 820 provides waste heat 802 (e.g., as generated through the generation of electrical power by the power plant 820) to the DAC system 815. In this example, the power plant 820 also generates electrical power 822 and 828. In some aspects, as shown, the electrical power 822 goes through one or more switches 830 (shown here as one, but more are possible) to provide electrical power 824 to the DAC system 815 and backup electrical power 826 to the industrial process 805.

As shown in this example, in some embodiments, the power output of the power plant 820 is sized to provide a sum of the electrical power 824 to the DAC system 815 and the electrical power 828 to the scrubbing system 825 for normal operation, as well as the backup electrical power 826 to the industrial process 805 when needed (e.g., when the industrial process 805 loses or cannot use grid electrical power 817). Thus, in some aspects, when the industrial process 805 needs the backup electrical power 826, electrical power 828 and electrical power 824 are still provided to their respective users. Alternatively, in some aspects, the power output of the power plant 820 is sized to provide a sum of the electrical power 824 to the DAC system 815 and the electrical power 828 to the scrubbing system 825 for normal operation, as well as the backup electrical power 826 to the industrial process 805 when needed (e.g., when the industrial process 805 loses or cannot use grid electrical power 817), as well as one or both of power inputs 806 and 808.

Alternatively, in some aspects, the power output of the power plant 820 is sized only to provide the backup electrical power 826 to the industrial process 805 when needed (e.g., when the industrial process 805 loses or cannot use grid electrical power 817). Thus, in some embodiments during operational periods when the industrial process 805 does not need backup electrical power 826, the electrical power 828 and/or the electrical power 824 (as well as other power inputs) is provided by the power plant 820. Alternatively, in some embodiments during operational periods when the industrial process 805 does need backup electrical power 826, the electrical power 828 and/or the electrical power 824 (as well as other power inputs) is not provided by the power plant 820. For example, electrical power 822 may be routed, in such operational periods, through the switch 830 as backup electrical power 826.

In some aspects, the electrical power 826 supplied from the power plant 820 to the industrial process 805 is not “backup” power but instead is a primary power source for the industrial process 805. For example, in some aspects, the power plant 820 is sized to provide primary electrical power 826 to the industrial process 805, as well as, in some aspects, one or more other components shown in the integrated system 800.

As further shown in FIG. 8, in some aspects, waste heat 802 that is generated from the scrubber system 825 is used by the thermal heat-reuse plant 810 to provide heated fluid to the DAC system 815. In some implementations, the heated fluid 1 is then returned via heated fluid return 813 to the thermal heat-reuse system 810 and the waste heat 802 is returned to the industrial process 805 via waste heat return 817.

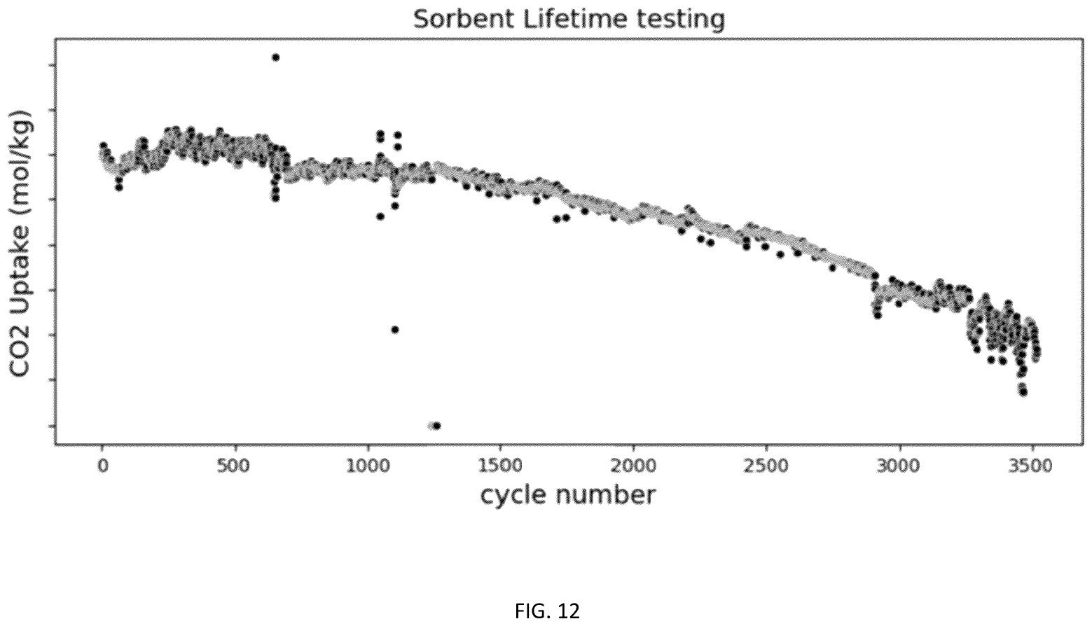

As shown in this example implementation, the scrubbing system 825 also receives an exhaust fluid 832 (e.g., the flue gas with 100% CO₂) from the power plant 820. For example, in some aspects, the power plant 820 is a natural gas power plant in which natural gas is combusted to drive electrical power generation equipment that operates to generate the electrical power shown in FIG. 12. In other aspects, the power plant 820 uses other carbon-based fuel rather than natural gas. In still other aspects, the power plant 820 uses non-carbon based fuels to generate electrical power (e.g., geothermal, solar, and other). In some embodiments, for a natural gas power plant 820, although not shown specifically here, such equipment includes, for example, a compressor rotatably coupled to a gas turbine that drives the compressor. In some embodiments, the gas turbine receives combustion products fluid from a combustion chamber that receives compressed natural gas from the compressor. In some embodiments, the combustion products fluid drives the gas turbine, which in turn is coupled to and drives a generator to produce electrical power.

In some embodiments, output from such a gas turbine (at a lower pressure than the combustion products fluid) is exhaust fluid 832 (e.g., as a flue gas). In some embodiments, a difference in pressure between the combustion products fluid and the exhaust fluid 832 drives the gas turbine to produce electrical power from the generator. As shown in this example, in some embodiments, the exhaust fluid 832 is separated by the scrubbing system 825 into multiple output streams. For example, the flue gas with 100% CO₂ 832 is separated into a carbon dioxide output and a flue gas stream 836 with 5% CO₂. The flue gas stream 836 with 5% CO₂ is sent to the DAC system 815 to remove the remaining carbon dioxide from the output airflow of the natural gas plant 820. This makes the resulting power generated from the natural gas plant carbon negative power. For example, similar to the DAC system 815, in some embodiments, outputs of a carbon dioxide supply stream 812 and a carbon dioxide-reduced airflow output stream 814 are output from the scrubbing system 825.

In some aspects, the carbon dioxide supply streams 812 are sold (e.g., for CO₂-EOR, sequestration, and/or other processes). For example, in some embodiments, the carbon dioxide supply streams 812 generate revenue through emissions credits and federal tax credits. In some aspects, such revenue offset capital and/or operations costs of the DAC system 815, the power plant 820, both, or other components of the system 800.

In some embodiments, the integrated system 800 advantageously utilizes the power plant 820, which may normally be sitting idle, to produce a saleable product in the carbon dioxide fluid streams 812, which also provide environmental benefits. Additionally, in the event of a power outage at the industrial process 805, the power plant 820 would already be running, meaning the delay between the outage and providing the process 805 with power would be reduced. Further, in some embodiments, by using the thermal energy 802 from the waste heat 802 from the scrubber 825 and 834, operating costs of the DAC system 815 is significantly reduced, allowing for the carbon dioxide captured to finance the construction of the DAC system 815 as well as help subsidize the cost of the industrial process's backup power. In addition, in some embodiments, the integrated system 800 produces water from ambient humidity as the DAC system 815 pulls carbon dioxide from the air. In some embodiments, the water is sold or used, e.g., at the industrial process 805.

### Additional Embodiments

Another aspect of the present disclosure provides a functionalized material, comprising a plurality of modified porous substrate particles, each modified porous substrate particle comprising: a porous particle comprising silicon dioxide or silicon oxide; a coating layer disposed on at least a portion of a surface of the porous particle, wherein the coating layer comprises a polymer; and a functionalization layer disposed on at least a portion of a surface of the porous particle, where the functionalization layer comprises a polymeric amine, a silane moiety, and an amine moiety. In some embodiments, the polymeric amine is reactive to carbon dioxide. In some embodiments, the functionalized material adsorbs CO2 per dry kilogram in a range from 0.5 mol to 2.5 mol. In some embodiments, the functionalized material desorbs in a temperature range between about 65° C. to 90° C. In some embodiments, the functionalized material adsorbs CO2 at a relative humidity in a range from 5% to 95% relative humidity. In some embodiments, the functionalized material has an abrasion resistance of less than 1% w/w loss according to an ASTM D4058-96 test. In some embodiments, the functionalized material has a crush strength of at least 1.5 MPa. In some embodiments, the functionalized material further comprises a hydrophobic compound. In some embodiments, the hydrophobic compound is a hydrophobic silane compound, or a hydrophobic polymer. In some embodiments, the hydrophobic silane compound comprises a silane molecule and one, two, or three alkyl chains. In some embodiments, the hydrophobic polymer comprises polydimethylsiloxane (PDMS), silicone oil, polyethylene, polytetrafluoroethylene, or polyurethanes.

Another aspect of the present disclosure provides a modified porous substrate particle, comprising: a porous particle comprising silicon dioxide or silicon oxide; a coating layer disposed on at least a portion of a surface of the porous particle, wherein the coating layer comprises a polymer; and a functionalization layer disposed on at least a portion of a surface of the porous particle, where the functionalization layer comprises a polymeric amine, a silane moiety, and an amine moiety.

Another aspect of the present disclosure provides a method for removing atmospheric CO₂ from air, comprising: obtaining a functionalized material comprising a plurality of modified porous substrate particles, each modified porous substrate particle comprising a porous substrate particle, a coating layer comprising a polymer, disposed on at least a portion of a surface of the porous substrate particle, and a functionalization layer comprising a polymeric amine, a silane moiety, and an amine moiety, disposed on at least a portion of a surface of the porous substrate particle. In some embodiments, the method further includes using the functionalized material to remove atmospheric CO₂ from air by direct air capture. In some embodiments, the polymer comprises PVA. In some embodiments, the polymeric amine is a linear or a branched polymeric amine. In some embodiments, the polymeric amine is selected from the group consisting of: Polyethylenimine (PEI), Polypropylenimine, Tetraethylenepentamine (TEPA), Triethylenetetramine (TETA), Diethanolamine, or a large molecule weight amine mixture. In some embodiments, the functionalization layer comprises an alkoxysilane, a methoxysilane, a silanetriol, an alkoxysilanol, a chlorosilane, a hydrosilane, or an ethoxysilane. In some embodiments, the functionalization layer comprises (3 Aminopropyl) trimethoxysilane, (3-Aminopropyl)triethoxysilane, [3-(2-Aminoethylamino) propyl]trimethoxysilane, N-(2-aminoethyl)-3-aminopropyl silanetriol, N1-(3-Trimethoxysilylpropyl) diethylenetriamine, 3-Aminopropylsilanetriol, N-(2Aminoethyl)-3-aminopropylsilanetriol, tris(ethylmethylamino) chlorosilane, or tris(dimethylamino) chlorosilane, or amino silane oligomers.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

### EXAMPLES

### Example 1—Silane and Polymeric Amine Functionalized Porous Substrate for Carbon Capture

Examples 1.1 to 1.3 generally relate to a functionalized porous silica and more specifically, to a functionalized porous silica for reversibly capturing carbon dioxide.

Example 1.1—N1-(3-Trimethoxysilylpropyl) diethylenetriamine and PEI grafting.

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hrs. N1-(3-trimethoxysilylpropyl) diethylenetriamine, having the chemical formula:

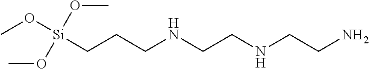 [SMILES: CO[Si](CCCNCCNCCN)(OC)OC]

was added into the above solution at a molar ratio in a range from 2.3 g to 4.7 g (e.g., 8 mmol to 16 mmol, e.g., a silica particle to amine material molar ratio in a range from 5:1 to 10:1). The mixture was heated and stirred at 60° C. or above (e.g., up to 90° C.). The temperature depends on the chosen solvent. The mixture was stirred for 18 hours (in some cases, the mixing continued for 24 hours). The mixture was cooled to room temperature. The functionalized silica particles were filtered from the solvent and washed twice while stirring with a 40 mL volume of solvent each time. The functionalized silica particles were dried in a vacuum oven at 50° C. for 12 hours. Alternatively, [3-(2-aminoethylamino) propyl]trimethoxysilane, having the chemical formula:

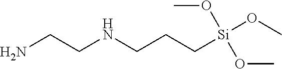

was added to the solution at 2.2 g to 4.5 g (e.g., 8 mmol to 16 mmol, e.g., a silica particle to amine material molar ratio in a range from 5:1 to 10:1).

In a second round bottom flask, 30 mL of methanol or solvent mixture (e.g., cyclohexane:ethanol=2:1), 5 g of silane-treated silica from the above step, and 1.5 g polyethylenimine (PEI) or other second amine (30 wt % to silica) was added. The mixture was stirred for 1 hour. The solvent was dried from the functionalized silica through evaporation, such as on a rotovap, to recover the functionalized silica. The functionalized silica particles were dried in a vacuum oven at 50° C. for 12 hours. The second step can be performed as a large scale process such as using vacuum drying together with an amine/solvent mixture spraying process.

### Example 1.2—Bis[3-(trimethoxysilyl) propyl]amine grafting

Using a silane compound having two or more silane moieties (e.g., two trimethoxysilane or triethoxysilane functional groups) in the same molecule, such as for example bis[3-(trimethoxysilyl) propyl]amine, can facilitate a plurality of interactions between silane groups and silica, potentially improving binding stability of the silane bond to the silica surface.

To add bis[3-(trimethoxysilyl) propyl]amine), having the chemical formula:

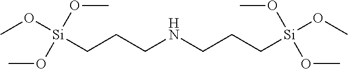

to the reaction, the same procedure as for [3-(2-aminoethylamino) propyl]trimethoxysilane grafting was followed.

In a three-necked round bottom flask, 4.85 g (80 mmol) of silica particles was added into 40 mL solvent (e.g., toluene, hexane, cyclohexane, and/or THF) at ambient temperature. The silica particles were stirred and soaked in the solvent for 2 hours. [3-(2-aminoethylamino) propyl] trimethoxysilane, having the chemical formula:

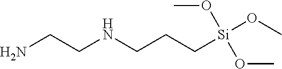

was added into the above solution at 2.2 g to 4.5 g (e.g., 8 mmol to 16 mmol, e.g., a silica particle to amine material molar ratio in a range from 5:1 to 10:1). Bis[3-(trimethoxysilyl) propyl]amine) was added into the above solution at 0.68 g (e.g., 2 mmol, a silica particle to bisamine material ratio of 40:1). The mixture was heated and stirred at 60° C. or above (e.g., up to 90° C.). The temperature depends on the chosen solvent. The mixture was stirred for 18 hours. The mixture was cooled to room temperature. The functionalized silica particles were filtered from the solvent and washed twice while stirring with a 40 mL volume of solvent each time. The functionalized silica particles were dried in a vacuum oven at 50° C. for 12 hours.

### Example 1.3—Experimental Results

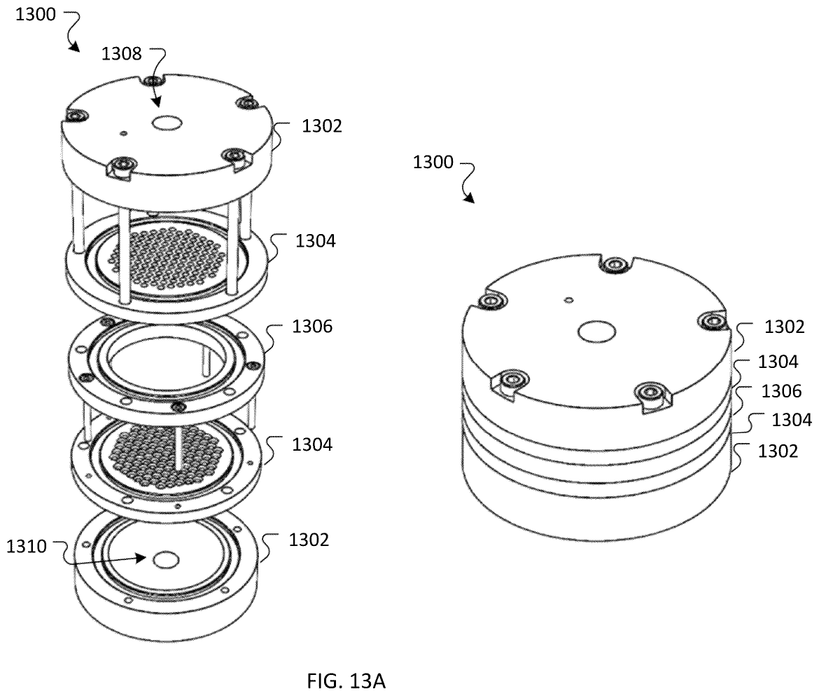

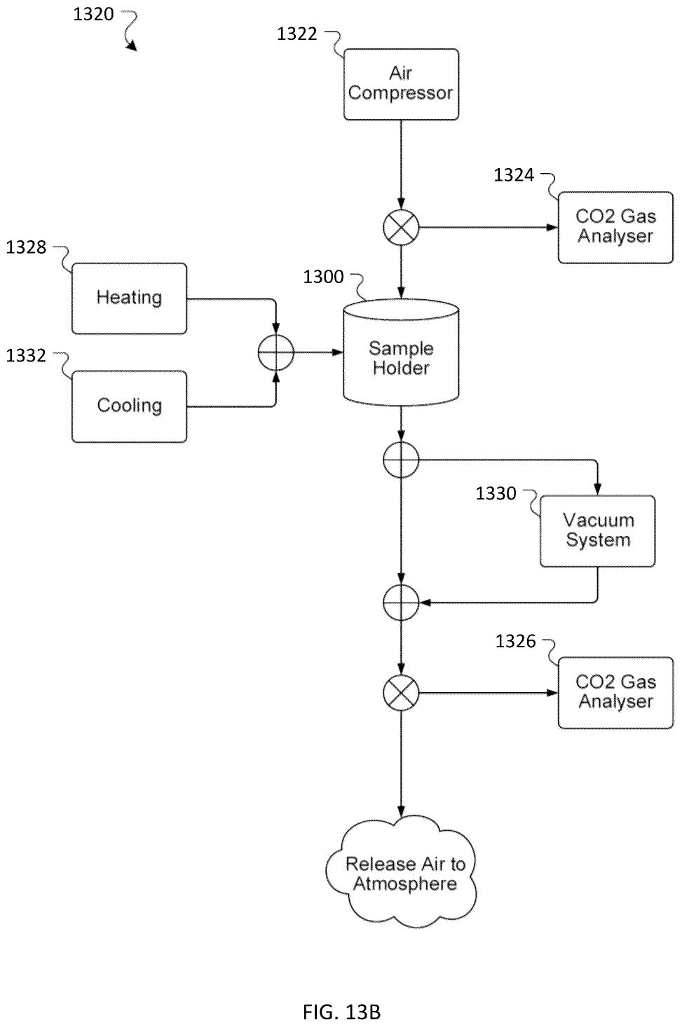

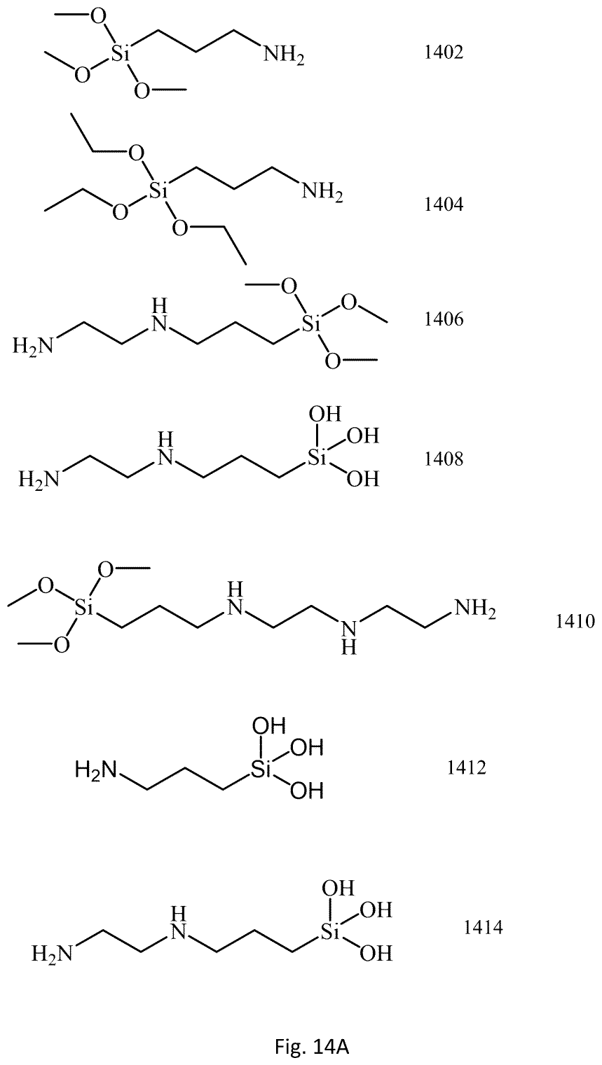

Functionalized silica produced using the processes described herein (e.g., in FIG. 3) was characterized by a CO₂ uptake measurement (e.g., using a sample holder as illustrated in FIGS. 13A-B). FIG. 12 is a line chart depicting CO₂ uptake in mol CO₂/kg (left y-axis) and against cycle number, e.g., the number of absorption and desorption cycles, (x-axis). The total CO₂ uptake of the functionalized silica sample during a single desorption is indicated.

### Example 2—CO₂ Uptake Measurements for Functionalized Material

Functionalized silica produced using the processes described herein (e.g., process 300 illustrated in FIG. 3) were characterized by a CO₂ uptake measurement. FIG. 13A schematically illustrates an exploded view (left) and an assembled view (right) of the sample holder 1300 for a sorbent. Functionalized silica particles or granules were placed in a sample space 1306 arranged between two layers of filter 1304 (e.g., such as glass wool) in a sample holder 1300. The sealing ends 1302 of the sample holder 1300 included an inlet 1308 and an outlet 1310 permissive to gas flow. The sealing ends 1302 included reversible screw connections to assemble the sample holder 1300. When assembled (right), the sample holder 1300 were otherwise sealed against gaseous inflow.

In FIG. 13B, a schematic diagram of the experimental setup 1320 is shown. Referring now to FIGS. 13A and 13B, a gas source, e.g., air compressor 1322, provided compressed environmental air to the inlet 1308 of a testing sample holder 1300, which was then passed through the filters 1304 and exposed the functionalized silica to environmental air. Optionally, air was exhausted from the outlet 1310. The concentration of CO₂ in the compressed environmental air was measured by a gas analyzer, e.g., CO₂ gas analyzers 1324 and 1326, prior to entering the inlet 1308 and/or subsequent to exiting the outlet 1310.

The samples of functionalized silica were treated with an activation process before data collection. Samples were heated in a vacuum drier (e.g., vacuum heater 1328) to 70° C. for 30 minutes under vacuum (e.g., 0.3 psi) to activate the adsorbent, e.g., as the activation process. Alternatively, and as shown in FIG. 13B, the heating element and the vacuum system 1330 were separate elements of the setup 1320 and worked in concert to heat and apply vacuum to the sample holder 1300. In some implementations, a cooling element 1332 was included in the setup 1320 to further control the temperature of the environment in the sample holder 1300. The activation process facilitated removal, e.g., evaporation, of residual solvent medium in the pores of the functionalized silica and facilitated desorption of CO₂ molecules bonded during a synthesis process (e.g., process 300) for venting to the atmosphere.

For the adsorption procedure, samples of functionalized silica in a range between 0.5 g and 10 g were placed in between two layers of glass fiber filters 1304 in the testing sample holder 1300. Compressed environmental air (e.g., input air) from gas source 1322 were continuously fed through the testing sample holder 1300 at a rate 1 to 10 standard liters per minute (slpm), thereby exposing the activated functionalized silica. The activated functionalized silica was exposed for time periods 30 to 60 minutes. The humidity of the input air was controlled to be 15% to 50% RH at 21° C. The same sample holder was then brought to vacuum by vacuum system 1330 and heated by vacuum heater 1328 to extract the carbon dioxide from the sample.

The amount of carbon dioxide extracted was measured by gas analyzer 1326. The humidity was controlled through blending of “dry air” and “wet air” with a flow meter (not shown). As an example, to produce input air having 50% RH at a flow rate of 5 slpm, dry air (e.g., <10% RH) at 2.5 slpm and wet air (e.g., >95% RH, 100% RH) was blended at 2.5 slpm each. The dry air and wet air flow control was performed using a closed loop controller.

The compressed environmental air including CO₂ concentration was monitored by gas analyzers 1324 and 1326 at the input and output of the testing sample holder 1300 during the experimental time period in units of mol CO₂/kg of adsorbent.

### Example 3—Agglomeration Trials for Functionalized Material

Shown below in Tables 1 and 2 are two trials in which fine particles were agglomerated to a baseline silica to form recycled silica particles. The CO₂ uptake (mol/kg), attrition loss (wt %), crush strength (MPa), and/or bulk density (g/L) were determined.

A baseline raw silica product was used as a base for the agglomerated particles. The CO₂ uptake of the baseline raw silica was determined using methods described herein to determine a normalized uptake with which to compare the agglomerated samples.

The agglomerated samples were formed as described herein using the baseline silica. The agglomerated samples of Table 1 were agglomerated using dry roller compaction under a pressure according to the specific row, e.g., either 20 kilopounds per square inch (ksi) or 30 ksi. In the “Condition” column, the term “Milled” means the baseline material was less than 100 microns in size. The term “Non-milled” means the baseline material was up to 500 microns.

Attrition testing was performed on the agglomerated samples. Briefly, 100 g of each sample was placed in a sieve shaker using a 20 mesh screen. The samples were agitated in the shaker for 5 minutes using a tapper. 50 g of the plus 20 mesh product was placed on the mesh 20 screen. 50 pieces of 9.5 mm ceramic beads were added to the 20 mesh screen. The samples were agitated for 5 minutes without the tapper. The weight percentage of fines found in the base pan following the agitation with the ceramic beads was determined compared to the original sample.

Following agglomeration, the samples were coated with the functionalization mixture and tested for CO₂ uptake, both methods as described herein. Briefly, for the functionalization/coating process, 7.7 wt % of PEI and 36 wt % of DAMO in 160 wt % of water were added to 100 g of the silica substrate by dip coating in the PEI/DAMO/Water solution. After the dip coating, the samples were dried under vacuum at 70° C. for 24 hrs. The samples were tested with the method described in Examples 1 and 2 to determine the uptake performance.

TABLE 1

| | | | Uptake | |
|---|---|---|---|---|
| Trial 1 | Condition | Shape | (mol/kg) | Attrition |
| Baseline | Not from agglomeration | Spherical | 1.2 | 8.7% |
| Silica | | granules | | |
| BT1 Run1 | Silica 150 A no-milled | Flat chips | 1.14 | 30.5% |
| | 20 ksi (70-200 um) | | | |
| BT1 Run2 | Silica 150 A milled | Flat chips | 0.67 | 6.9% |
| | 20 ksi | | | |
| BT1 Run3 | Silica 150 A milled | Flat chips | 0.53 | 7.7% |
| | 30 ksi | | | |
| BT1 Run4 | Silica F1 milled | Flat chips | 0.64 | 11.3% |
| | 20 ksi | | | |

The agglomerated samples for Table 2 (below) were produced using a liquid binding mixture of PVA and water at varying wt % (PVA to water wt %) as a binder. The samples from Table 2 were agglomerated using a mixer with the liquid binding mixture.

The CO₂ uptake capacity and attrition were determined using the same method as for the samples for Table 1. The agglomerated particles for Table 2 were characterized for compression strength. The bulk compression strength test utilizes a test fixture which consists of a lower crush platform and upper crusher head. The lower crush platform included a flat surface onto which samples are placed. The upper crush head included a crush head with a flat lower surface substantially parallel with the plane of surface such that force was applied evenly to particles between the crush head and surface during force application. The crush head had an outer diameter (OD) 72.6 mm and the surface was 124.5 mm in diameter. The crush platform had a diameter 125.4 mm. In another example, the crush platform had a diameter of 146 mm.

During testing, a layer of particles, e.g., the sample, was packed closely on the crush platform and roughly aligned with the center of the crush head. The particle bed diameter was about 90 mm to about 2 mm in thickness. The samples were 3-6 g dry weight depending on particle coating components. The force applied to the crush head was recorded while displacement changed. The packed particle bed was crushed to achieve 50% of its compressive strain (e.g., displacement divided by initial sample bed thickness) and the stress (MPa) (e.g., force divided by contact area) is reported as 50% strain crush strength. Samples of uncoated, and coated particles were tested. For both types of particle, at least 3 samples were tested to get the average performance for the bulk compression strength.

The bulk density was measured according to ASTM D1895 Method A. Briefly, fine granules were poured through a V shaped funnel. The material being tested were allowed to flow into a cylinder cup with a known volume of 100 mL. Testing results were averaged using more than 4 measurements.

TABLE 2

| | | | | | Crush | Bulk |
|---|---|---|---|---|---|---|
| | | | Uptake | | Strength | Density |
| Trial 2 | Condition | Shape | (mol/kg) | Attrition | (MPa) | (g/L) |
| Baseline | Not from | Spherical | 1.2 | 12% | 1.14 | 260 |
| Silica | agglomer- | granules | | | | |
| | ation | | | | | |
| BT1 | 7% PVA | | 1.35 | 5-7 | 1.04 | 262 |
| Run1 | solution | | | wt % | | |
| | as binder | | | | | |
| BT1 | 10% PVA | | 1.3 | 5-7 | 1.21 | 268 |
| Run2 | solution | | | wt % | | |
| | as binder | | | | | |
| BT1 | 3% PVA | | 1.35 | 5-7 | 0.87 | 255 |
| Run3 | solution | | | wt % | | |
| | as binder | | | | | |

### Example 4—Experimental Results of Uncoated and Coated Functionalized Material

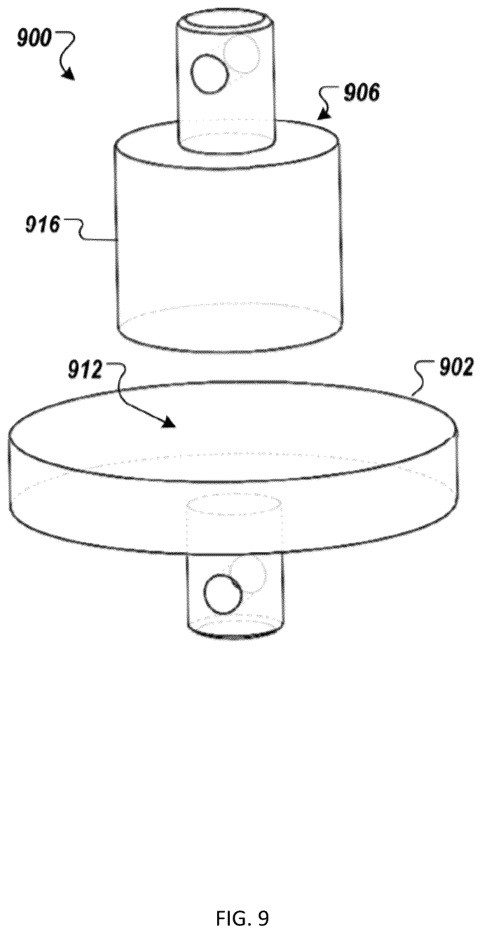

Functionalized, coated particles produced using the process 300 described herein, and as detailed in Examples 5-10, were characterized for compression strength and attrition resistance. The bulk compression strength test utilized the test fixture 900 shown in FIG. 9. The test fixture 900 consisted of a lower crush platform 902 and upper crusher head 906. The lower crush platform 902 included a flat surface 912 onto which samples are placed. The upper crush head 906 included a crush head 916 with a flat lower surface substantially parallel with the plane of surface 912 such that force was applied evenly to particles between the crush head 916 and surface 912 during force application. The crush head 916 had an outer diameter (OD) 72.6 mm and the surface 912 was 124.5 mm in diameter. The crush platform 902 had a diameter 125.4 mm. In another example, the crush platform had a diameter of 146 mm.

During testing, a thin layer of particles, e.g., the sample, was packed closely on the crush platform 902 and roughly aligned with the center of the crush head 916. The particle bed diameter was 90 mm and about 2 mm in thickness. The samples were in a range from 3-6 g dry weight depending on particle coating components. The force applied to the crush head 906 was recorded while displacement changed. The packed particle bed was crushed to achieve 50% of its compressive strain (e.g., displacement divided by initial sample bed thickness) and the stress (MPa) (e.g., force divided by contact area) was reported as 50% strain crush strength. Samples of uncoated, and coated particles were tested. For both types of particle, at least 3 samples were tested to get the average performance for the bulk compression strength.

Tables 3 and 4 presents the bulk compression strength for the samples, normalized against an uncoated substrate (Table 3; Control 1) (Table 4; Control 2). Compression strength is also known as ‘crush strength.’ Samples included no coating raw porous substrate, silica coated with amine only, and silica coated with various types of polymers. The particles of each sample had average radii in a range from 1 to 1.4 mm to ensure consistent particle size distribution.

TABLE 3
Bulk Compression Strength Results.

| | | 50% Strain | |
|---|---|---|---|
| | | Compressive | |
| | | Strength | Normalized % |
| | Sample | (MPa) | to Control |
| Control | No coating (Control 1) | 1.29 | 100% |
| 1 | Amine coating (DAMO + PEI | 1.36 | 105% |
| | sorbent) | | |
| 2 | Amine coating + 200K Mw | 2.09 | 162% |
| | PVA (DAMO + PEI sorbent + | | |
| | 10 wt % 200K PVA) | | |
| 3 | Amine coating + 30-50K | 2.05 | 159% |
| | Mw PVA (DAMO + PEI | | |
| | sorbent + 10 wt % 30-50K | | |
| | PVA) | | |
| 4 | Amine coating + 13-23K | 1.73 | 134% |
| | Mw PVA (DAMO + PEI | | |
| | sorbent + 10 wt % 13-23K | | |
| | PVA) | | |
| 5 | Amine coating + cellulose | 1.40 | 108% |
| | acetate (DAMO + PEI | | |
| | sorbent + 2 wt % cellulose | | |
| | acetate (CA)) | | |
| 6 | Amine coating + PVP | 1.59 | 123% |
| | (DAMO + PEI sorbent + | | |
| | 2 wt % PVP) | | |
| 7 | Amine coating + PVA 99% | 1.77 | 137% |
| | Hydrolyzed (DAMO + PEI | | |
| | sorbent + 2 wt % PVA | | |
| | 99% Hdrolyzed) | | |

TABLE 4
Bulk Compression Strength Results.

| | 50% Strain | | CO2 |
|---|---|---|---|
| | Compressive Stress | Strength | uptake |
| Sample | (MPa) | Improvement % | (mol/kg) |
| No coating | 1.14 | 100% | 0 |
| (Control 2) | | | |
| DAMO + PEI | 1.36 | 119% | 1.3 |
| sorbent | | | |
| DAMO + PEI | 2.09 | 183% | 1.2 |
| sorbent + 10 | | | |
| wt % 200K PVA | | | |
| DAMO + PEI | 2.05 | 180% | 1.05 |
| sorbent + 10 | | | |
| wt % 30-50K PVA | | | |
| DAMO + PEI | 1.73 | 152% | 1.05 |
| sorbent + 10 | | | |
| wt % 13-23K PVA | | | |
| DAMO + PEI | 1.98 | 174% | 1.04 |
| sorbent + 10 | | | |
| wt % 10K PVA | | | |
| DAMO + PEI | 1.40 | 122% | 1.07 |
| sorbent + | | | |
| 2 wt % cellulose | | | |
| acetate (CA) | | | |
| DAMO + PEI | 1.59 | 139% | 0.61 |
| sorbent + | | | |
| 2 wt % PVP | | | |
| DAMO + PEI | 1.77 | 155% | 1.04 |
| sorbent + | | | |
| 2 wt % PVA | | | |
| 99% Hydrolyzed | | | |
| DAMO + PEI | 2.16 | 189% | 0.88 |
| sorbent + | | | |
| 10% Polysulfone | | | |

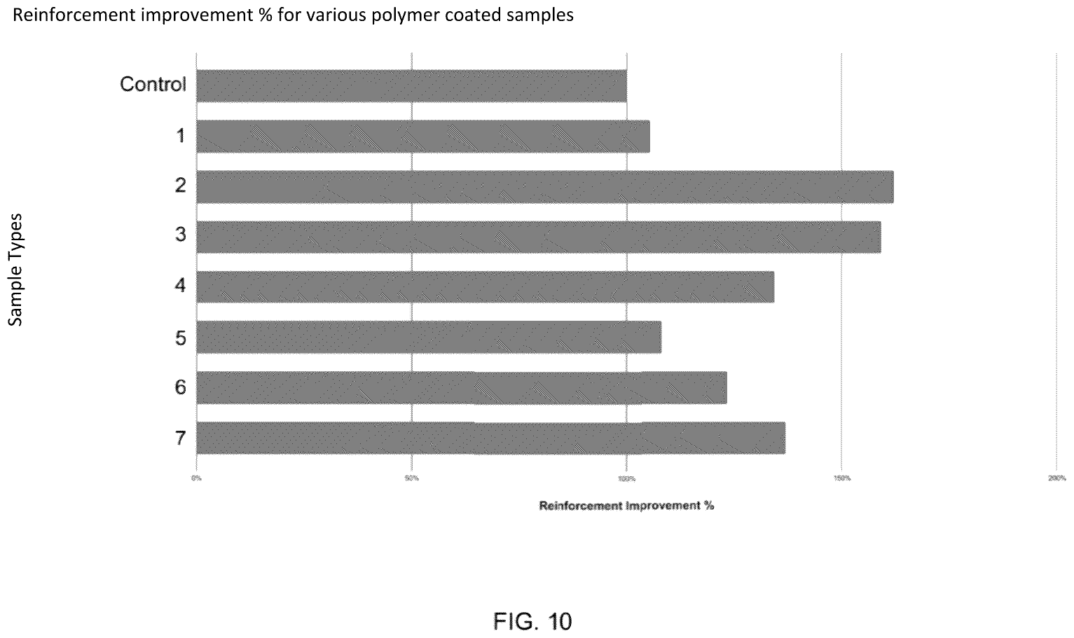

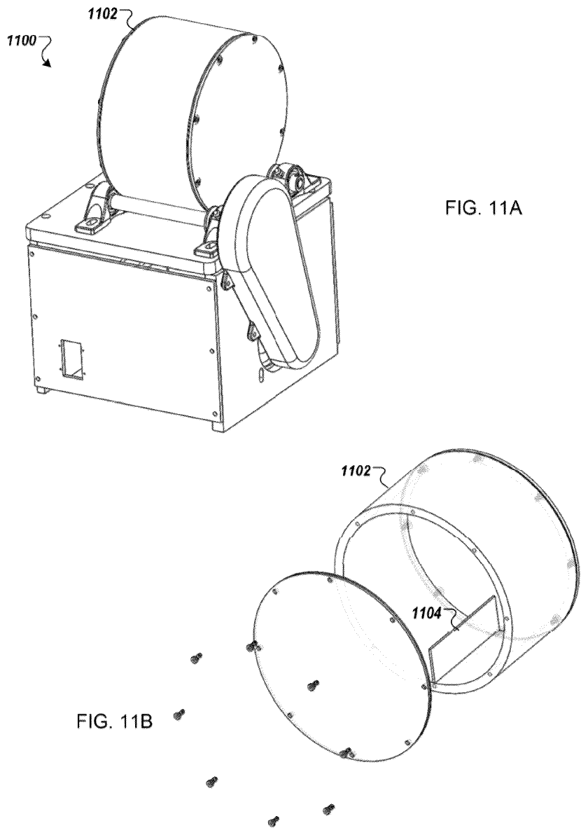

PVA reinforcement (Sample 2) improved the crush strength by ˜162% (maximum) compared to baseline raw silica. Different molecular weight PVA resulted in different reinforcement effects. Lower molecular weight PVA (Sample 4) showed less reinforcement effect compared to Sample 2, e.g., the normalized improvement was about 134%. Other polymers such as cellulose acetate, PVP also provided a reinforcement effect. Cellulose acetate reinforcement (Sample 5) provided 108% reinforcement and PVP (Sample 7) provided 137% reinforcement. A bar chart of the compression strength results comparison is shown in FIG. 10.

Attrition and abrasion resistance was determined according to the ASTM D4058-96 (Standard Test Method for Attrition and Abrasion of Catalysts and Catalyst Carriers) testing method. The testing fixture 1100 is shown in FIG. 11A and exploded diagram of the drum 1102 is shown in FIG. 11B. Samples of particles were placed inside the drum 1102 and the testing fixture 1100 rotated the drum 1102 for a 30 min cycle. The particles within the drum 1102 interacted with a baffle 1104 which caused attrition loss. As the particles are tumbled, attrition occurred. The sample of particles was removed and the particles sieved to determine loss to attrition. Attrition is the process of breaking down, therefore “loss to attrition” refers to the amount of particles that have broken down to a standard definition. In the process described herein, particles broken down to <0.5 mm are no longer useful and will be collected, e.g., filtered, and discarded and would be defined as “lost to attrition.” Table 4 shows the results.

TABLE 5
Attrition Loss Results

| | | | Reduction in generated | |
|---|---|---|---|---|
| Single cycle | | | fines (%) | |
| attrition | particle size | particle size | particle size | particle size |
| (% loss) | >0.71 mm | >0.1 mm | >0.71 mm | >0.1 mm |
| Raw silica | 1.65% | 1.33% | — | — |
| PVA coated | 0.91% | 0.89% | 45% | 33% |
| silica test 1 | | | | |
| PVA coated | 1.05% | 1.04% | 36% | 22% |
| silica test 2 | | | | |
| PVA and | 0.93% | 0.93% | 44% | 30% |
| amine coated | | | | |
| silica | | | | |

As shown in Table 5, particles including the polymer reinforcement coating had improvement on the attrition loss resistance of between 36%-45% for particle size<0.71 mm.

### Example 5—Example Functionalization Mixture (Second Reagent and Third Reagent)

In one non-limiting embodiment, creating the plurality of functionalized particles includes introducing a second reagent including the polymeric amine (e.g., polyamine) polyethyleneimine (PEI) and a third reagent comprising the aminosilane aminopropyltrimethoxysilane (DAMO) having the structure:

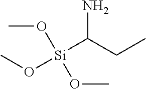

into a volume of the second solvent ethanol to form the functionalization mixture. A total of 45 g of aminopropyltrimethoxysilane (DAMO) and 10 g of polyethyleneimine PEI were charged into a 200 mL beaker and stirred till a homogenous mixture was obtained. 190 mL ethanol was charged into the DAMO-PEI mixture and stirred till a homogeneous mixture was obtained. The PEI-DAMO-ethanol solution was decanted over 100 grams of porous silica particles in a 500 ml beaker. The beaker was placed in a vacuum oven at 80° C. and 50 mbar for 12 hours till a dry product (coated particles) was obtained.

### Example 6—Two-Step Procedure for Sorbent Formation

This example provides a method comprising forming a plurality of coated particles by introducing at least a portion of a plurality of porous particles and a first reagent comprising a polymer to a solvent. The method further comprises forming a plurality of functionalized coated particles by introducing a second reagent comprising a polymeric amine and a third reagent comprising a silane-functionalized amine or an amino-functionalized silane (aminosilane) to at least a portion of the plurality of coated particles.

In this example the plurality of porous particles were silica particles.

In this example the polymer in the first reagent is 13K-23K MW polyvinylalcohol (PVA).

In this example the polymeric amine of the second reagent is the polyamine poly(ethyleneimine) (PEI).

In this example the silane-functionalized amine or the amino-functionalized silane (aminosilane) of the third reagent is the aminosilane aminopropyltrimethoxysilane (DAMO).

In this example the plurality of functionalized coated particles is formed in the presence of a crosslinker that is incorporated into the plurality of functionalized coated particles, where the crosslinker is the dialdehyde terephthalaldehyde (TALD.

Step 1 for a 100 g batch of coated particles.

Formation of first reagent. Slowly, 15 g of 13-23K Mw PVA was charged into 60 mL of rapidly stirring cold water in a 500 mL flask with a condenser. The mixture was heated to 70-80° C. and stirred until a homogeneous solution was obtained, approximately 30 minutes. The solution was cooled to 60-70° C. under constant stirring. Slowly, 140 mL of hot ethanol (˜60° C.) was charged into the flask and mixed thoroughly until a uniform solution was obtained. 1.67 g of 60% etidronic acid (ETDA) solution was charged into the warm solution (50-60° C.) and mixed thoroughly until a uniform solution was obtained.

Forming a plurality of coated particles by introducing a plurality of porous particles to a first reagent comprising a polymer. The warm PVA-ethanol-water solution was decanted over 100 g of silica in a 1 L rotary evaporation flask with mixing. The flask was placed on the rotary evaporator and set to 20 rotations per minute (rpm) until the mixture was observed to be homogenous with no dry particles. Once a uniform mixture was obtained the rotary evaporator was set to 70° C., 50 mbar, and 10 rpm. The mixture was dried until the sorbent (plurality of coated particles) contained 20-30 wt % volatiles as measured by a Mettler Toledo Halogen Moisture Analyzer HE73.

Step 2 for a 100 g (starting silica) batch.

The plurality of coated particles. The PVA-coated silica product from the first step (141 g) was left in the 1 L rotary evaporator flask.

Form the second and third reagent. 10 g of the polyamine poly(ethyleneimine) (PEI) (second reagent and 45 g of the aminosilane aminopropyltrimethoxysilane (DAMO) (third reagent) was charged into a 500 ml beaker followed by 10 mL isopropyl alcohol (IPA). The PEI, DAMO, and IPA were mixed until a uniform DAMO-PEI-IPA solution was obtained.

1.1 g of the crosslinker terephthalaldehyde (TALD), having the chemical structure:

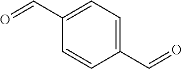

was charged into a 250 ml beaker followed by 141 mL of hexane and 19 mL of IPA. 1 g Chimassorb 944 FDL (C944) (Poly[[6-[(1,1,3,3-tetramethylbutyl)amino]-1,3,5-triazine-2,4-diyl][imino(2,2,6,6-tetramethyl-4-piperidinyl)]-1,6-hexanediylimino(2,2,6,6-tetramethyl-4-piperidinyl)]]; BASF, Ludwigshafen am Rhein, 67056 Germany) was charged into the same 250 ml beaker and mixed until a uniform solution was obtained. TALD-C944-Hexane-IPA was warmed to 60° C. with mixing until a uniform solution was obtained.

The DAMO-PEI-IPA solution (second and third reagents) was warmed to 40° C. with mixing. The warm TALD-C944-hexane-IPA solution (crosslinker) was charged into the 500 ml beaker of DAMO-PEI-IPA. The temperature was maintained at 60° C. and mixed until a homogeneous solution was obtained.

Forming a plurality of functionalized coated particles by introducing the second reagent comprising the polymeric amine and the third reagent comprising a silane-functionalized amine or the amino-functionalized silane (aminosilane) to at least a portion of the plurality of coated particles. The warm PEI-DAMO-TALD-C944-Hexane-IPA solution was decanted over the 141 g of PVA-EDTA-coated silica product from step 1 (plurality of coated particles) in the 1 L rotary evaporation flask with mixing. The flask was placed on the rotary evaporator and spun at 20 rpm until the mixture was observed to be uniform. Once a uniform mixture was obtained, the rotary evaporator was set to 70° C., 50 mbar, and 10 rpm. The mixture was dried until the sorbent contained <5 wt % volatiles as measured by a Mettler Toledo Halogen Moisture Analyzer HE73.

In an embodiment, the procedure was used to obtain the sample DAMO+PEI sorbent+10 wt % 13-23K PVA described in Example 4 (Table 3 and Table 4).

In an embodiment, the polymer in the first reagent is 200K MW polyvinylalcohol (PVA), and the procedure was used to obtain the sample DAMO+PEI sorbent+10 wt % 200K PVA described in Example 4 (Table 3 and Table 4).

In an embodiment, the polymer in the first reagent is 30-50K MW polyvinylalcohol (PVA), and the procedure was used to obtain the sample DAMO+PEI sorbent+10 wt % 30-50K PVA described in Example 4 (Table 3 and Table 4).

In an embodiment, the polymer in the first reagent is 10K MW polyvinylalcohol (PVA), and the procedure was used to obtain the sample DAMO+PEI sorbent+10 wt % 10K PVA described in Example 4 (Table 3 and Table 4).

In an embodiment, the substrate particles were not introduced to the first reagent comprising the polymer, and only step 2 of the procedure was used to obtain the sample DAMO+PEI sorbent described in Example 4 (Table 3 and Table 4).

### Example 7—Second Procedure for Sorbent Formation

In an embodiment, the procedure included formation of the first reagent comprising adding 3 g of PVA into 60 mL of cold water, in accordance with step 1 of Example 6 above, thereby obtaining 2% by weight PVA. In an embodiment, the procedure included, after forming the second reagent and the third reagent in accordance with step 2 of Example 6 above, agitating the functionalization mixture (the second reagent and the third reagent) for a duration to allow hydrolysis of and fully dissolve the polymeric amine and the silane-functionalized amine or the amino-functionalized silane (aminosilane), thereby achieving 99% hydrolysis. In an embodiment, the procedure was used to obtain the sample DAMO+PEI sorbent+2 wt % PVA 99% Hydrolyzed described in Example 4 (Table 3 and Table 4).

### Example 8 —Third Procedure for Forming Coated Particles (First Reagent)

This example provides a method comprising forming a plurality of coated particles by introducing at least a portion of a plurality of porous particles and a first reagent comprising a polymer to a solvent. In an embodiment, the particles are coated with 2% by weight polyvinylpyrrolidone (PVP).

4 g PVP was charged into 25 mL of methanol and warmed and stirred on a hotplate until a homogenous solution was obtained. The solution was decanted over 20 g of sorbent previously coated with polyamine and an aminosilane in a 100 ml beaker. The mixture was mixed until the sorbent was thoroughly wetted by the solution. The beaker was placed in a vacuum oven at 80° C. and 50 mbar for 12 hrs until a dry product was obtained.

In an embodiment, the third procedure was used to obtain the sample DAMO+PEI sorbent+2 wt % cellulose acetate (CA) described in Example 4 (Table 3 and Table 4).

### Example 9—Fourth Procedure for Forming Coated Particles (First Reagent)

This example provides a method comprising forming a plurality of coated particles by introducing at least a portion of a plurality of porous particles and a first reagent comprising a polymer to a solvent. In an embodiment, the particles are coated with 2% by weight cellulose acetate (CA).

4 g CA was charged into 25 mL of THF and warmed and stirred on a hotplate until a homogenous solution was obtained. The solution was decanted over 20 g of sorbent previously coated with polyamine and an aminosilane in a 100 ml beaker. The mixture was mixed until the sorbent was thoroughly wetted by the solution. The beaker was placed in a vacuum oven at 80° C. and 50 mbar for 12 hrs until a dry product was obtained.

In an embodiment, the fourth procedure was used to obtain the sample DAMO+PEI sorbent+2 wt % PVP described in Example 4 (Table 3 and Table 4).

### Example 10—Fifth Procedure for Forming Coated Particles (First Reagent)

This example provides a method comprising forming a plurality of coated particles by introducing at least a portion of a plurality of porous particles and a first reagent comprising a polymer to a solvent. In an embodiment, the particles are coated with 10% by weight polysulfone.

5 g of 35K mW polysulfone was charged and 50 mL of THF was charged into a 200 mL flask. A stir bar was added and the flask stoppered and was heated to 70° C. in a sand bath. The solution was stirred until the complete dissolution of the polymer was observed. The solution was decanted over 50 g of previously prepared silica coated with amines (PEI and DAMO 7.7/36) in a 200 mL jar. The mixture was thoroughly stirred until no dry spots were observed. The mixture was placed in a vacuum oven at 80° C. and 50 mbar for 12 hrs until a dry product was obtained.

In an embodiment, the fifth procedure was used to obtain the sample DAMO+PEI sorbent+10% Polysulfone described in Example 4 (Table 3 and Table 4).

A number of implementations have been described. Nevertheless, it will be understood that various modifications may be made without departing from the spirit and scope of the invention. Accordingly, other implementations are within the scope of the following claims.

1. A method, comprising:
forming a plurality of coated particles by introducing (i) at least a portion of a plurality of porous substrate particles and (ii) a first reagent, comprising a polymer, to a solvent; and
forming a plurality of functionalized coated particles by introducing (i) a second reagent comprising a polymeric amine and (ii) a third reagent, comprising a silane-functionalized amine or an amino-functionalized silane (aminosilane), to at least a portion of the plurality of coated particles.

2. A method comprising:
forming a plurality of functionalized particles by introducing (i) a second reagent, comprising a polymeric amine, and (ii) a third reagent, comprising a silane-functionalized amine or an amino-functionalized silane, to a portion of a plurality of porous substrate particles; and
forming a plurality of functionalized coated particles by introducing a first reagent, comprising a polymer, to at least a portion of the plurality of functionalized particles.

3. The method of claim 1, wherein introducing the second reagent and the third reagent comprises mixing the second reagent and the third reagent in a different solvent to form a mixture and spraying the mixture on the coated particles.

4. The method of claim 1, wherein the first reagent comprises polyvinyl alcohol.

5. The method of claim 1, wherein the plurality of porous substrate particles is introduced to the solvent at a ratio in a range from 1.5 to 4:1 wt/wt of solvent to the plurality of porous substrate particles.

6. The method of claim 1, wherein the first reagent is introduced to the solvent at a ratio in a range of up to 20% wt/wt of the first reagent to the plurality of porous substrate particles.

7. The method of claim 3, wherein a ratio of the third reagent to the different solvent, while mixing the second reagent and the third reagent in the different solvent, is between 20% and 80% wt/wt of the third reagent to the plurality of porous substrate particles.

8. The method of claim 1, wherein the silane-functionalized amine or amino-functionalized silane is an alkoxysilane, a methoxysilane, a silanetriol, an alkoxysilanol, a chlorosilane, a hydrosilane, an ethoxysilane, or a mixture thereof.

9. The method of claim 8, wherein the silane-functionalized amine or amino-functionalized silane is 3-aminopropyl) trimethoxysilane, (3-aminopropyl)triethoxysilane, [3-(2-aminoethylamino)propyl]trimethoxysilane, N-(2-aminoethyl)-3-aminopropyl silanetriol, N1-(3-trimethoxysilylpropyl) diethylenetriamine, 3-aminopropylsilanetriol, N-(2Aminoethyl)-3-aminopropylsilanetriol, tris(ethylmethylamino) chlorosilane, tris(dimethylamino) chlorosilane, an amino silane oligomer, or a mixture thereof.

10. The method of claim 1, wherein the polymeric amine of the second reagent is linear or branched, and wherein the polymeric amine of the second reagent is selected from a group comprising polyethylenimine (PEI), polypropylenimine, tetraethylenepentamine (TEPA), triethylenetetramine (TETA), diethanolamine, or a mixture thereof.

11.-12. (canceled)

13. The method of claim 1, further comprising, before introducing the second reagent and the third reagent:
drying the plurality of coated particles, under vacuum, until a hydration threshold of less than 5% wt/wt of water to coated substrate is reached.

14. The method of claim 1, further comprising introducing a fourth reagent comprising an antioxidant at a weight ratio of 5% to the plurality of porous substrate particles, wherein the antioxidant is 2,2-thiodiethanol, 2-hydroxyethyl disulfide, 3,3′-dithiodipropionic acid, or a mixture thereof.

15. (canceled)

16. The method of claim 1, wherein the plurality of porous substrate particles are amorphous silica particles.

17. The method of claim 1, wherein the plurality of porous substrate particles are alumina particles, calcium silicate particles, sodium alumino silicate particles, borosilicate particles, amorphous zirconium silicate particles, porous ziriconia (ZrO₂) particles, calcium aluminate particles, amorphous magnesium silicate particles, zeolite particles, potassium alumino silicate particles, or amorphous lithium sulfate particles.

18. The method of claim 1, wherein the plurality of coated particles have (i) a distribution of pore sizes from 10 nanometers to 200 nanometers and (ii) a distribution of sieve diameters from 0.4 millimeters to 4 millimeters.

19. The method of claim 1, wherein the plurality of coated particles have (i) a distribution of pore sizes from 50 Angstroms to 300 Angstroms and (ii) a distribution of sieve diameters from 0.4 millimeters to 4 millimeters.

20.-28. (canceled)

29. A composition comprising: a plurality of porous substrate particles modified according to the method of claim 1.

30.-33. (canceled)

34. The composition of claim 29, wherein the composition has an abrasion resistance of less than 1% w/w loss according to an ASTM D4058-96 test.

35. The composition of claim 29, wherein the composition has a crush strength of at least 1.5 MPa.

36.-39. (canceled)

40. A method, comprising using the functionalized particles of claim 1 to remove atmospheric CO₂ from air by direct air capture.

41.-70. (canceled)
